(19) United States
(12) Patent Application Publication
(10) Pub. No.: US 2003/0149603 A1
(43) Pub. Date: Aug. 7, 2003

(54) System and method for operating a non-linear model with missing data for use in electronic commerce

(76) Inventors: Bruce Ferguson, Round Rock, TX (US); Eric Hartman, Austin, TX (US)

Correspondence Address: Jeffrey C. Hood, Conley, Rose & Tayon, P.C., P.O. Box 398, Austin, TX, 78767, US

(21) Appl. No.: 10/051,598

(22) Filed: Jan. 18, 2002

(51) Int. Cl. G06F 17/60

(52) U.S. Cl. 705/7; 706/22

(57) ABSTRACT

A system and method for preprocessing input electronic commerce data to a non-linear model for use in an electronic commerce (e-commerce) system. The non-linear model includes parameters that define the representation of the e-commerce system, and operates in two modes: run-time and training. A data preprocessor preprocesses received data in accordance with predetermined preprocessing parameters, and outputs preprocessed data. The data preprocessor includes an input buffer for receiving and storing the input data. The input data may include one or more outlier values. A data filter detects and removes, and may optionally replace, any outlier values in the input data, generating corrected input data. An output device outputs the corrected data from the data filter as preprocessed data, which may be input to the non-linear model in training mode to train the non-linear model, and/or in run-time mode to generate control parameters and/or predictive output information for the e-commerce system.

### BACKGROUND OF THE INVENTION

1. Field of the Invention

The present invention relates generally to the field of predictive system models. More particularly, the present invention relates to an electronic commerce system for preprocessing input data so as to correct for different time scales, transforms, missing or bad data, and/or time-delays prior to input to a non-linear model for either training of the non-linear model or operation of the non-linear model.

2. Description of the Related Art

Many predictive systems may be characterized by the use of an internal model which represents a process or system for which predictions are made. Predictive model types may be linear, non-linear, stochastic, or analytical, among others. However, for complex phenomena non-linear models may generally be preferred due to their ability to capture non-linear dependencies among various attributes of the phenomena. Examples of non-linear models may include neural networks and support vector machines (SVMs).

Generally, a model is trained with training data, e.g., historical data, in order to reflect salient attributes and behaviors of the phenomena being modeled. In the training process, sets of training data may be provided as inputs to the model, and the model output may be compared to corresponding sets of desired outputs. The resulting error is often used to adjust weights or coefficients in the model until the model generates the correct output (within some error margin) for each set of training data. The model is considered to be in “training mode” during this process. After training, the model may receive real-world data as inputs, and provide predictive output information which may be used to control the process or system or make decisions regarding the modeled phenomena. It is desirable to allow for pre-processing of input data of predictive models (e.g., non-linear models, including neural networks and support vector machines), particularly in the field of e-commerce.

Predictive models may be used for analysis, control, and decision making in many areas, including electronic commerce (i.e., e-commerce), e-marketplaces, financial (e.g., stocks and/or bonds) markets and systems, data analysis, data mining, process measurement, optimization (e.g., optimized decision making, real-time optimization), quality control, as well as any other field or domain where predictive or classification models may be useful and where the object being modeled may be expressed abstractly. For example, quality control in commerce is increasingly important. The control and reproducibility of quality is the focus of many efforts. For example, in Europe, quality is the focus of the ISO (International Standards Organization, Geneva, Switzerland) 9000 standards. These rigorous standards provide for quality assurance in production, installation, final inspection, and testing of processes. They also provide guidelines for quality assurance between a supplier and customer.

A common problem that is encountered in training non-linear models for prediction, forecasting, pattern recognition, sensor validation and/or processing problems is that some of the training/testing patterns may be missing, corrupted, and/or incomplete. Prior systems merely discarded data with the result that some areas of the input space may not have been covered during training of the non-linear model. It is a common occurrence in real-world problems that some or all of the input data may be missing at a given time. It is also common that the various values may be sampled on different time intervals. Additionally, any one value may be “bad” in the sense that after the value is entered, it may be determined by some method that a data item was, in fact, incorrect. Hence, if a given set of data has missing values, and that given set of data is plotted in a table, the result may be a partially filled-in table with intermittent missing data or “holes”. These “holes” may correspond to “bad” data or “missing” data.

Conventional non-linear model training and testing methods require complete patterns such that they are required to discard patterns with missing or bad data. The deletion of the bad data in this manner is an inefficient method for training a non-linear model. For example, suppose that a non-linear model has ten inputs and ten outputs, and also suppose that one of the inputs or outputs happens to be missing at the desired time for fifty percent or more of the training patterns. Conventional methods would discard these patterns, leading to no training for those patterns during the training mode and no reliable predicted output during the run mode. The predicted output corresponding to those certain areas may be somewhat ambiguous and/or erroneous. In some situations, there may be as much as a 50% reduction in the overall data after screening bad or missing data. Additionally, experimental results have shown that non-linear model testing performance generally increases with more training data, therefore throwing away bad or incomplete data may decrease the overall performance of the non-linear model.

Another common issue concerning input data for non-linear models relates to situations when the data are retrieved on different time scales. As used herein, the term “time scale” is meant to refer to any aspect of the time-dependency of data. As is well known in the art, input data to a non-linear model is generally required to share the same time scale to be useful. This constraint applies to data sets used to train a non-linear model, i.e., input to the non-linear model in training mode, and to data sets used as input for run-time operation of a non-linear model, e.g., input to the non-linear model in run-time mode. Additionally, the time scale of the training data generally must be the same as that of the run-time input data to insure that the non-linear model behavior in run-time mode corresponds to the trained behavior learned in training mode.

In one example of input data (for training and/or operation) with differing time scales, one set of data may be taken on an hourly basis and another set of data taken on a quarter hour (i.e., every fifteen minutes) basis. In this case, for three out of every four data records on the quarter hour basis there will be no corresponding data from the hourly set. Thus, the two data sets are differently synchronous, i.e., have different time scales.

As another example of different time scales for input data sets, in one data set the data sample periods may be non-periodic, producing asynchronous data, while another data set may be periodic or synchronous, e.g., hourly. These two data sets may not be useful together as input to the non-linear model while their time-dependencies, i.e., their time scales, differ. In another example of data sets with differing time scales, one data set may have a “hole” in the data, as described above, compared to another set, i.e., some data may be missing on one of the data sets. The presence of the hole may be considered to be an asynchronous or anomalous time interval in the data set, and thus may be considered to have an asynchronous or inhomogeneous time scale.

In yet another example of different time scales for input data sets, two data sets may have two different respective time scales, e.g., an hourly basis and a 15 minute basis. The desired time scale for input data to the non-linear model may have a third basis, e.g., daily.

While the issues above have been described with respect to time-dependent data, i.e., where the independent variable of the data is time, t, these same issues may arise with different independent variables. In other words, instead of data being dependent upon time, e.g., D(t), the data may be dependent upon some other variable, e.g., D(x).

In addition to data retrieved over different time periods, data may also be taken on different machines in different locations with different operating systems and quite different data formats. It is essential to be able to read all of these different data formats, keeping track of the data values and the timestamps of the data, and to store both the data values and the timestamps for future use. It is a formidable task to retrieve these data, keeping track of the timestamp information, and to read it into an internal data format (e.g., a spreadsheet) so that the data may be time merged.

Inherent delays in a system is another issue which may affect the use of time-dependent data. For example, in an electronic commerce system, a scanning device may provide inventory data at time t₀ at a given value. However, a given change in inventory resulting in a different reading on the scanning device may not affect the output for a predetermined delay τ. In order to predict the inventory, the inventory data provided by the scanning device must be input to the non-linear model at a delay equal to τ. This must also be accounted for in the training of the non-linear model. Thus, the timeline of the data must be reconciled with the timeline of the process. In generating data that account for time delays, it has been postulated that it may be possible to generate a table of data that comprises both original data and delayed data. This may necessitate a significant amount of storage in order to store all of the delayed data and all of the original data, wherein only the delayed data are utilized. Further, in order to change the value of the delay, an entirely new set of input data must be generated from the original set.

Thus, improved systems and methods for preprocessing data for training and/or operating a non-linear model are desired.

### SUMMARY OF THE INVENTION

A system and method are presented for preprocessing input data to an e-commerce system based on a non-linear system model. The system model may utilize any of a variety of non-linear models, such as support vector machines or neural networks, having a set of parameters associated therewith that define the representation of the system being modeled. The non-linear model, also referred to herein as “the model”, may have multiple inputs, each of the inputs associated with a portion of the input data. The model parameters may be operable to be trained on a set of training data that is received from training data and/or a run-time system such that the system model is trained to represent the run-time system. The input data may include a set of target output data representing the output of the system and a set of measured input data representing the system variables. The target data and system variables may be reconciled by the preprocessor and then input to the model. A training device may be operable to train the model according to a predetermined training algorithm such that the values of the model parameters are changed until the model comprises a stored representation of the run-time system. Note that as used herein, the term “device” may refer to a software program, a hardware device, and/or a combination of the two.

In one embodiment of the present invention, the system may include a data storage device for storing training data from the run-time system. The model may operate in two modes, a run-time mode and a training mode. In the run-time mode, run-time data may be received from the run-time system. Similarly, in the training mode, data may be retrieved from the data storage device, the training data being both training input data and training output data. A data preprocessor may be provided for preprocessing received (i.e., input) data in accordance with predetermined preprocessing parameters to output preprocessed data. The data preprocessor may include an input buffer for receiving and storing the input data. The input data may be on different time scales. A time merge device may be operable to select a predetermined time scale and reconcile the input data so that all of the input data are placed on the same time scale. An output device may output the reconciled data from the time merge device as preprocessed data. The reconciled data may be used as input data to the system model, e.g., the support vector machine or neural network. In other embodiments, other scales than time scales may be determined for the data, and reconciled as described herein.

The model may have an input for receiving the preprocessed data, and may map it to an output through a stored representation of the run-time system in accordance with associated model parameters. A control device may control the data preprocessor to operate in either training mode or run-time mode. In the training mode, the preprocessor may be operable to process the stored training data and output preprocessed training data. A training device may be operable to train the support vector machine (in the training mode) on the training data in accordance with a predetermined training algorithm to define the model parameters on which the model operates. In the run-time mode, the preprocessor may be operable to preprocess run-time data received from the run-time system to output preprocessed run-time data. The model may then operate in the run-time mode, receiving the preprocessed input run-time data and generating a predicted output and/or control parameters for the run-time system.

The data preprocessor may further include a pre-time merge processor for applying one or more predetermined algorithms to the received data prior to input to the time merge device. A post-time merge processor (e.g., part of the output device) may be provided for applying one or more predetermined algorithms to the data output by the time merge device prior to output as the processed data. The preprocessed data may then have selective delay applied thereto prior to input to the model in both the run-time mode and the training mode. The one or more predetermined algorithms may be externally input and stored in a preprocessor memory such that the sequence in which the predetermined algorithms are applied is also stored.

In one embodiment, the input data associated with at least one of the inputs of the model may have missing data in an associated time sequence. The time merge device may be operable to reconcile the input data to fill in the missing data.

In one embodiment, the input data associated with a first one or more of the inputs may have an associated time sequence based on a first time interval, and a second one or more of the inputs may have an associated time sequence based on a second time interval. The time merge device may be operable to reconcile the input data associated with the first one or more of the inputs to the input data associated with the second one or more of the inputs, thereby generating reconciled input data associated with the at least one of the inputs having an associated time sequence based on the second time interval.

In one embodiment, the input data associated with a first one or more of the inputs may have an associated time sequence based on a first time interval, and the input data associated with a second one or more of the inputs may have an associated time sequence based on a second time interval. The time merge device may be operable to reconcile the input data associated with the first one or more of the inputs and the input data associated with the second one or more of the inputs to a time scale based on a third time interval, thereby generating reconciled input data associated with the first one or more of the inputs and the second one or more of the inputs having an associated time sequence based on the third time interval.

In one embodiment, the input data associated with a first one or more of the inputs may be asynchronous, and the input data associated with a second one or more of the inputs may be synchronous with an associated time sequence based on a time interval. The time merge device may be operable to reconcile the asynchronous input data associated with the first one or more of the inputs to the synchronous input data associated with the second one or more of the inputs, thereby generating reconciled input data associated with the first one or more of the inputs, where the reconciled input data comprise synchronous input data having an associated time sequence based on the time interval.

In one embodiment, the input data may include a plurality of system input variables, each of the system input variables including an associated set of data. A delay device may be provided that may be operable to select one or more input variables after preprocessing by the preprocessor and to introduce a predetermined amount of delay therein to output a delayed input variable, thereby reconciling the delayed variable to the time scale of the data set. This delayed input variable may be input to the system model. Further, this predetermined delay may be determined external to the delay device.

In one embodiment, the input data may include one or more outlier values which may be disruptive or counter-productive to the training and/or operation of the model. The received data may be analyzed to determine any outliers in the data set. In other words, the data may be analyzed to determine which, if any, data values fall above or below an acceptable range.

After the determination of any outliers in the data, the outliers, if any, may be removed from the data, thereby generating corrected input data. The removal of outliers may result in a data set with missing data, i.e., with gaps in the data.

In one embodiment, a graphical user interface (GUI) may be included whereby a user or operator may view the received data set. The GUI may thus provide a means for the operator to visually inspect the data for bad data points, i.e., outliers. The GUI may further provide various tools for modifying the data, including tools for “cutting” the bad data from the set.

In one embodiment, the detection and removal of the outliers may be performed by the user via the GUI. In another embodiment, the user may use the GUI to specify one or more algorithms which may then be applied to the data programmatically, i.e., automatically. In other words, a GUI may be provided which is operable to receive user input specifying one or more data filtering operations to be performed on the input data, where the one or more data filtering operations operate to remove and/or replace the one or more outlier values. Additionally, the GUI may be further operable to display the input data prior to and after performing the filtering operations on the input data. Finally, the GUI may be operable to receive user input specifying a portion of said input data for the data filtering operations.

After the outliers have been removed from the data, the removed data may optionally be replaced. In other words, the preprocessing operation may “fill in” the gap resulting from the removal of outlying data. Various techniques may be brought to bear to generate the replacement data, including, but not limited to, clipping, interpolation, extrapolation, spline fits, sample/hold of a last prior value, etc., as are well known in the art.

In another embodiment, the removed outliers may be replaced in a later stage of preprocessing, such as the time merge process described above. In this embodiment, the time merge process will detect that data are missing, and operate to fill the gap.

Thus, in one embodiment, the preprocess may operate as a data filter, analyzing input data, detecting outliers, and removing the outliers from the data set. The filter parameters may simply be a predetermined value limit or range against which a data value may be tested. If the value falls outside the range, the value may be removed, or clipped to the limit value, as desired. In one embodiment, the limit(s) or range may be determined dynamically. For example, in one embodiment, the range may be determined based on the standard deviation of a moving window of data in the data set, e.g., any value outside a two sigma band for a moving window of 100 data points may be clipped or removed. As mentioned above, the data filter may also operate to replace the outlier values with more appropriate replacement values.

In one embodiment, the received input data may comprise training data including target input data and target output data, and the corrected data may comprise corrected training data which includes corrected target input data and corrected target output data.

In one embodiment, the model may be operable to be trained according to a predetermined training algorithm applied to the corrected target input data and the corrected target output data to develop model parameter values such that the model has stored therein a representation of the system that generated the target output data in response to the target input data. In other words, the model parameters of the model may be trained based on the corrected target input data and the corrected target output data, after which the model may represent the system.

In one embodiment, the input data may comprise run-time data, such as from the system being modeled, and the corrected data may comprise reconciled run-time data. In this embodiment, the model may be operable to receive the corrected run-time data and generate run-time output data. In one embodiment, the run-time output data may comprise control parameters for the system. The control parameters may be usable to determine control inputs to the system for run-time operation of the system. For example, in an e-commerce system, control inputs may include such parameters as advertisement or product placement on a website, pricing, and credit limits, among others.

In another embodiment, the run-time output data may comprise predictive output information for the system. For example, the predictive output information may be usable in making decisions about operation of the system. In an embodiment where the system may be a financial system, the predictive output information may indicate a recommended shift in investment strategies, for example. In an embodiment where the system may be a manufacturing plant, the predictive output information may indicate production costs related to increased energy expenses, for example. Thus, in one embodiment, the preprocessor may be operable to detect and remove and/or replace outlying data in an input data set for the non-linear model.

Various embodiments of the systems and methods described above may thus operate to preprocess input data for a non-linear model to reconcile data on different time scales to a common time scale. Various embodiments of the systems and methods may operate to remove and/or replace bad or missing data in the input data. The resulting preprocessed input data may then be used to train and/or operate a non-linear model in an e-commerce system.

### BRIEF DESCRIPTION OF THE DRAWINGS

A better understanding of the present invention may be obtained when the following detailed description of various embodiments is considered in conjunction with the following drawings, in which:

FIG. 1 illustrates an exemplary computer system according to one embodiment of the present invention;

FIG. 2 illustrates a first e-commerce system that operates according to various embodiments of the present invention;

FIG. 3 illustrates a second e-commerce system that operates according to various embodiments of the present invention;

FIG. 4 illustrates a third e-commerce system that operates according to various embodiments of the present invention;

FIG. 5 is a flowchart diagram illustrating operation of an e-commerce transaction according to one embodiment of the present invention;

FIG. 6 is a flowchart illustrating operation of an alternate e-commerce transaction according to one embodiment of the present invention;

FIG. 7A is a block diagram illustrating an overview of optimization according to one embodiment;

FIG. 7B is a dataflow diagram illustrating an overview of optimization according to one embodiment;

FIG. 8 illustrates a network system suitable for implementing an e-marketplace, according to one embodiment;

FIGS. 9A and 9B illustrate an e-marketplace with transaction optimization, according to one embodiment, wherein FIG. 9A illustrates various participants providing transaction requirements to the e-marketplace optimization server, and FIG. 9B illustrates various participants receiving transaction results from the e-marketplace optimization server;

FIG. 10 is a flowchart of a transaction optimization process, according to one embodiment;

FIGS. 11A and 11B illustrate a system for optimizing an e-marketplace, according to one embodiment;

FIG. 12 is a flowchart diagram illustrating a method of creating and using models and optimization procedures to model and/or control a business process, according to one embodiment;

FIG. 13 illustrates a support vector machine implementation, according to one embodiment;

FIGS. 14A and 14B illustrate two embodiments of an overall block diagram of the system for both preprocessing data during the training mode and for preprocessing data during the run mode;

FIGS. 15A and 15B illustrate simplified block diagrams of embodiments of the systems of FIGS. 14A and 14B;

FIG. 16 is a detailed block diagram of the preprocessor in the training mode according to one embodiment;

FIG. 17 is a simplified block diagram of the preprocess time merging operation, according to one embodiment;

FIG. 18A illustrates a data block before the time merging operation, according to one embodiment;

FIG. 18B illustrates a data block after the time merging operation, according to one embodiment;

FIGS. 19A-19C illustrate diagrammatic views of the time merging operation, according to various embodiments;

FIGS. 20A-20C are flowcharts depicting various embodiments of a preprocessing operation;

FIGS. 21A-21E illustrate the use of graphical tools for preprocessing the “raw” data, according to various embodiments;

FIG. 22 illustrates a flowchart of the steps involved in cutting or otherwise modifying the data, according to one embodiment;

FIG. 23 illustrates the display for the algorithm selection operation, according to one embodiment;

FIG. 24 is a block diagram depicting parameters associated with various stages in process flow relative to a plant output, according to one embodiment;

FIG. 25 illustrates a diagrammatic view of the relationship between the various plant parameters and the plant output, according to one embodiment;

FIG. 26 illustrates a diagrammatic view of the delay provided for input data patterns, according to one embodiment;

FIG. 27 illustrates a diagrammatic view of the buffer formation for each of the inputs and the method for generating the delayed input, according to one embodiment;

FIG. 28 illustrates the display for selection of the delays associated with various inputs and outputs in the non-linear model, according to one embodiment;

FIG. 29 is a block diagram for a variable delay selection, according to one embodiment;

FIG. 30 is a block diagram of the adaptive determination of the delay, according to one embodiment;

FIG. 31 is a flowchart depicting the time delay operation, according to one embodiment;

FIG. 32 is a flowchart depicting the run mode operation, according to one embodiment;

FIG. 33 is a flowchart for setting the value of the variable delay, according to one embodiment; and

FIG. 34 is a block diagram of the interface of the run-time preprocessor with a distributed control system, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Incorporation by Reference

U.S. Pat. No. 5,842,189, titled “Method for Operating a Neural Network With Missing and/or Incomplete Data”, whose inventors are James D. Keeler, Eric J. Hartman, and Ralph Bruce Ferguson, and which issued on Nov. 24, 1998, is hereby incorporated by reference in its entirety as though filly and completely set forth herein.

U.S. Pat. No. 5,729,661, titled “Method and Apparatus for Preprocessing Input Data to a Neural Network”, whose inventors are James D. Keeler, Eric J. Hartman, Steven A. O'Hara, Jill L. Kempf, and Devandra B. Godbole, and which issued on Mar. 17, 1998, is hereby incorporated by reference in its entirety as though filly and completely set forth herein.

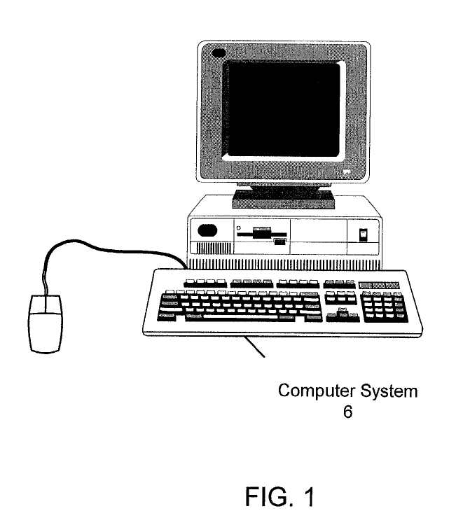

FIG. 1—Computer System

FIG. 1 illustrates a computer system 6 operable to execute a non-linear model for performing modeling and/or control operations. Several embodiments of methods for creating and/or using a non-linear model are described below. The computer system 6 may be any type of computer system, including a personal computer system, mainframe computer system, workstation, network appliance, Internet appliance, personal digital assistant (PDA), television system or other device. In general, the term “computer system” may be broadly defined to encompass any device having at least one processor that executes instructions from a memory medium.

As shown in FIG. 1, the computer system 6 may include a display device operable to display operations associated with the non-linear model. The display device may also be operable to display a graphical user interface of process or control operations. The graphical user interface may comprise any type of graphical user interface, e.g., depending on the computing platform.

The computer system 6 may include a memory medium(s) on which one or more computer programs or software components according to one embodiment of the present invention may be stored. For example, the memory medium may store one or more non-linear model software programs (e.g., neural networks or support vector machines) which are executable to perform the methods described herein. Also, the memory medium may store a programming development environment application used to create and/or execute non-linear model software programs. The memory medium may also store operating system software, as well as other software for operation of the computer system.

The term “memory medium” is intended to include various types of memory or storage, including an installation medium, e.g., a CD-ROM, floppy disks, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory or storage as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution.

As used herein, the term “neural network” refers to at least one software program, or other executable implementation (e.g., an FPGA), that implements a neural network as described herein. The neural network software program may be executed by a processor, such as in a computer system. Thus the various neural network embodiments described below are preferably implemented as a software program executing on a computer system.

As used herein, the term “support vector machine” refers to at least one software program, or other executable implementation (e.g., an FPGA), that implements a support vector machine as described herein. The support vector machine software program may be executed by a processor, such as in a computer system. Thus the various support vector machine embodiments described below are preferably implemented as a software program executing on a computer system.

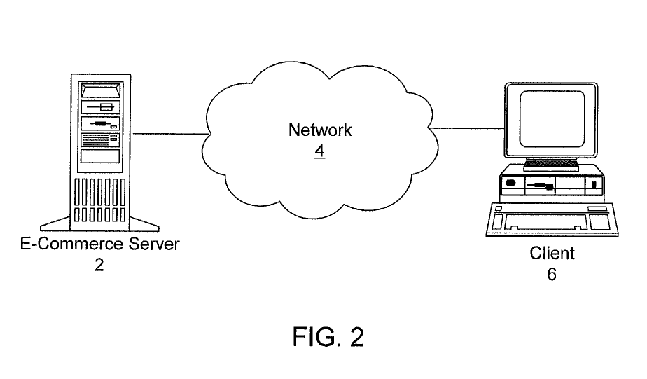

FIGS. 2 through 4—Various Network Systems for Performing E-Commerce

FIGS. 2, 3, and 4 illustrate simplified and exemplary e-commerce or Internet commerce systems that operate according to various embodiments of the present invention. The systems shown in FIGS. 2, 3, and 4 may utilize an optimization process to provide targeted inducements, e.g., promotions or advertising, to a user, such as during an e-commerce transaction. The systems shown in FIGS. 2, 3, and 4 may also utilize an optimization process to configure the e-commerce site (also called a web site) of an e-commerce vendor.

As shown in the e-commerce system of FIG. 2, the e-commerce system may include an e-commerce server 2. The e-commerce server 2 is preferably maintained by a vendor who offers products, such as goods or services, for sale over a network, such as the Internet. One example of an e-commerce vendor is Amazon.com, which sells books and other items over the Internet.

As used herein, the term “product” is intended to include various types of goods or services, such as books, music, furniture, on-line auction items, clothing, consumer electronics, software, medical supplies, computer systems etc., or various services such as loans (e.g., auto, mortgage, and home re-financing loans), securities (e.g., CDs, stocks, retirement accounts, cash management accounts, bonds, and mutual funds), ISP service, content subscription services, travel services, or insurance (e.g., life, health, auto, and home owner's insurance), among others.

As shown, the e-commerce server 2 may be connected to a network 4, preferably the Internet. The Internet is currently the primary mechanism for performing e-commerce. However, the network 4 may be any of various types of wide-area networks and/or local area networks, or networks of networks, such as the Internet, which connects computers and/or networks of computers together, thereby providing the connectivity for enabling e-commerce to operate. Thus, the network 4 may be any of various types of networks, including wired networks, wireless networks, etc. In the preferred embodiment, the network 4 is the Internet using standard protocols such as TCP/IP, http, and html or xml.

A client computer 6 may also be connected to the Internet. The client system 6 may be a computer system, network appliance, Internet appliance, personal digital assistant (PDA) or other system. The client computer system 6 may execute web browser software for allowing a user of the client computer 6 to browse and/or search the network 4, e.g., the Internet, as well as enabling the user to conduct transactions or commerce over the network 4. The network 4 is also referred to herein as the Internet 4. When the user of the client computer 6 desires to browse or purchase a product from a vendor over the Internet 4, the web browser software preferably accesses the e-commerce site of the respective e-commerce server, such as e-commerce server 2. The client 6 may access a web page of the e-commerce server 2 directly or may access the site through a link from a third party. The user of the client computer 6 may also be referred to as a customer.

When the client web browser accesses the web page of the e-commerce server 2, the e-commerce server 2 provides various data and information to the client browser on the client system 6, possibly including a graphical user interface (GUI) that displays the products offered, descriptions and prices of these products, and other information that would typically be useful to the purchaser of a product.

The e-commerce server 2, or another server, may also provide one or more inducements to the client computer system 6, wherein the inducements may be generated using an optimization process or an experiment engine. The e-commerce server 2 may include an optimizer, such as an optimization software program, which is executable to generate the one or more inducements in response to various information related to the e-commerce transaction. The operation of the optimizer in generating the inducements to be provided is discussed further below.

As used herein, the term “inducement” is intended to include one or more of advertising, promotions, discounts, offers or other types of incentives which may be provided to the user. In general, the purpose of the inducement is to achieve a desired commercial result with respect to a user. For example, one purpose of the inducement may be to encourage or entice the user to complete the purchase of the product, or to encourage or entice the user to purchase additional products, either from the current e-commerce vendor or another vendor. For example, an inducement may be a discount on purchase of a product from the e-commerce vendor, or a discount on purchase of a product from another vendor. An inducement may also be an offer of a free product with purchase of another product. The inducement may also be a reduction or discount in shipping charges associated with the product, or a credit for future purchases, or any other type of incentive. Another purpose of the inducement may be to encourage or entice the user to select or subscribe to a certain e-commerce site, or to encourage the user to provide desired information, such as user demographic information.

The inducement(s) may be provided to the user during any part of an e-commerce transaction. As used herein, an “e-commerce transaction” may include a portion, subset, or all of any stage of a user purchase of a product from an e-commerce site, including selection of the e-commerce site, browsing of products on the e-commerce site, selection of one or more products from the e-commerce site, such as using a “shopping cart” metaphor, purchasing the one or more products or “checking out,” and delivery of the product. During any stage of the e-commerce transaction, one or more inducements may be generated and displayed to the user. In one embodiment, the optimization process may determine times, such as during a user's “click flow” in navigating the e-commerce site, for provision of the inducements to the user. Thus the optimization process may optimize the types of inducements provided as well as the timing of delivery of the inducements.

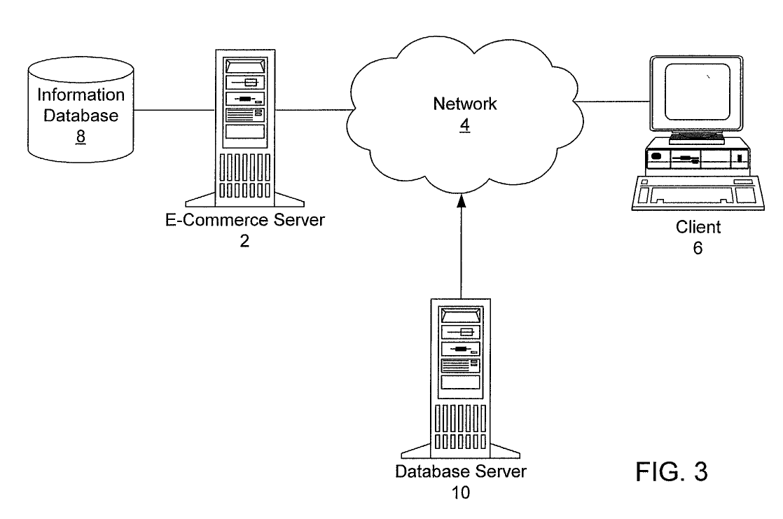

As shown in the e-commerce system of FIG. 3, an information database 8 may be coupled to or comprised in the e-commerce server 2. Alternatively, or in addition, a separate database server 10 may be coupled to the network 4, wherein the separate database server 10 includes an information database 8 (not shown). The information database 8 and/or database server 10 may store information related to the e-commerce transaction, as described above. The e-commerce server 2 may access this information from the information database 8 and/or the database server 10 for use by the optimization program in generating the one or more inducements to display to a user. Thus, the e-commerce server 2 may collect and/or store its own information database 8, and/or may access this information from the separate database server 10.

As noted above, the information database 8 and/or database server 10 may store information related to the e-commerce transaction. The information “related to the e-commerce transaction” may include user demographic information, i.e., demographic information of users, such as age, sex, marital status, occupation, financial status, income level, purchasing habits, hobbies, past transactions of the user, past purchases of the user, commercial activities of the user, affiliations, memberships, associations, historical profiles, etc. The information “related to the e-commerce transaction” may also include “user site navigation information”, which comprises information on the user's current or prior navigation of an e-commerce site of the e-commerce vendor. For example, where the e-commerce vendor maintains an e-commerce site, and the site receives input from a user during any stage of an e-commerce transaction, the user site navigation information may comprise information on the user's current navigation of the e-commerce site of the e-commerce vendor. The information “related to the e-commerce transaction” may also include time and date information, inventory information of products offered by the e-commerce vendor, and/or competitive information of competitors to the e-commerce vendor. The information “related to the e-commerce transaction” may further include number and dollar amount of products being purchased (or comprised in the shopping cart), “costs” associated with various inducements, the cost of the transaction being conducted, as well as the results from previous transactions. The information “related to the e-commerce transaction” may also include various other types of information related to the e-commerce transaction or information which is useable in selecting or generating inducements to display to users during an e-commerce transaction.

As noted above, the e-commerce server 2 may include an optimization process, such as an optimization software program, which is executable to use the information “related to the e-commerce transaction” from the information database 8 or the database server 10 to generate the one or more inducements to be provided to the user.

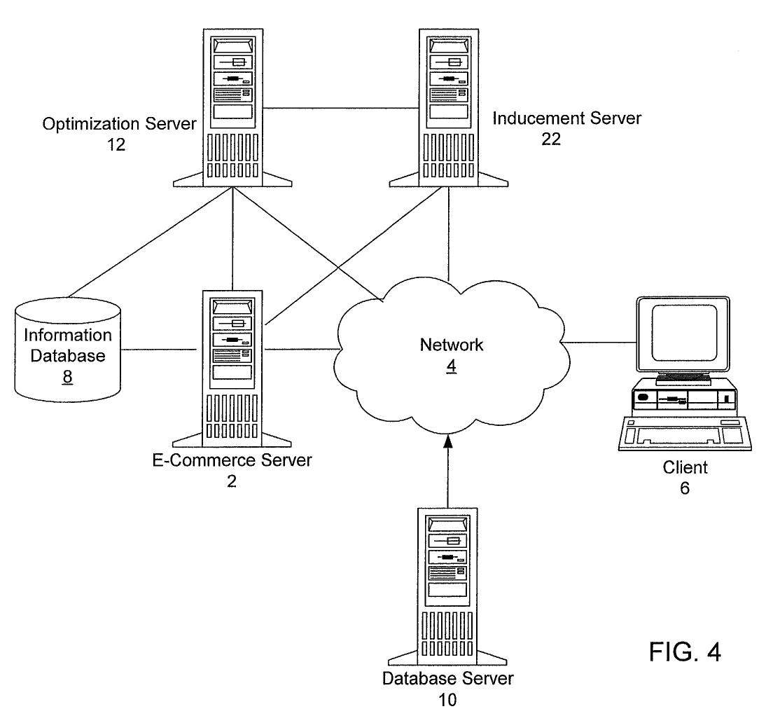

As shown in the e-commerce system of FIG. 4, the e-commerce system may also include a separate optimization server 12 and/or a separate inducement server 22. As noted above, the e-commerce server 2 may instead implement the functions of both the optimization server 12 and the inducement server 22.

The optimization server 12 may couple to the information database 8 and/or may couple through the Internet to the database server 10. Alternatively, the information database 8 may be comprised in the optimization server 12. The optimization server 12 may also couple to the e-commerce server 2.

The optimization server 12 may include the optimization software program and may execute the optimization software program using the information to generate the one or more inducements to be provided to the user. Thus, the optimization software program may be executed by the e-commerce server 2 or by the separate optimization server 12. The optimization server 12 may also store the inducements which are provided to the client computer system 6, or the inducements may be provided by the e-commerce server 2. The optimization server 12 may be operated directly by the e-commerce vendor who operates the e-commerce server 2, or by a third party company. Thus, the optimization server 12 may offload or supplement the operation of the e-commerce server 2, i.e., offload this task from the e-commerce vendor.

The system may also include a separate inducement server 22 which may couple to the Internet 4 as well as to one or both of the optimization server 12 and the e-commerce server 2. The inducement server 22 may operate to receive information regarding inducements generated by the optimization software program, either from the e-commerce server 2 or the optimization server 12, and source the inducements to the client 6. Alternatively, the inducement server 22 may also include the optimization software program for generating the inducements to be provided to the client computer system 6. The inducement server 22 may be operated directly by the e-commerce vendor who operates the e-commerce server 2, by the third party company who operates the optimization server 12, or by a separate third party company. Thus, the inducement server 22 may offload or supplement the operation of the e-commerce server 2 and/or the optimization server 12, i.e., off load this task from the e-commerce vendor or the optimization provider who operates the optimization server 12.

In the e-commerce system of FIG. 4, one or both of the optimization server 12 or the inducement server 22 may not be coupled to the internet for security reasons, and thus the optimization server 12 and/or inducement server 22 may use other means for communicating with the e-commerce server 2. For example, the optimization server 12 and/or inducement server 22 may connect directly to the e-commerce server 2, or directly to each other, (not through the Internet), e.g., through a direct connection such as a dedicated T1 line, frame relay, Ethernet LAN, DSL, or other dedicated (and presumably more secure) communication channel.

It is noted that the e-commerce systems of FIGS. 2, 3, and 4 are exemplary e-commerce systems. Thus, various different embodiments of e-commerce systems may also be used, as desired. The e-commerce systems shown in FIGS. 2, 3, and 4 may be implemented using one or more computer systems, e.g., a single server or a number of distributed servers, connected in various ways, as desired.

Also, FIGS. 2, 3, and 4 illustrate exemplary embodiments of e-commerce systems including one e-commerce server 2, one client computer system 6, one optimization server 12, and one inducement server 22 which may be connected to the internet 4. However, it is noted that alternate e-commerce systems may utilize any number of e-commerce servers 2, clients 6, optimization servers 12, and/or inducement servers 22.

Further, in addition to the various servers described above, an e-commerce system may include various other components or functions, such as credit card verification, payment, inventory, shipping, among others.

Each of the e-commerce server 2, optimization server 12, and/or the inducement server 22 may include various standard components such as one or more processors or central processing units and one or more memory media, and other standard components, e.g., a display device, input devices, a power supply, etc. Each of the e-commerce server 2, optimization server 12, and/or the inducement server 22 may also be implemented as two or more different computer systems.

At least one of the e-commerce server 2, optimization server 12, and/or the inducement server 22 preferably includes a memory medium on which computer programs are stored. Also, the servers 2, 12 and/or 22 may take various forms, including a computer system, mainframe computer system, workstation, or other device. In general, the term “computer server” or “server” may be broadly defined to encompass any device having a processor that executes instructions from a memory medium.

The memory medium may store an optimization software program for implementing the optimized inducement generation process. The software program may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A CPU of one of the servers 2, 12 or 22 executing code and data from the memory medium comprises a means for implementing an optimized inducement generation process according to the methods or flowcharts described below.

Various embodiments further include receiving or storing instructions and/or data implemented in accordance with the foregoing description upon a carrier medium. Suitable carrier media include memory media or storage media such as magnetic or optical media, e.g., disk or CD-ROM, as well as signals such as electrical, electromagnetic, or digital signals, conveyed via a communication medium such as networks and/or a wireless link.

The optimization server 12, the e-commerce server 2, and/or the inducement server 22 may be programmed according to one embodiment to generate and/or provide one or more inducements to a user conducting an e-commerce transaction. In the following description, for convenience, the e-commerce system is described assuming the e-commerce server 2 implements or executes the optimization process, i.e., executes the optimization software program (or implements the function of the optimization server 12). This is not intended to limit various possible embodiments of e-commerce systems that operate according to various embodiments of the present invention.

Targeted inducements may provide a number of benefits to e-commerce vendors. First, the amount of sales and revenue for e-commerce vendors may increase, through increased closure of purchases. Targeted inducements may also provide a number of benefits to the user, including various inducements or incentives to the user that add value to the user's purchases.

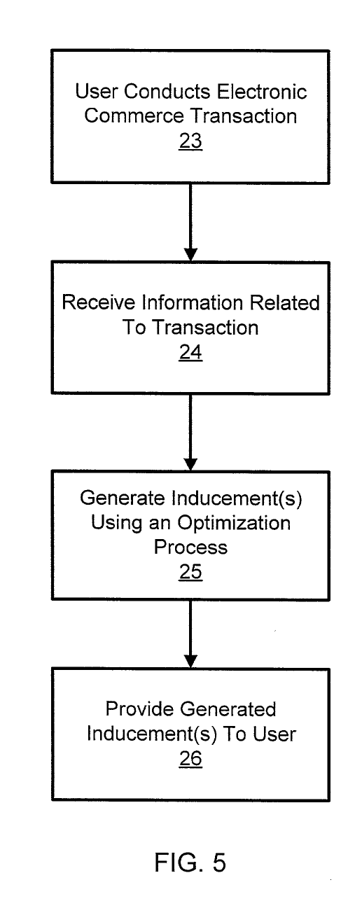

FIG. 5—Providing Optimized Inducements to a User Conducting an E-Commerce Transaction

FIG. 5 illustrates an embodiment of a method for providing one or more inducements to a user conducting an e-commerce transaction using an optimization process. It is noted that various of the steps mentioned below may occur concurrently and/or in different orders, or may be absent in some embodiments.

As shown, in step 23 the method may comprise receiving input from a user conducting an e-commerce transaction with an e-commerce vendor. For example, an e-commerce server 2 of the e-commerce vendor may receive the user input, wherein the user is conducting the e-commerce transaction with the e-commerce server 2. The user input may comprise the user selecting the e-commerce site, or the user browsing the site, e.g., the user selecting a product or viewing information about a product. The user input may also comprise the user entering various user demographic information, or information to purchase a product. Thus the user input may occur during any part of the e-commerce transaction.

As noted above, an e-commerce transaction may include a portion, subset or all of any of various stages of a user purchase of a product from an e-commerce site, including selection of the e-commerce site, browsing of products on the e-commerce site, selection of one or more products from the e-commerce site, such as using a “shopping cart” metaphor, and purchasing the one or more products or “checking out”. During any stage of the e-commerce transaction, one or more inducements may be generated and displayed to the user. As used herein, the term “user” may refer to a customer, a potential customer, a business, an organization, or any other establishment.

The client system 6 may provide identification of the user to the e-commerce server 2 or another server. Alternatively, or instead the client system 6 may provide identification of itself (i.e., the client system 6), such as with a MAC ID or other identification, to the e-commerce server 2 or another server. The client system identification may then be used by the e-commerce server 2 or another server to determine the identity of the user and/or relevant demographic information of the user.

The client system 6 may provide identification using any of various mechanisms, such as cookies, digital certificates, or any other user identification method. For example, the client system 6 may provide a cookie which indicates the identity of the user or client system 6. The client system 6 may instead provide a digital certificate which indicates the identity of the user or client system 6. A digital certificate may reside in the client computer 6 and may be used to identify the client computer 6. In general, digital certificates may be used to authenticate the user and perform a secure transaction. When the user accesses the e-commerce site of the e-commerce server 2, the client system 6 may transmit its digital certificate to the e-commerce server 2. As an alternative to the use of digital certificates, a user access to an e-commerce site may include registration and the use of passwords by users accessing the site, or may include no user identification.

In step 24 the method may include storing, receiving or collecting information, wherein the information is related to the e-commerce transaction. For example, the method may use the received digital certificate or cookie from the client system to reference the user's demographic information, such as from a database. Various types of information related to the e-commerce transaction are discussed above. This information may be used to generate the one or more inducements, as well as to update stored information pertaining to the user. Where the information is financial information received from a user, the financial information may be verified.

For example, pertinent information may be retrieved via accessing an internal or separate database 8 or database server 10, respectively, for demographic information, historical profiles, inventory information, environmental information, competitor information, or other information “related to the e-commerce transaction”. Here, a separate database may refer to a remote database server 10 maintained by the e-commerce vendor, or a database server 10 operated and/or maintained by a third party, e.g., an infomediary. Thus, the e-commerce server 2 may access information from its own database and/or a third party database. In one embodiment, the method may include collecting information during the e-commerce transaction, such as demographic information regarding the user or the user's navigation of the e-commerce site, often referred to as “click flow”. This collected information may then be used, possibly in conjunction with other information, in generating the one or more inducements.

In one embodiment, the method may include collecting demographic information of the user during the e-commerce transaction, which may then be used to generate the one or more inducements. For example, upon registration and/or during checkout, the user might be asked to supply demographic information, such as name, address, hobbies, memberships, affiliations, etc.

For another example, environmental information, such as geographic information, local weather conditions, traffic patterns, popular hobbies, etc. may be determined based on the user's address to display specific products suitable for conditions in the user's locale, such as rain gear during the wet season.

In one embodiment, in order for the e-commerce vendor to gain information about the user, the user may be presented with an opportunity to complete a survey, upon completion of which the user may receive an inducement, such as a discount toward current or future purchases. In this manner, stored user demographic information may be kept current.

In step 25 the method may generate one or more inducements in response to the information, wherein the generation of inducements uses an optimization process. In one embodiment, the generation of the one or more inducements may comprise inputting the information into an optimization process, and the optimization process generating (e.g., selecting or creating) one or more inducements in response to the information. The optimization process may use constrained optimization techniques.

The optimization process may comprise inputting the information related to the e-commerce transaction into at least one predictive model to generate one or more action variables. The action variables may comprise predictive user behaviors corresponding to the information. The action variables, as well as other data, such as constraints and an objective function, may then be input into an optimizer, which then may generate the one or more inducements to be presented to the user.

In various embodiments, the predictive model may comprise one or more linear predictive models, and/or one or more non-linear predictive models (e.g., neural networks, support vector machines). Non-linear predictive models may of course include both continuous non-linear models and non-continuous non-linear models. In various embodiments, the predictive model may comprise one or more trained neural networks. One example of a trained neural network is described in U.S. Pat. No. 5,353,207, incorporated by reference as noted above. In other embodiments, the predictive model may comprise one or more trained support vector machines. The predictive model may be trained using the on-line training method and system of the present invention, as described in greater detail below.

As is well known in the art, a neural network comprises an input layer of nodes, an output layer of nodes, and a hidden layer of nodes disposed therein, and weighted connections between the hidden layer and the input and output layers. In a neural network embodiment used in the invention, the connections and the weights of the connections essentially contain a stored representation of the e-commerce system and the user's interaction with the e-commerce system.

The neural network may be trained using back propagation with historical data or any of several other neural network training methods, as would be familiar to one skilled in the art. The above-mentioned information, including results of previous transactions of the user responding to previous inducements, which may be collected during the e-commerce transaction, may be used to update the predictive model(s). The predictive model may be updated either in a batch mode, such as once per day or once per week, or in a real-time mode, wherein the model(s) are updated continuously as new information is collected.

In one embodiment, designed experiments may be used to create the initial training input data for a non-linear model (e.g., a neural network model, or a support vector machine model). When the system or method is initially installed on an e-commerce server, the method may present a range of inducements to a subset of users or customers. The users or customers resultant behaviors to these inducement may be recorded, and then combined with demographic and other data. This information may then be used as the initial training input data for the non-linear model. This process may be repeated at various times to update the non-linear model, as desired.

As noted above, the optimizer may receive one or more constraints, wherein the constraints comprise limitations on one or more resources, and may comprise functions of the action variables. Examples of the constraints include budget limits, number of inducements allowed per customer, value of an inducement, or total value of inducements dispensed. The optimizer may also receive an objective function, wherein the objective function comprises a function of the action variables and represents the goal of the e-commerce vendor. In one embodiment, the objective function may represent a desired commercial goal of the e-commerce vendor, such as maximizing profit, or increasing market share. As another example, if the user is a habitual customer of the e-commerce vendor, the objective function may be a function of lifetime customer value, wherein lifetime customer value comprises a sum of expected cash flows over the lifetime of the customer relationship.

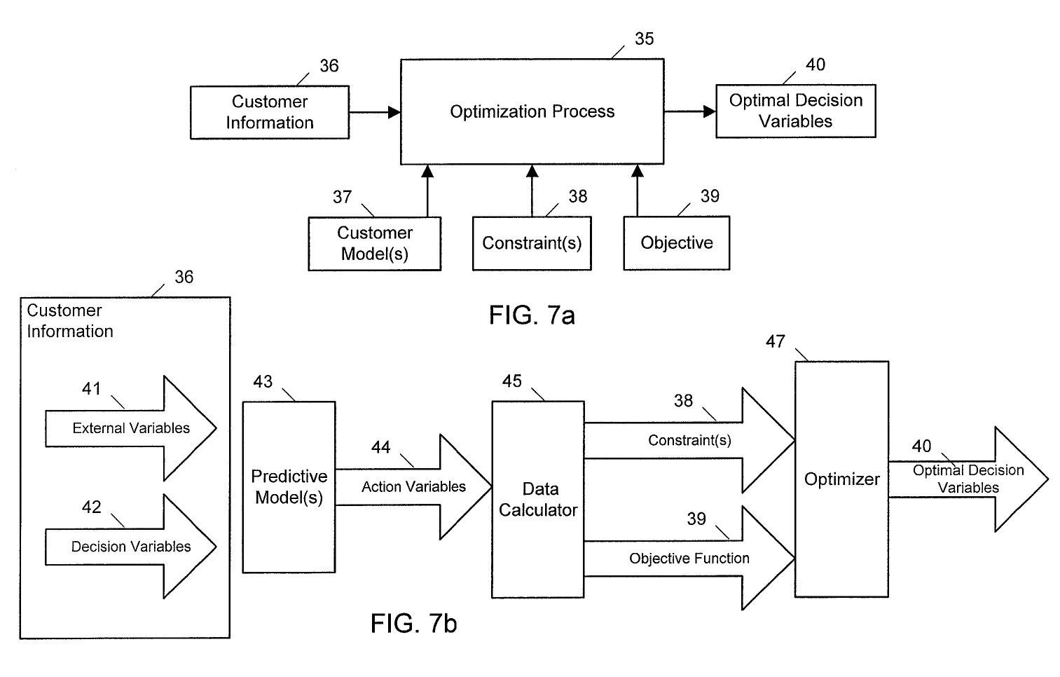

The optimizer may then solve the objective function subject to the constraints and generate (e.g., select) the one or more inducements. The optimization process is described in greater detail below with respect to FIGS. 7a and 7b.

After the optimizer generates one or more inducements in response to the information using the optimization process, in step 26 the method then provides the one or more generated inducements to the user. More specifically, the e-commerce server 2 (or the optimization server 12 or the inducement server 22) may provide the inducement(s) to the client computer system 6, where the inducements are displayed, preferably by a browser, on the client computer system 6. As discussed above, the inducement(s) are preferably designed to encourage or entice the user to complete the transaction in a desired way, such as by purchasing a product, purchasing additional products, selecting a particular e-commerce site, providing desired user demographic information, etc. In one embodiment, the one or more inducements may be pre-selected and then provided to the user while the user conducts the e-commerce transaction. In another embodiment, the inducement(s) may be both selected and provided substantially in real-time while the user is conducting the e-commerce transaction.

The user's response to the one or more inducements presented may be monitored and/or recorded for use in subsequent on-line training of the non-linear model. In some cases, the processing of the user's response via the on-line training may cause the non-linear model to be updated.

As one example, during user checkout to purchase a product from the e-commerce vendor, the one or more generated inducements may be provided and displayed to the user on the client system 6 to encourage the user to complete the purchase. In response to the inducements provided and displayed to the user, the user may provide input to complete purchase of the product from the e-commerce vendor. The user input to complete purchase of the product from the e-commerce vendor may include acceptance of the one or more inducements. The e-commerce vendor would then provide the product to the user, incorporating any inducements or incentives made to the user, such as discounts, free gifts, discounted shipping etc.

As another example, the one or more generated inducements may be provided and displayed to the user while the user is browsing products on the e-commerce site to encourage or entice the user to purchase these products, e.g., to add the products to the virtual shopping cart. In response to the inducements provided and displayed to the user, the user may provide input to add products to the shopping cart. In one embodiment, the inducements that are made to encourage the user to add the products to the virtual shopping cart may only be valid if the products are in fact purchased by the user.

After the user has responded to the inducement, the method may include collecting information regarding the user's response to the particular inducement provided. This collected information may then be used to update or train the predictive model(s), e.g., to train the neural network(s), or to train the support vector machines. The collected information may include not only the particular inducement provided and the user's response, but also the timing of the inducement with respect to the user's navigation of the e-commerce site. The optimization process may then take this information into account in the future presentations of inducements to users, thus the types of inducements presented as well as the timing of inducement presentation may be optimized.

The above-mentioned information regarding the user's response to inducements may also be stored and compiled to generate summary displays and reports to allow the e-commerce vendor or others to review the results of inducement offerings. The summary displays and reports may include, but are not limited to, percentage responses of particular classes or segments of users to particular inducements presented at particular stages or times in the “click flow” of the users' site navigation, revenue increases as a function of inducements, inducement timing, and/or user demographics, or any other information or correlations germane to the e-commerce vendor's goals.

In an alternate embodiment, the predictive model is a commerce model of a commerce system which is used to predict a defined commercial result as a function of information related to the e-commerce transaction and also as a function of the inducements that may be provided to the user during the e-commerce transaction. The optimal inducement is generated by varying the inducement input to the commerce model to vary the predicted output of the commerce model in a predetermined manner until a desired predicted output of the commerce model is achieved, at which point, the optimal inducement has been generated. In this embodiment, the predictive model may be a non-linear model (e.g., a trained neural network or a trained support vector machine).

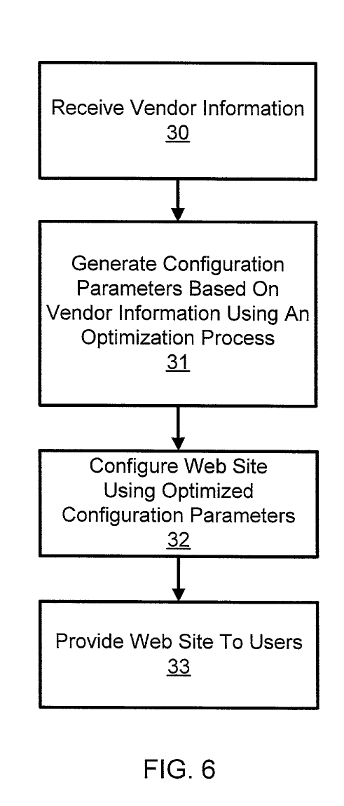

FIG. 6—Optimized Configuration of an E-Commerce Site

FIG. 6 illustrates an embodiment of a method for configuring an e-commerce site using an optimization process. Here it is presumed that the e-commerce site is maintained by an e-commerce vendor, and that the e-commerce site is useable for conducting e-commerce transactions. It is noted that various of the steps mentioned below may occur concurrently and/or in different orders, or may be absent in some embodiments.

As shown, in step 30 the method comprises receiving vendor information, wherein the vendor information is related to products offered by the e-commerce vendor. As used herein, “vendor information” may include an inventory of products offered by the e-commerce vendor, time and date information, environmental information, and/or competitive information of competitors to the e-commerce vendor. The vendor information is preferably not specific to any one user, but rather is related generally to the e-commerce vendor's products, web site or other general information. In one embodiment, the vendor information may include user-specific information, which may entail customizing portions of the e-commerce site for specific users.

In one example, the vendor information may include inventory information pertaining to which of the e-commerce vendor's products are over-stocked, so that they may be featured prominently on the e-commerce site or placed on sale, and/or those that are under-stocked or sold out, so that the price may be adjusted or selectively removed.

In another example, the vendor information may comprise seasonal and/or cultural information, such as the beginning and end of the Christmas season, or Cinco de Mayo, whereupon appropriate marketing and/or graphical themes may be presented.

In yet another example, the vendor information may involve competitive information of competitors, such as the competitor's current pricing of products identical to or similar to those sold by the e-commerce vendor. The e-commerce vendor's prices may then be adjusted, or product presentation may be changed.

In step 31 the method includes generating a configuration of the e-commerce site in response to the vendor information, wherein generation of the e-commerce site configuration uses an optimization process. In one embodiment, generating the configuration of the e-commerce site includes modifying one or more configuration parameters of the e-commerce site and/or generating one or more new configuration parameters of the e-commerce site. For example, one or more configuration parameters of the e-commerce site may represent one or more of a color or a layout of the e-commerce site. One or more configuration parameters of the e-commerce site may also represent content comprised in or presented by the e-commerce site, such as text, images, graphics, audio, or other types of content. One or more configuration parameters of the e-commerce site may also represent one or more inducements, such as promotions, advertisements, offers, or product purchase discounts or incentives, in the e-commerce site, as described above with respect to FIG. 5.

The optimization process used to generate the e-commerce site configuration is described above with reference to FIG. 5, but in this embodiment of the invention, the information input into the predictive model is the vendor information, and the optimized decision variables comprise the e-commerce site configuration parameters. Examples of the constraints in this embodiment may comprise the number of products displayed, the number of colors employed simultaneously on the page, or limits on the values of sale discounts. The objective function represents a given desired commercial goal of the e-commerce vendor, such as increased profits, increased sales of a particular product or product line, increased traffic to the e-commerce site, etc. Further detailed description of the optimization process may be found below, with reference to FIGS. 7a and 7b.

Once the optimizer has solved the objective function, in step 32, the resulting configuration parameters may be applied to the e-commerce site. In other words, the e-commerce site may be configured, modified, or generated based on the configuration parameters produced by the optimization process. Thus a designer may change one or more of a color, layout, or content of the e-commerce site. In an alternate embodiment, the optimized configuration parameters may be applied to the e-commerce site automatically by software designed for that purpose which may reside on the e-commerce server. In this way, the e-commerce site may in large part be configured without the need for direct human involvement.

For example, modification of one or more configuration parameters of the e-commerce site may entail modifying one or more of a color or a layout of the e-commerce site. Modification of one or more configuration parameters of the e-commerce site may also entail modifying content comprised in or presented by the e-commerce site, such as text, images, graphics, audio, or other types of content. Modification of one or more configuration parameters of the e-commerce site may also include incorporating one or more inducements, such as promotions, advertisements, or product purchase discounts or incentives, in the e-commerce site in response to the vendor information, as described above with respect to FIG. 5.

In step 33 the method may include making the reconfigured e-commerce site available to users of the e-commerce site. In other words, when users connect to the e-commerce site, the newly configured e-commerce pages may be provided to the user and displayed on the client system of the user. These newly configured e-commerce pages are designed to achieve a desired commercial goal of the e-commerce vendor.

The responses of one or more users to the reconfigured e-commerce site presented may be monitored and/or recorded for use in subsequent on-line training of the non-linear model. In some cases, the processing of the responses via the on-line training may cause the non-linear model to be updated.

It is noted that, although the embodiments illustrated in FIGS. 5 and 6 have much in common, they differ in the following way. The inducement optimization embodiment of FIG. 5 is preferably executed with the aim of influencing an individual user by customizing the inducements which may be based primarily on information specific to that user, or to a user segment or sample of which that user is a member. In contrast, the configuration optimization embodiment of FIG. 6 is preferably executed with the aim of influencing a broad group of users based primarily on information, circumstances, and needs of the e-commerce vendor. It is noted that the embodiments of FIGS. 5 and 6 are not mutually exclusive, and so may be used in conjunction with each other to further the commercial goals of the e-commerce vendor.

FIG. 7—Overview of Optimization

As discussed herein, optimization may generally be used by a decision-maker associated with a business to select an optimal course of action or optimal course of decision. The optimal course of action or decision may include a sequence or combination or actions and/or decisions. For example, optimization may be used to select an optimal course of action for marketing one or more products to one or more customers, e.g., by selecting inducements or web site configuration for an e-commerce site. As used herein, a “customer” may include an existing customer or a prospective customer of the business. As used herein, a “customer” may include one or more persons, one or more organizations, or one or more business entities. As used herein, the term “product” is intended to include various types of goods or services, as described above. It is noted that optimization may be applied to a wide variety of industries and circumstances.

Generally, a business may desire to apply the optimal course of action or optimal course of decision to one or more customer relationships to increase the value of customer relationships to the business. As used herein, a “portfolio” may include a set of relationships between the business and a plurality of customers. In general, the process of optimization may include determining which variables in a particular problem are most predictive of a desired outcome, and what treatments, actions, or mix of variables under the decision-maker's control (i.e., decision variables) will optimize the specified value. The one or more products may be marketed to customers in accordance with the optimal course of action, such as through inducements displayed on an e-commerce site, or an optimized web site configuration. Other means of applying the optimal course of action may include, for example, (i) conducting an acquisition campaign in accordance with the optimal course of action, (ii) conducting a promotional campaign in accordance with the optimal course of action, (iii) conducting a re-pricing campaign in accordance with the optimal course of action, (iv) conducting an e-mailing campaign in accordance with the optimal course of action, and/or (v) direct mailing and/or targeted advertising.

FIG. 7a is a block diagram which illustrates an overview of optimization according to one embodiment. FIG. 7b is a dataflow diagram which illustrates an overview of optimization according to one embodiment. As shown in FIG. 7a, an optimization process 35 may accept the following elements as input: customer information records 36, predictive model(s) such as customer model(s) 37, one or more constraints 38, and an objective 39. The optimization process 35 may produce as output an optimized set of decision variables 40. In one embodiment, each of the customer model(s) 37 may correspond to one of the customer information records 36. Additionally or alternatively, the customer model(s) 37 may include historical data and/or real-time data, as described in the on-line training methods below. As used herein, an “objective” may include a goal or desired outcome of a process (e.g., an optimization process).

As used herein, a “constraint” may include a limitation on the outcome of an optimization process. Constraints are typically “real-world” limits on the decision variables and are often critical to the feasibility of any optimization solution. Constraints may be specified for numerous variables (e.g., decision variables, action variables, among others). Managers who control resources and/or capital, or are responsible for financial outcomes should be involved in setting constraints that accurately represent their real-world environments. Setting constraints with management input may realistically restrict the allowable values for the decision variables.

In many applications of the optimization process 35, the number of customers involved in the optimization process 35 may be so large that treating the customers individually is computationally infeasible. In these cases, it may be useful to group like customers together in segments. If segmented properly, the customers belonging to a given segment will typically have approximately the same response in the action variables (shown in FIG. 7b) to a given change in decision variables and external variables.

For example, customers may be placed into particular segments based on particular customer attributes such as risk level, financial status, or other demographic information. Each customer segment may be thought of as an average customer for a particular type or profile. A segment model, which represents a segment of customers, may be used as described above with reference to a customer model 37 to generate the action variables for that segment. Another alternative to treating customers individually is to sample a larger pool of customers. Therefore, as used herein, a “customer” may include an individual customer, a segment of like customers, and/or a sample of customers. As used herein, a “customer model”, “predictive model”, or “model” may include segment models, models for individual customers, and/or models used with samples of customers. The customer information 36 may include external variables 41 and/or decision variables 42, as shown in FIG. 7b. As used herein, “decision variables” are those variables that the decision-maker may change to affect the outcome of the optimization process 35. For example, in the optimization of inducements provided to a user viewing an e-commerce site, the type of inducement and value of inducement may be decision variables. As used herein, “external variables” are those variables that are not under the control of the decision-maker. In other words, the external variables are not changed in the decision process but rather are taken as givens. For example, external variables may include variables such as customer addresses, customer income levels, customer demographic information, credit bureau data, transaction file data, cost of funds and capital, and other suitable variables.

In one embodiment, the customer information 36, including external variables 41 and/or decision variables 42, may be input into the predictive model(s) 43 to generate the action variables 44. In one embodiment, each of the predictive model(s) 43 may correspond to one of the customer information records 36, wherein each of the customer information records 36 may include appropriate external variables 41 and/or decision variables 42. As used herein, “action variables” are those variables that predict a set of actions for an input set of external variables and decision variables. In other words, the action variables may comprise predictive metrics for customer behavior. For example, in the optimization of inducements provided to users, the action variables may include the probability of a customer's response to an inducement. In a re-pricing campaign, the action variables may include the likelihood of a customer maintaining a service after the service is re-priced. In the optimization of a credit card offer, the action variables may include predictions of balance, attrition, charge-off, purchases, payments, and other suitable behaviors for the customer of a credit card issuer.

The predictive model(s) 43 may include the customer model(s) 37 as well as other models. The predictive model(s) 43 may take any of several forms, including, but not limited to: trained neural networks, trained support vector machines, statistical models, analytic models, and any other suitable models (e.g., other trained or untrained non-linear models) for generating predictive metrics. The models may take various forms including linear or non-linear (e.g., a neural network, or a support vector machine), and may be derived from empirical data or from managerial judgment.

In one embodiment, the predictive model(s) 43 may be implemented as a non-linear model (e.g., a neural network, or a support vector machine). In the neural network implementation, typically, the neural network includes a layer of input nodes, interconnected to a layer of hidden nodes, which are in turn interconnected to a layer of output nodes, wherein each connection is associated with an adjustable weight whose value is set in the training phase of the model. The neural network may be trained, for example, with historical customer data records as input, as further described below in various embodiments of the present invention. The trained neural network may include a non-linear mapping function that may be used to model customer behaviors and provide predictive customer models in the optimization system. The trained neural network may generate action variables 44 based on customer information 36 such as external variables 41 and/or decision variables 42.

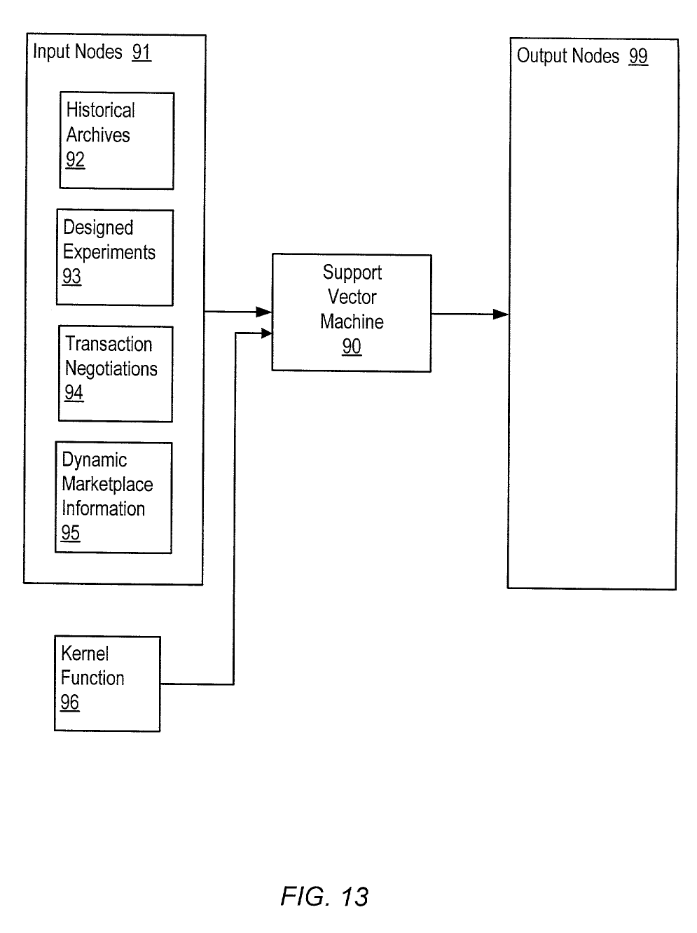

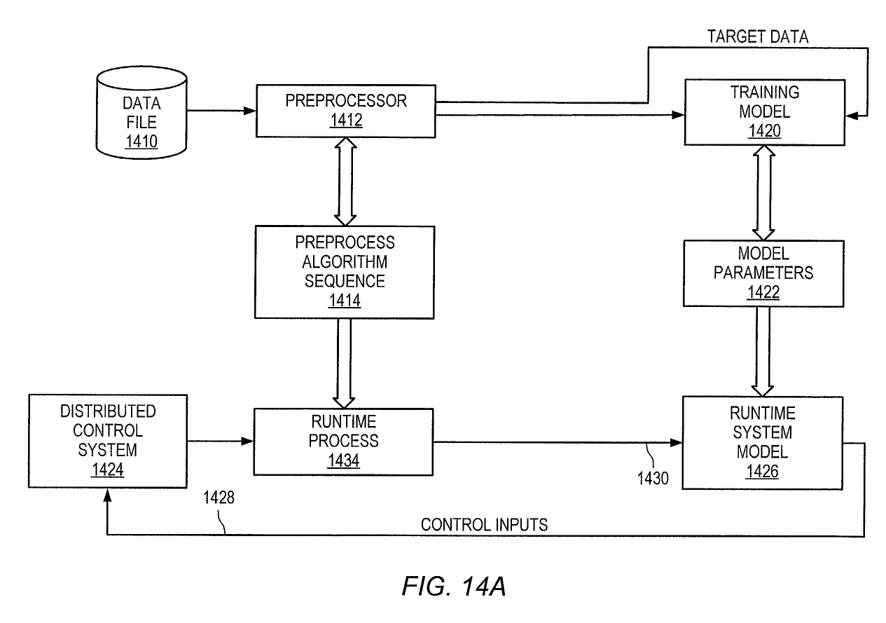

In the support vector machine implementation, typically, the support vector machine includes a layer of input nodes, interconnected to a layer of support vectors, which are in turn interconnected to a layer of output nodes, wherein each node computes a non-linear function of values of the support vectors. See FIG. 13 for more detail on a support vector machine implementation.

In one embodiment, a model may comprise a representation that allows prediction of action variables, a, due to various decision variables, d, and external variables, e. For example, a customer may be modeled to predict customer response to various offers under various circumstances. It may be said that the action variables, a, are a function, via the model, of the decision and external variables, d and e, such that: a=M(d,e) wherein M( ) is the model, a, is the vector of action variables, d is the vector of decision variables, and e is the vector of external variables.

In one embodiment, the action variables 44 generated by the predictive model(s) 43 may be used to formulate constraint(s) 38 and the objective function 39 via formulas. As shown in FIG. 7b, a data calculator 45 may generate the constraint(s) 38 and objective function 39 using the action variables 44 and potentially other data and variables. In one embodiment, the formulas used to formulate the constraint(s) 38 and objective function 39 may include financial formulas such as formulas for determining net operating income over a certain time period. The constraint(s) 38 and objective function 39 may be input into an optimizer 47, which may comprise, for example, a custom-designed process or a commercially available “off the shelf” product. The optimizer may then generate the optimal decision variables 40 which have values optimized for the goal specified by the objective function 39 and subject to the constraint(s) 38. A further understanding of the optimization process 35 and the optimizer 47 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

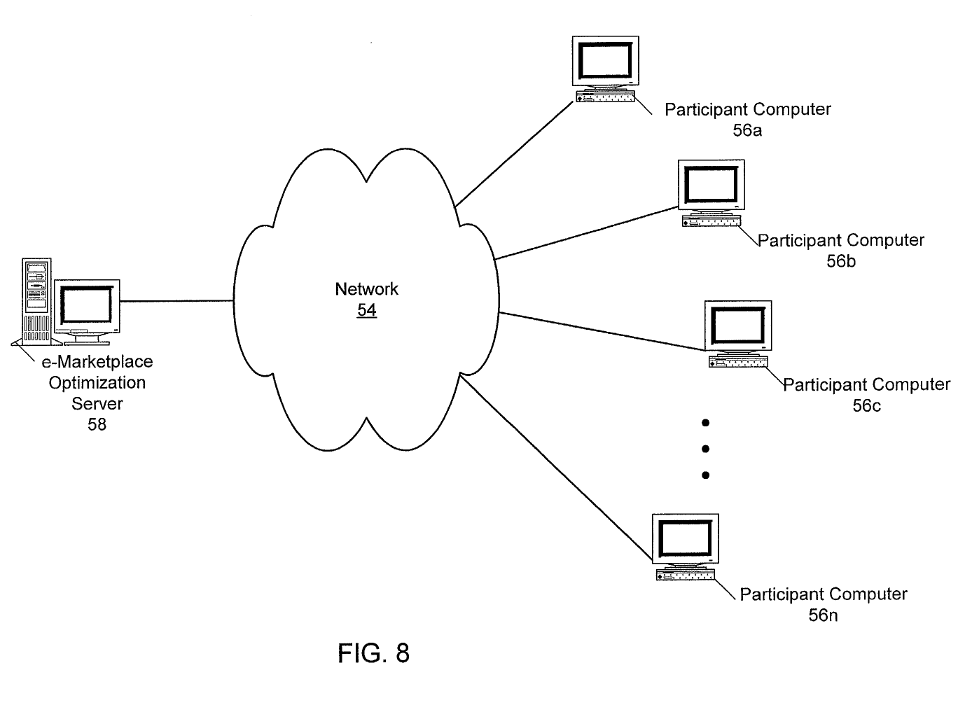

FIG. 8—An E-Marketplace System

FIG. 8 illustrates a network system suitable for implementing an e-marketplace, according to one embodiment. As FIG. 8 shows, an e-marketplace optimization server 58 is communicatively coupled to a plurality of participant computers 56 through a network 54. Each of the participant computers 56 may be operated by or on behalf of a participant. As used herein, the term “participant” is used to refer to one or both of participant and participant computer 56. The network 54 may be a Local Area Network (LAN), or a Wide Area Network (WAN) such as the Internet.

In one embodiment, the e-marketplace optimization server 58 may host an e-commerce site which is operable to provide an e-marketplace where goods and services may be bought and sold among participants 56. The e-marketplace optimization server 58 may comprise one or more server computer systems for implementing e-marketplace optimization as described herein.

Each participant 56 may be a buyer or a seller, or possibly a service provider, depending upon a particular transaction being conducted. Note that for purposes of simplicity, similar components, e.g., participant computers 56a, 56b, 56c, and 56n may be referred to collectively herein by a single reference numeral, e.g., 56.

The e-marketplace optimization server 58 preferably includes a memory medium on which computer programs are stored. For example, the e-marketplace optimization server 58 may store a transaction optimization program for optimizing e-marketplace transactions among a plurality of participants 56. The e-marketplace optimization server 58 may also store web site hosting software for presenting various graphical user interfaces (GUIs) on the various participant computer systems 56 and for communicating with the various participant computer systems 56. The GUIs presented on the various participant computer systems 56 may be used to allow the participants to provide transaction requirements to the e-marketplace optimization server 58 or receive transaction results from the e-marketplace optimization server 58.

Thus, an e-marketplace may function as a forum to facilitate transactions between participants and may comprise an e-commerce site. The e-commerce site may be hosted on an e-commerce server computer system (e.g., e-commerce server 2, described in previous Figures). The e-marketplace optimization server 58 may take various forms, including one or more connected computer systems.

The memory medium preferably stores one or more software programs for providing an e-marketplace and optimizing transactions among various participants. The software program may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

In one embodiment, each of the participant computers 56 may include a memory medium which stores standard browser software, which is used for displaying a graphical user interface presented by the e-marketplace optimization server 58. In another embodiment, each of the participant computers 56 may store other client software for interacting with the e-marketplace optimization server 58.

The e-marketplace may serve to facilitate the buying and selling of goods and services in any industry, including metals, wood and paper, food, manufacturing, electronics, healthcare, insurance, finance, or any other industry in which goods or services may be bought and sold. In one embodiment, the e-marketplace may serve the chemical manufacturing industry, providing a forum for the purchase and sale of raw chemicals and chemical products. There may be multiple suppliers (sellers) of a given product, such as polypropylene for example, and a single buyer who wishes to place an order for the product. The multiple suppliers may compete to fill the order of the single buyer. In another embodiment, there may be multiple buyers and one supplier of a product. The multiple customers may then compete to receive an order from the supplier. In yet another embodiment, there may be multiple buyers and multiple sellers involved in a given transaction, in which case a complex transaction may result in which multiple sub-transactions may be conducted among the participants 56.

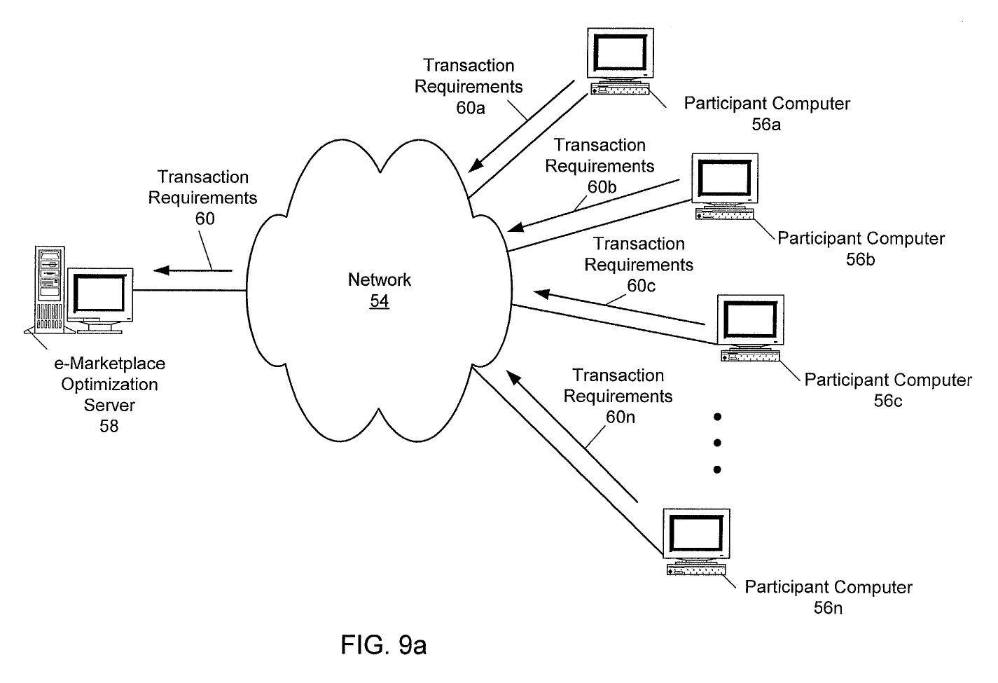

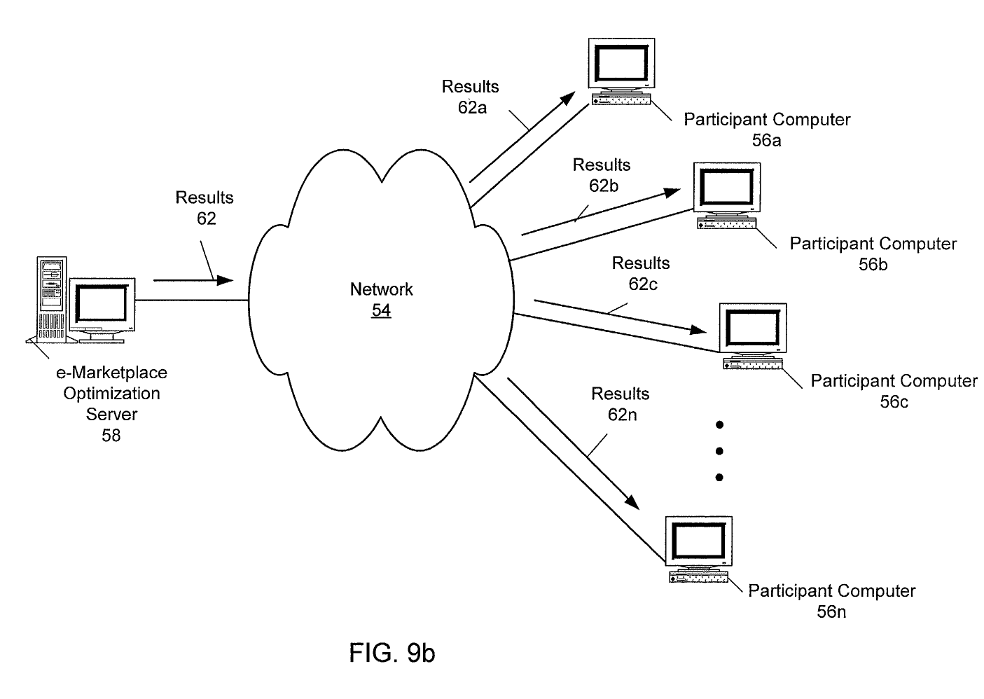

FIG. 9—An E-Marketplace with Transaction Optimization

FIGS. 9a and 9b illustrate an e-marketplace system with transaction optimization, according to one embodiment. As shown, the embodiments illustrated in FIGS. 9a and 9b are substantially similar to that illustrated in FIG. 8. FIG. 9a illustrates various participants 56 providing transaction requirements 60 to the e-marketplace optimization server 58, and FIG. 9b illustrates various participants 56 receiving transaction results 62 from the e-marketplace optimization server 58.

The e-marketplace optimization server 58, in addition to hosting the e-marketplace site, may also be operable to provide optimization services to the e-marketplace. The optimization services may comprise mediating a transaction among the participants 56 such that the desired outcome best serves the needs and/or desires of two or more of the participants. In one embodiment, the transaction may be optimized by a transaction optimization program or engine which is stored and executed on the e-marketplace optimization server 58. For example, in the case mentioned above where there are multiple sellers and one buyer, the transaction optimization program may generate a transaction which specifies one of the sellers to provide the product order to the buyer, at a particular price, by a particular time, such that the buyer's needs are met as well as those of the seller.

As shown in FIG. 9a, the plurality of participant computer systems 56 may be coupled to the server computer system 58 over the network 54. Each of the participant computers 56 may be operable to provide transaction requirements 60 to the server 58. For each of the plurality of participants, the transaction requirements 60 may include one or more of constraints, objectives and other information related to the transaction. The constraints and/or objectives may include parameter bounds, functions, algorithms, and/or models which specify each participant's transaction guidelines. In one embodiment, each participant may, at various times, modify the corresponding transaction requirements 60 to reflect the participant's current transaction constraints and/or objectives. As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model (or function) may also be used to express objectives of the transaction for a participant.

As FIG. 9a shows, each participant's transaction requirements 60 may be sent to the e-marketplace optimization server 58. The e-marketplace optimization server 58 may then execute the transaction optimization program using the transaction requirements 60 from each of the plurality of participant computer systems to produce optimized transaction results for each of the plurality of participants. The transaction optimization program may include a model of at least a portion of the e-marketplace. For example, the model may comprise a model of a transaction, a model of one or more participants, or a model of the e-marketplace itself. In one embodiment, the model may be implemented as a non-linear model (e.g., a neural network, or a support vector machine). The term “support vector machine” is used synonymously with “support vector” herein.

In one embodiment, the transaction optimization program may use the model to predict transaction results for each of the plurality of participants. The transaction optimization program may use these results to optimize the transaction among a plurality of participants.

As shown in FIG. 9b, after the transaction optimization program executing on the e-marketplace server 58 has generated the transaction results 62, the transaction results 62 may be sent to each of the participants 56 over the network 54. In one embodiment, the transaction results 62 may specify which of the participants is included in the transaction, as well as the terms of the transaction and possibly other information.

In one embodiment, each of the participants may receive the same transaction results 62, i.e. each of the participants may receive the terms of the optimized transaction, including which of the participants were selected for the transaction. In another embodiment, each participant may receive only the transaction results 62 which apply to that participant. For example, the terms of the optimized transaction may only be delivered to those participants which were included in the optimized transaction, while the participants which were excluded from the transaction (or not selected for the transaction) may receive no results. In another embodiment, the terms of the optimized transaction may be delivered to each of the participants, but the identities of the participants selected for the optimized transaction may be concealed from those participants who were excluded in the optimized transaction.

In one embodiment, the transaction optimization program may include an optimizer which operates to optimize the transaction according to the constraints and/or objectives comprised in the transaction requirements 60 from each of the plurality of participant computer systems 56.

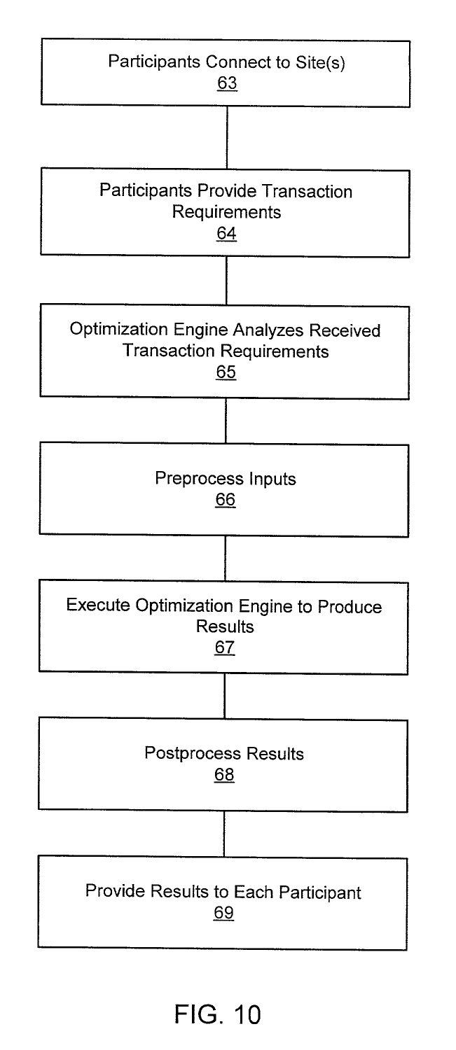

FIG. 10—Transaction Optimization Process

FIG. 10 is a flowchart of a transaction optimization process, according to one embodiment. As FIG. 10 shows, in step 63, participants may connect to an e-marketplace site over a network 54, such as the Internet. The e-marketplace site may be hosted on e-marketplace server 58. The participants preferably connect to the e-marketplace server 58 using participant computer systems 56 which are operable to communicate with the e-marketplace server 58 over the network 54. In one embodiment, the participants may communicate with the e-marketplace server through a web browser, such as Netscape Navigator™ or Microsoft Internet Explorer™. In another embodiment, custom client/server software may be used to communicate between the server and the participants.

In step 64, each participant may provide transaction requirements 60 to the e-marketplace server 58. The transaction requirements 60 may include one or more constraints and/or objectives for a given participant. The objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

In step 65, a transaction optimization engine may optionally analyze the transaction requirements 60 (constraints and/or objectives). In one embodiment, the transaction requirements 60 may be analyzed to filter out unfeasible parameters, e.g. bad data, for example, such as uninitialized or missing parameters.

In step 66, the transaction optimization engine may optionally preprocess a plurality of inputs from the plurality of e-marketplace participants providing one or more transaction terms which describe the specifics of the desired transaction, such as order quantity or quality, or product type. The inputs may be preprocessed to aid in formulating the optimization problem to be solved.

In step 67, the transaction optimization engine or program may be executed using the transaction requirements 60 from each of the participants to produce transaction results 62 for each of the participants. The transaction results 62 may include a set of transaction terms which specify a transaction between two or more of the participants which optimizes the objectives of the two or more participants subject to the constraints of the two or more participants.

In step 68, the transaction optimization engine may optionally post process the optimized transaction results 62. Such post processing may be performed to check for reasonable results, or to extract useful information for analysis.

Finally, in step 69, the transaction results 62 may be provided to the participants. At this point, the resultant optimized transaction may be executed among the two or more participants specified in the optimized transaction.

In one embodiment, after the transaction results 62 have been provided to the participants, the participants may adjust their constraints and/or objectives and re-submit them to the transaction optimization server, initiating another round of transaction optimization. This may continue until a pre-determined number of rounds has elapsed, or until the participants agree to terminate the process.

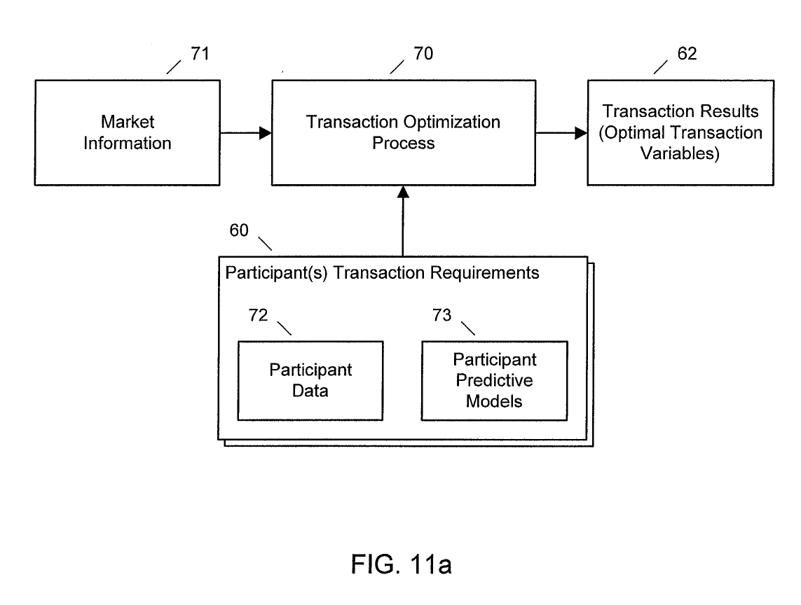

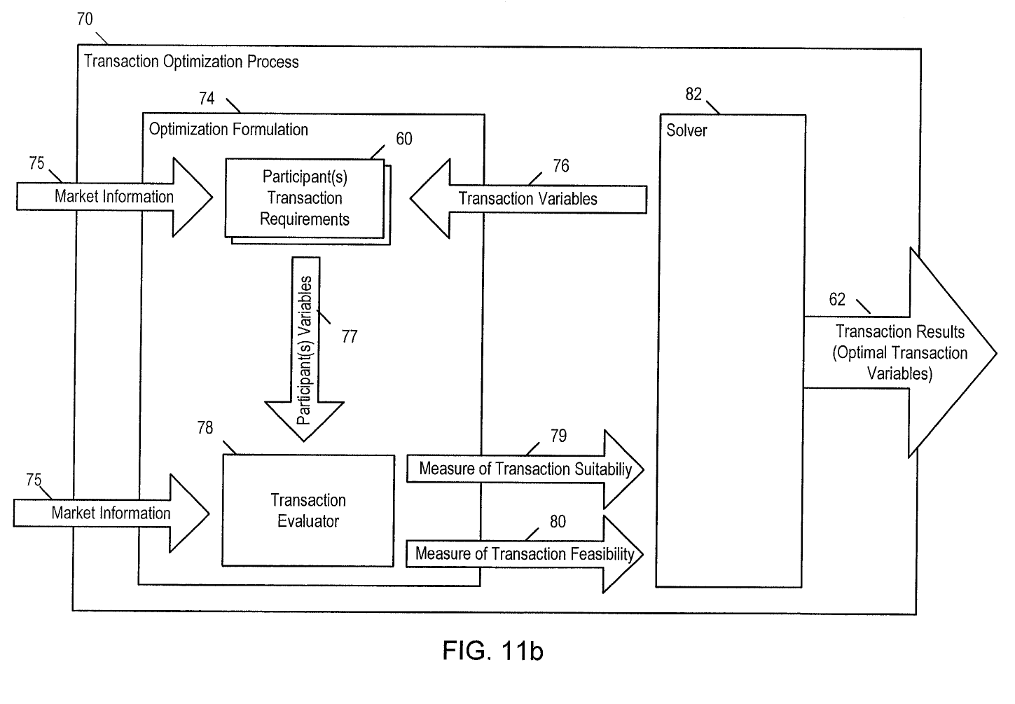

FIG. 11—Optimization Overview

FIG. 11a is a block diagram which illustrates an overview of optimization according to one embodiment. FIG. 11b is a dataflow diagram which illustrates an optimization process according to one embodiment. FIGS. 11a and 11b together illustrate an exemplary system for optimizing an e-marketplace system.

As shown in FIG. 11a, a transaction optimization process 70 may accept the following elements as input: market information 71 and participant(s) transaction requirements 60. The optimization process 70 may produce as output transaction results 62 in the form of an optimized set of transaction variables. As used herein, “optimized” means that the selection of transaction values is based on a numerical search or selection process which maximizes a measure of suitability while satisfying a set of feasibility constraints. A further understanding of the optimization process 70 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

As used herein, the term “market information” may refer to any information generated, stored, or computed by the marketplace which provides context for the possible transactions. This information is not available to a participant without engaging in the e-marketplace. Furthermore, the market information is treated as a set of external variables in that those variables are not under the control of the transaction optimization process. For example, the marketplace may report the number of active participants, the recent historical demand for a particular product, or the current asking price for a product being sold. Additionally, market information may include information retrieved from other marketplaces.

As used herein, “transaction requirements” may include information that a participant provides to the optimization process to affect the outcome of the transaction optimization process. This information may include: (a) the participants objectives in accepting a transaction, (b) constraints describing what transaction parameters the participant will accept, (c) and internal participant data including inventory, production schedules, cost of goods sold, available funds, and/or required delivery times. Information may either be specified statically as participant data 72 or as participant predictive models 73 which allow information to be computed dynamically based on market information and transaction variables.

As noted above, an “objective” may include a goal or desired outcome of a process; in this case, a transaction optimization process. Some example objectives are: obtain goods at a minimum price, sell goods in large lots, minimize delivery costs, and reduce inventory as rapidly as possible.

As noted above, a “constraint” may include a limitation on the outcome of an optimization process. Constraints may include “real-world” limits on the transaction variables and are often critical to the feasibility of any optimization solution. For example, a marketplace seller may impose a minimum constraint on the volume of product that may be delivered in one transaction. Similarly, a marketplace buyer may impose a maximum constraint on the price the buyer is willing to pay for a purchased product. Constraints may be specified for numerous variables (e.g., transaction variables, computed variables, among others). For example, a seller may have a minimum limit on the margin of sales. This quantity may be computed internally by the seller participant. Constraints may reflect financial or business constraints. They may also reflect physical production or delivery constraints.

As described above, the constraints and/or objectives provided by a participant may include parameter bounds or limits, functions, algorithms, and/or models which express the desired transaction requirements of the participant.

As used herein, “transaction variables” define the terms of a transaction. For example, the transaction variables may identify the selected participants, the volume of product exchanged, the purchase price, and the delivery terms, among others. As used herein, “optimal transaction variables” define the final transaction, which is provided to two or more of the participants as transaction results 62. The optimization process 70 selects the optimal transaction variables 62 in order to satisfy the constraints of the participants and best meet the objectives of the participants.

As shown in the dataflow of FIG. 11b, the transaction optimization process 70 may comprise an optimization formulation 74 and a solver 82. The optimization formulation 74 is a system which may take as input a proposed set of transaction variables 76 and market information 75. The optimization formulation 74 may then compute both a measure of suitability for the proposed transaction 79 and one or more measures of feasibility for the proposed transaction 80. The solver 82 may determine a set of transaction variables 76 that maximizes the transaction suitability 79 over all participants while simultaneously ensuring that all of the transaction feasibility conditions are satisfied.

Before execution of the transaction optimization program, participants may each submit transaction requirements 60 to the marketplace. These requirements are incorporated into the optimization formulation 74. The participant transaction requirements 60 are used to compute or specify a set of participant(s) variables 77 for each participant based on the market information 75, proposed transaction variables 76, and participant's unique properties. The participant(s) variables 77 are passed to a transaction evaluator 78 which determines the overall suitability 79 and feasibility 80 of the transaction variables 76 proposed by the solver 82. The solver uses these measures 79 and 80 to refine the choice of transaction variables 76. After the optimization solver 82 computes, selects, or creates the final set of transaction variables 76 in response to the received data, the e-marketplace server, or a separate server, or possibly the solver itself, may distribute or provide the transaction results 62 to some or all of the participants. The transaction results 62 may be provided to the client systems of the participants, where the results (transactions) may be displayed, stored or automatically acted upon. As discussed above, the transaction results 62 are preferably designed to achieve a desired commercial result, e.g., to complete a transaction in a desired way, such as by purchasing or selling a product.

Participant(s) variables 77 are used to represent participant constraints and/or objectives to the transaction evaluator 78 in a standard form. These participant(s) variables 77 are based on the participant's requirements. In one embodiment, the constraints and/or objectives are directly represented as participant data. For example, a buyer-participant may specify a product code, desired volume, and maximum unit price. In another example a seller may specify available product, minimum selling price, minimum order volume, and delivery time-window. In another embodiment, objective and constraint terms may be computed as a function of transaction variables using predictive models. For example, a buyer may specify a maximum price computed based on a combination of the predicted market demand and seller's available volume. As another example, models may be used to translate a participant's strategic business objectives such as increase profit, increase market share, minimize inventory, etc., into standardized objective and constraint information based on current marketplace activity. In yet another embodiment, constraints and/or objectives are determined as a mixture of static data and dynamically computed values.

Participant predictive model(s) 73 may be used to compute participant variables such as constraints and/or objectives dynamically based on current marketplace information and proposed transaction variables. Models may estimate current or future values associated with the participant, other participants, or market conditions. Computations may represent different aspects of a participant's strategy. For example, a predictive model may represent the manufacturing conditions and behavior of a participant, a price-bidding strategy, the future state of a participant's product inventory, or the future behavior of other participants.

Predictive models 73 may take on any of a number of forms. In one embodiment, a model may be implemented as a non-linear model, such as a neural network or support vector machine (see FIG. 13). In the neural network implementation, typically, the neural network includes a layer of input nodes, interconnected to a layer of hidden nodes, which are in turn interconnected to a layer of output nodes, wherein each connection is associated with an adjustable weight or coefficient and wherein each node computes a non-linear function of values of source nodes. In the support vector machine implementation, typically, the support vector machine includes a layer of input nodes, interconnected to a layer of support vectors, which are in turn interconnected to a layer of output nodes, wherein each node computes a non-linear function of values of the support vectors. See FIG. 13 for more detail on a support vector machine implementation.

The support vectors are set in the training phase of the model. The model may be trained based on data extracted from historical archives, data gathered from designed experiments, or data gathered during the course of transaction negotiations. The model may be further trained based on dynamic marketplace information. In other embodiments, predictive models may be based on statistical regression methods, analytical formulas, physical first principles, or rule-based systems or decision-tree logic. In another embodiment, a model may be implemented as an aggregation of a plurality of model types.

Individual constraints and/or objectives 77 from two or more participants are passed to the transaction evaluator 78. The transaction evaluator combines the set of participant constraints to provide to the solver 82 one or more measures of transaction feasibility 80. The transaction evaluator also combines the individual objectives of the participants to provide to the solver 82 one or more measures of transaction suitability 79. The combination of objectives may be based on a number of different strategies. In one embodiment, the individual objectives may be combined by a weighted average. In a different embodiment, the individual objectives may be preserved and simultaneously optimized, such as in a Pareto optimal sense, as is well known in the art.

The solver 82 implements a constrained search strategy to determine the set of transaction variables that maximize the transaction suitability while satisfying the transaction feasibility constraints. Many strategies may be used, as desired. Solver strategies may be substituted as necessary to satisfy the requirements of a particular marketplace type. Examples of search strategies may include gradient-based solvers such as linear programming, non-linear programming, mixed-integer linear and/or non-linear programming. Search strategies may also include non-gradient methods such as genetic algorithms and evolutionary programming techniques. Solvers may be implemented as custom optimization processes or off-the-shelf applications or libraries.

As mentioned above, the e-marketplace system described herein may include one or more predictive models used to represent various aspects of the system, such as the participants, the related market, or any other attribute of the system. In one embodiment, one or more of the predictive models may be implemented as a non-linear model (e.g., a neural network, or a support vector machine). To increase the usefulness of a non-linear model, they may be trained with data, and internal weights or coefficients may be set to reconcile input training input data with expected or desired output data. On-line training methods may be used to train non-linear models, according to various embodiments of the present invention, as further detailed below.

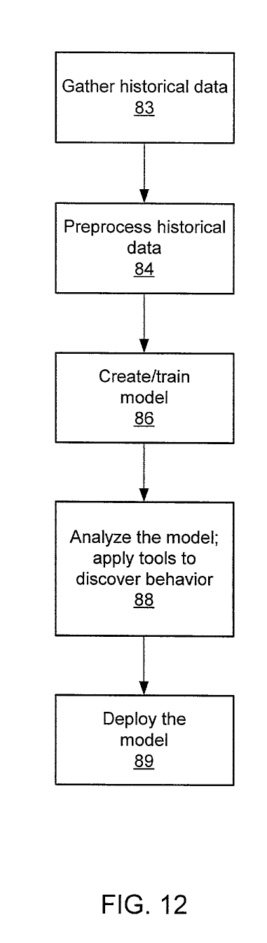

FIG. 12—Method of Modeling a Business Process

FIG. 12 is a flowchart diagram illustrating a method of creating and using models and optimization procedures to model and/or control a business process, according to one embodiment.

As used herein, the term “business process” may refer to a series of actions or operations in a particular field or domain, beginning with inputs (e.g., data inputs), and ending with outputs, as further described in detail below. Thus, the term “business process” is intended to include many areas, such as electronic commerce (i.e., e-commerce), e-marketplaces, financial (e.g., stocks and/or bonds) markets and systems, insurance systems, data analysis, data mining, process measurement, optimization (e.g., optimized decision making, real-time optimization), quality control, as well as any other business-related or financial-related field or domain where predictive or classification models may be useful and where the object being modeled may be expressed. In various embodiments of the present invention, components described herein as inputs or outputs may comprise software constructs or operations which control or provide information or information processes. The term “process” is intended to include a “business process” as described herein.

As shown, in step 83 the method involves gathering historical data which describes the process. This historical data may comprise a combination of inputs and the resulting outputs when these inputs are applied to the respective process. This historical data may be gathered in many and various ways. Typically, large amounts of historical data are available for most processes or enterprises.

In step 84 the method may preprocess the historical data. The preprocessing may occur for several reasons. For example, preprocessing may be performed to manipulate or remove error conditions or missing data, or accommodate data points that are marked as bad or erroneous. Preprocessing may also be performed to filter out noise and unwanted data. Further, preprocessing of the data may be performed because in some cases the actual variables in the data are themselves awkward to use in modeling. For example, where the variables are price1 and price2, the model may be much more related to the ratio between the prices. Thus, rather than apply price1 and price2 to the model, the data may be processed to create a synthetic variable which is the ratio of the two price values, and the model may be used against the ratio.

In step 86 the model may be created and/or trained. This step may involve several steps. First, a representation of the model may be chosen, e.g., choosing a linear model or a non-linear model. If the model is a non-linear model, the model may be a neural network or a support vector machine, among other non-linear models. Further, the neural network may be a fully connected neural net or a partly connected neural net. After the model has been selected, a training algorithm may be applied to the model using the historical data, e.g., to train the non-linear model. Finally, the method may verify the success of this training to determine whether the model actually corresponds to the process being modeled. In one embodiment, the training in step 86 may be on-line training, as further described below.

In step 88, the model is typically analyzed. This may involve applying various tools to the model to discover its behavior. Lastly, in step 89, the model may be deployed in the “real-world” to model, predict, optimize, or control the respective process. The model may be deployed in any of various manners. For example, the model may be deployed simply to perform predictions, which involves specifying various inputs and using the model to predict the outputs. Alternatively, the model may be deployed with a problem formulation, e.g., an objective function, and a solver or optimizer.

FIG. 13—Support Vector Machine Implementation

In order to fully appreciate the various aspects and benefits produced by various embodiments of the present invention, an understanding of support vector machine technology is useful. A detailed description of a non-linear model in the form of a neural network is described earlier. Support vector machine technology as applicable to the support vector machine 90 of the system and method of various embodiments of the present invention is discussed below.

A. Introduction

Historically, classifiers have been determined by choosing a structure, and then selecting a parameter estimation algorithm used to optimize some cost function. The structure chosen may fix the best achievable generalization error, while the parameter estimation algorithm may optimize the cost function with respect to the empirical risk.

There are a number of problems with this approach, however. These problems may include:

1. The model structure needs to be selected in some manner. If this is not done correctly, then even with zero empirical risk, it is still possible to have a large generalization error.

2. If it is desired to avoid the problem of over-fitting, as indicated by the above problem, by choosing a smaller model size or order, then it may be difficult to fit the training data (and hence minimize the empirical risk).

3. Determining a suitable learning algorithm for minimizing the empirical risk may still be quite difficult. It may be very hard or impossible to guarantee that the correct set of parameters is chosen.

The support vector method is a recently developed technique which is designed for efficient multidimensional function approximation. The basic idea of support vector machines (SVMs) is to determine a classifier or regression machine which minimizes the empirical risk (i.e., the training set error) and the confidence interval (which corresponds to the generalization or test set error), that is, to fix the empirical risk associated with an architecture and then to use a method to minimize the generalization error. One advantage of SVMs as adaptive models for binary classification and regression is that they provide a classifier with minimal VC (Vapnik-Chervonenkis) dimension which implies low expected probability of generalization errors. SVMs may be used to classify linearly separable data and nonlinearly separable data. SVMs may also be used as nonlinear classifiers and regression machines by mapping the input space to a high dimensional feature space. In this high dimensional feature space, linear classification may be performed.

In the last few years, a significant amount of research has been performed in SVMs, including the areas of learning algorithms and training methods, methods for determining the data to use in support vector methods, and decision rules, as well as applications of support vector machines to speaker identification, and time series prediction applications of support vector machines.

Support vector machines have been shown to have a relationship with other recent nonlinear classification and modeling techniques such as: radial basis function networks, sparse approximation, PCA (principle components analysis), and regularization. Support vector machines have also been used to choose radial basis function centers.

A key to understanding SVMs is to see how they introduce optimal hyperplanes to separate classes of data in the classifiers. The main concepts of SVMs are reviewed in the next section.

B. How Support Vector Machines Work

The following describes support vector machines in the context of classification, but the general ideas presented may also apply to regression, or curve and surface fitting.

1. Optimal Hyperplanes

Consider an m-dimensional input vector x=[x₁, . . . ,xₘ]^{T} ε X ⊂ R^{m} and a one-dimensional output y ε {−1,1}. Let there exist n training vectors (xᵢ,yᵢ)i=1, . . . ,n. Hence we may write X=[x₁x₂ . . . xₙ] or

$$X = [ \begin{matrix}{x}_{11} & ⋯ & {x}_{1 n} \\ ⋮ & ⋰ & ⋮ \\ {x}_{m1} & ⋯ & {x}_{mn}\end{matrix} ] \qquad ( 1 )$$

A hyperplane capable of performing a linear separation of the training data is described by

w^{T}x+b=0 (2)

where w=[w₁w₂ . . . wₘ]^{T}, w ε W ⊂ R^{m}.

The concept of an optimal hyperplane was proposed by Vladimir Vapnik. For the case where the training data is linearly separable, an optimal hyperplane separates the data without error and the distance between the hyperplane and the closest training points is maximal.

2. Canonical Hyperplanes

A canonical hyperplane is a hyperplane (in this case we consider the optimal hyperplane) in which the parameters are normalized in a particular manner.

Consider (2) which defines the general hyperplane. It is evident that there is some redundancy in this equation as far as separating sets of points. Suppose we have the following classes

yᵢ[w^{T}xᵢ+b]≧1 i=1, . . . ,n (3)

where y ε [−1,1].

One way in which we may constrain the hyperplane is to observe that on either side of the hyperplane, we may have w^{T}x+b>0 or w^{T}x+b<0. Thus, if we place the hyperplane midway between the two closest points to the hyperplane, then we may scale w,b such that

$${min}_{ i = 1 … n} \vert {w}^{T} {x}_{i} + b \vert = 0 \qquad ( 4 )$$

Now, the distance d from a point xᵢ to the hyperplane denoted by (w,b) is given by

$$d ( w , b ; {x}_{i} ) = \frac{\vert {w}^{T} {x}_{i} + b \vert}{\vert \vert w \vert \vert} \qquad ( 5 )$$

where ∥w∥=w^{T}w. By considering two points on opposite sides of the hyperplane, the canonical hyperplane is found by maximizing the margin

$$\begin{matrix}p ( w , b ) = {min}_{i ; {y}_{i} = 1} d ( w , b ; {x}_{i} ) + {min}_{j ; y j = 1} d ( w , b ; {x}_{j} ) \\ = \frac{2}{\vert \vert w \vert \vert}\end{matrix} \qquad ( 6 )$$

This implies that the minimum distance between two classes i and j is at least [2/(∥w∥)].

Hence an optimization function which we seek to minimize to obtain canonical hyperplanes, is

$$J ( w ) = \frac{1}{2} \vert \vert w {\vert \vert}^{2} \qquad ( 7 )$$

Normally, to find the parameters, we would minimize the training error and there are no constraints on w,b. However, in this case, we seek to satisfy the inequality in (3). Thus, we need to solve the constrained optimization problem in which we seek a set of weights which separates the classes in the usually desired manner and also minimizing J(w), so that the margin between the classes is also maximized. Thus, we obtain a classifier with optimally separating hyperplanes.

C. An SVM Learning Rule

For any given data set, one possible method to determine w₀,b₀ such that (8) is minimized would be to use a constrained form of gradient descent. In this case, a gradient descent algorithm is used to minimize the cost function J(w), while constraining the changes in the parameters according to (3). A better approach to this problem however, is to use Lagrange multipliers which is well suited to the nonlinear constraints of (3). Thus, we introduce the Lagrangian equation:

$$L ( w , b , α ) = \frac{1}{2} \vert \vert w {\vert \vert}^{2} - {\sum }_{i = 1}^{n} {α}_{i} ( {y}_{i} [ {w}^{T} {x}_{i} + b ] - 1 ) \qquad ( 8 )$$

where α₁ are the Lagrange multipliers and αᵢ>0.

The solution is found by maximizing L with respect to αᵢ and minimizing it with respect to the primal variables w and b. This problem may be transformed from the primal case into its dual and hence we need to solve

$${max}_{α} {min}_{w , b} L ( w , b , α ) \qquad ( 9 )$$

At the solution point, we have the following conditions

$$\frac{\partial L ( {w}_{0} , {b}_{0} , {α}_{0} )}{\partial w} = 0 \\ \frac{\partial L ( {w}_{0} , {b}_{0} , {α}_{0} )}{\partial b} = 0 \qquad ( 10 )$$

where solution variables w₀,b₀,α₀ are found. Performing the differentiations, we obtain respectively,

$${\sum }_{i = 1}^{n} {α}_{0 i} {y}_{i} = 0 \\ {w}_{0} = {\sum }_{i = 1}^{n} {α}_{0 i} {x}_{i} {y}_{i} \qquad ( 11 )$$

and in each case α₀ᵢ>0, i=1, . . . ,n.

These are properties of the optimal hyperplane specified by (w₀,b₀). From (14) we note that given the Lagrange multipliers, the desired weight vector solution may be found directly in terms of the training vectors.

To determine the specific coefficients of the optimal hyperplane specified by (w₀,b₀) we proceed as follows. Substitute (13) and (14) into (9) to obtain

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} ( {x}_{i}^{T} {x}_{j} ) \qquad ( 12 )$$

It is necessary to maximize the dual form of the Lagrangian equation in (15) to obtain the required Lagrange multipliers. Before doing so however, consider (3) once again. We observe that for this inequality, there will only be some training vectors for which the equality holds true. That is, only for some (xᵢ,yᵢ) will the following equation hold:

yᵢ[w^{T}x₁+b]=1 i=1, . . . ,n (13)

The training vectors for which this is the case, are called support vectors.

Since we have the Karush-Kühn-Tucker (KKT) conditions that α₀₁>0, i=1, . . . ,n and that given by (3), from the resulting Lagrangian equation in (9), we may write a further KKT condition

α₀ᵢ(yᵢ[w₀^{T}xᵢ+b₀]−1)=0 i=1, . . . ,n (14)

This means, that since the Lagrange multipliers α₀ᵢ are nonzero with only the support vectors as defined in (16), the expansion of w₀ in (14) is with regard to the support vectors only.

Hence we have

$${w}_{0} = {\sum }_{i ⋐ S} {α}_{0 i} {x}_{i} {y}_{i} \qquad ( 15 )$$

where S is the set of all support vectors in the training set. To obtain the Lagrange multipliers α₀ᵢ, we need to maximize (15) only over the support vectors, subject to the constraints α₀ᵢ>0, i=1, . . . ,n and that given in (13). This is a quadratic programming problem and may be readily solved. Having obtained the Lagrange multipliers, the weights w₀ may be found from (18).

D. Classification of Linearly Separable Data

A support vector machine which performs the task of classifying linearly separable data is defined as

f(x)=sgn{w^{T}x+b} (16)

where w,b are found from the training set. Hence may be written as

$$f ( x ) = sgn \{ {\sum }_{i ⋐ S} {α}_{0 i} {y}_{i} ( {x}_{i}^{T} x ) + {b}_{0} \} \qquad ( 17 )$$

where α₀ᵢ are determined from the solution of the quadratic programming problem in (15) and b₀ is found as

$${b}_{0} = \frac{1}{2} ( {w}_{0}^{T} {x}_{i}^{+} + {w}_{0}^{T} {x}_{i}^{-} ) \qquad ( 18 )$$

where xᵢ⁺ and xᵢ⁻ are any input training vector examples from the positive and negative classes respectively. For greater numerical accuracy, we may also use

$${b}_{0} = \frac{1}{2 n} {\sum }_{i = 1}^{n} ( {w}_{0}^{T} {x}_{i}^{+} + {w}_{0}^{T} {x}_{i}^{-} ) \qquad ( 19 )$$

E. Classification of Nonlinearly Separable Data

For the case where the data is nonlinearly separable, the above approach can be extended to find a hyperplane which minimizes the number of errors on the training set. This approach is also referred to as soft margin hyperplanes. In this case, the aim is to

yᵢ[w^{T}xᵢ+b]≧1−ξᵢ i=1, . . . ,n (20)

where ξᵢ>0, i=1, . . . ,n. In this case, we seek to minimize to optimize

$$J ( w , ξ ) = \frac{1}{2} {‖ w ‖}^{2} + C {\sum }_{i = 1}^{n} {ξ}_{i} \qquad ( 21 )$$

F. Nonlinear Support Vector Machines

For some problems, improved classification results may be obtained using a nonlinear classifier. Consider (20) which is a linear classifier. A nonlinear classifier may be obtained using support vector machines as follows.

The classifier is obtained by the inner product xᵢ^{T}x where i⊂S, the set of support vectors. However, it is not necessary to use the explicit input data to form the classifier. Instead, all that is needed is to use the inner products between the support vectors and the vectors of the feature space.

That is, by defining a kernel

K(xᵢ,x)=xᵢ^{T}x (22)

a nonlinear classifier can be obtained as

$$f ( x ) = sgn \{ {\sum }_{i ⋐ S} {α}_{0 i} {y}_{i} K ( {x}_{i} , x ) + {b}_{0} \} \qquad ( 23 )$$

G. Kernel Functions

A kernel function may operate as a basis function for the support vector machine. In other words, the kernel function may be used to define a space within which the desired classification or prediction may be greatly simplified. Based on Mercer's theorem, as is well known in the art, it is possible to introduce a variety of kernel functions, including:

1. Polynomial

The p^{th} order polynomial kernel function is given by

K(x₁,x)= (24)

2. Radial Basis Function

K(x₁,x)=e (25)

where γ>0.

3. Multilayer Networks

A multilayer network may be employed as a kernel function as follows. We have

K(xᵢ,x)=σ(θ(xᵢ^{T}x)+φ) (26)

where σ is a sigmoid function.

Note that the use of a nonlinear kernel permits a linear decision function to be used in a high dimensional feature space. We find the parameters following the same procedure as before. The Lagrange multipliers may be found by maximizing the functional

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} K ( {x}_{i} , x ) \qquad ( 27 )$$

When support vector methods are applied to regression or curve-fitting, a high-dimensional “tube” with a radius of acceptable error is constructed which minimizes the error of the data set while also maximizing the flatness of the associated curve or function. In other words, the tube is an envelope around the fit curve, defined by a collection of data points nearest the curve or surface, i.e., the support vectors.

Thus, support vector machines offer an extremely powerful method of obtaining models for classification and regression. They provide a mechanism for choosing the model structure in a natural manner which gives low generalization error and empirical risk.

H. Construction of Support Vector Machines

A Support vector machine may be built by specifying a kernel function, a number of inputs, and a number of outputs. Of course, as is well known in the art, regardless of the particular configuration of the support vector machine, some type of training process may be used to capture the behaviors and/or attributes of the system or process to be modeled.

The modular aspect of one embodiment of the present invention may take advantage of this way of simplifying the specification of a support vector machine. Note that more complex support vector machines may require more configuration information, and therefore more storage.

Various embodiments of the present invention contemplate other types of support vector machine configurations. In one embodiment, all that is required for the support vector machine is that the support vector machine be able to be trained and retrained so as to provide needed predicted values.

I. Support Vector Machine Training

The coefficients used in a support vector machine may be adjustable constants which determine the values of the predicted output data for given input data for any given support vector machine configuration. Support vector machines may be superior to conventional statistical models because support vector machines may adjust these coefficients automatically. Thus, support vector machines may be capable of building the structure of the relationship (or model) between the input data and the output data by adjusting the coefficients. While a conventional statistical model typically requires the developer to define the equation(s) in which adjustable constant(s) are used, the support vector machine may build the equivalent of the equation(s) automatically.

The support vector machine may be trained by presenting it with one or more training set(s). The one or more training set(s) are the actual history of known input data values and the associated correct output data values.

To train the support vector machine, the newly configured support vector machine is usually initialized by assigning random values to all of its coefficients. During training, the support vector machine may use its input data to produce predicted output data.

These predicted output data values may be used in combination with training input data to produce error data. These error data values may then be used to adjust the coefficients of the support vector machine.

It may thus be seen that the error between the output data and the training input data may be used to adjust the coefficients so that the error is reduced.

J. Advantages of Support Vector Machines

Support vector machines may be superior to computer statistical models because support vector machines do not require the developer of the support vector machine model to create the equations which relate the known input data and training values to the desired predicted values (i.e., output data). In other words, a support vector machine may learn relationships automatically during training.

However, it is noted that the support vector machine may require the collection of training input data with its associated input data, also called a training set. The training set may need to be collected and properly formatted. The conventional approach for doing this is to create a file on a computer on which the support vector machine is executed.

In one embodiment of the present invention, in contrast, creation of the training set may be done automatically, using historical data. This automatic step may eliminate errors and may save time, as compared to the conventional approach. Another benefit may be significant improvement in the effectiveness of the training function, since automatic creation of the training set(s) may be performed much more frequently.

Implementation Using a Non-Linear Model

The following figures describe pre-processing of input data to a non-linear model (e.g., a neural network, or a support vector machine) for use in electronic commerce. In various embodiments of the present invention, the process being controlled is a “business process”, as described above. When the process under control represents a business process, the corresponding controller or control device is intended to include a computer system (e.g., in an e-commerce system, the computer system may be an e-commerce server computer system).

As mentioned above, in many applications, the time-dependence, i.e., the time resolution and/or synchronization, of training and/or real-time data may not be consistent, due to missing data, variable measurement chronologies or timelines, etc. In one embodiment of the invention, the data may be preprocessed to homogenize the timing aspects of the data, as described below. It is noted that in other embodiments, the data may be dependent on a different independent variable than time. It is contemplated that the techniques described herein regarding homogenization of time scales are applicable to other scales (i.e., other independent variables), as well.

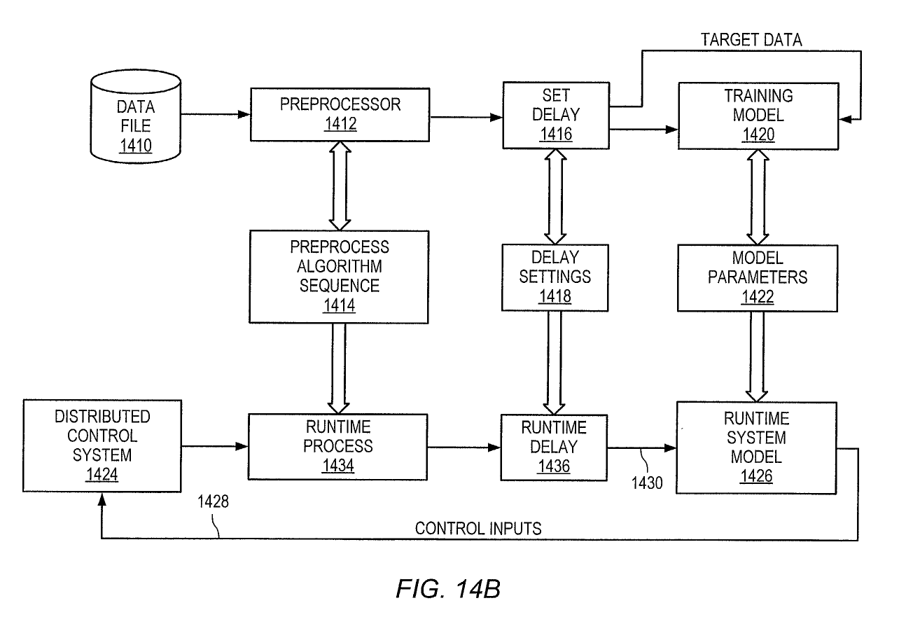

FIG. 14A is an overall block diagram of the data preprocessing operation in both the training mode and the run-time mode, according to one embodiment. FIG. 14B is a diagram of the data preprocessing operation of FIG. 14A, but with an optional delay process included for reconciling time-delayed values in a data set. As FIG. 14A shows, in the training mode, one or more data files 1410 may be provided (however, only one data file 1410 is shown). The one or more data files 1410 may include both input training data and output training data. The training data may be arranged in “sets”, e.g., corresponding to different variables, and the variables may be sampled at different time intervals. These data may be referred to as “raw” data. When the data are initially presented to an operator, the data are typically unformatted, i.e., each set of data is in the form that it was originally received. Although not shown, the operator may first format the data files so that all of the data files may be merged into a data-table or spreadsheet, keeping track of the original “raw” time information. This may be done in such a manner as to keep track of the timestamp for each variable. Thus, the “raw” data may be organized as time-value pairs of columns; that is, for each variable xᵢ, there is an associated time of sample tᵢ. The data may then be grouped into sets {xᵢ, tᵢ}.

If any of the time-vectors happen to be identical, it may be convenient to arrange the data such that the data will be grouped in common time scale groups, and data that is on, for example, a fifteen minute sample time scale may be grouped together and data sampled on a one hour sample time scale may be grouped together. However, any type of format that provides viewing of multiple sets of data is acceptable.

The one or more data files 1410 may be input to a preprocessor 1412 that may function to perform various preprocessing functions, such as determining bad or missing data, reconciling data to replace bad data or fill in missing data, and performing various algorithmic or logic functions on the data, among others. Additionally, the preprocessor 1412 may be operable to perform a time merging operation, as described below. During operation, the preprocessor 1412 may be operable to store various preprocessing algorithms in a given sequence in a storage area 1414 (noted as preprocess algorithm sequence 1414 in FIGS. 14A & 14B). As described below, the sequence may define the way in which the data are manipulated in order to provide the overall preprocessing operation.

After preprocessing by the preprocessor 1412, the preprocessed data may be input into a training model 1420, as FIGS. 14A & 14B show. The training model 1420 may be a non-linear model (e.g., a neural network or a support vector machine) that receives input data and compares it with target output data. Any of various training algorithms may be used to train the non-linear model to generate a model for predicting the target output data from the input data. Thus, in one embodiment, the training model may utilize a non-linear model that is trained on one or more of multiple training methods. Various weights within the non-linear model may be set during the training operation, and these may be stored as model parameters in a storage area 1422. The training operation and the non-linear model may be conventional systems. It is noted that in one embodiment, the training model 1420 and the runtime system model 1426 may be the same system model operated in training mode and runtime mode, respectively. In other words, when the non-linear model is being trained, i.e., is in training mode, the model may be considered to be a training model, and when the non-linear model is in runtime mode, the model may be considered to be a runtime system model. In another embodiment, the runtime system model 1426 may be distinct from the training model 1420. For example, after the training model 1420 (the non-linear model in training mode) has been trained, the resulting parameters which define the state of the non-linear model may be used to configure the runtime system model 1426, which may be substantially a copy of the training model. Thus, one copy of the system model (the training model 1420) may be trained while another copy of the system model (the runtime system model 1426) is engaged with the real-time system or process being controlled. In one embodiment, the model parameter values in storage area 1422 resulting from the training model may be used to periodically or continuously update the runtime system model 1426, as shown.

A Distributed Control System (DCS) 1424 may be provided that may be operable to generate various system measurements and control settings representing system variables (e.g., price, inventory, etc.), that comprise the input data to the system model. The system model may either generate control inputs for control of the DCS 1424 or it may provide a predicted output, these being conventional operations which are well known in the art. In one embodiment, the control inputs may be provided by the run-time system model 1426, which has an output 1428 and an input 1430, as shown. The input 1430 may include the preprocessed and, in the embodiment of FIG. 14B, delayed, data and the output may either be a predictive output, or a control input to the DCS 1424. In the embodiments of FIGS. 14A and 14B, this is illustrated as control inputs 1428 to the DCS 1424. The run-time system model 1426 is shown as utilizing the model parameters stored in the storage area 1422. It is noted that the run-time system model 1426 may include a representation learned during the training operation, which representation was learned on the preprocessed data, i.e., the trained non-linear model. Therefore, data generated by the DCS 1424 may be preprocessed in order to correlate with the representation stored in the run-time system model 1426.

The output data of the DCS 1424 may be input to a run-time process block 1434, which may be operable to process the data in accordance with the sequence of preprocessing algorithms stored in the storage area 1414, which are generated during the training operation. In one embodiment, as shown in FIG. 14B, the output of the run-time processor 1434 may be input to a run-time delay process 1436 to set delays on the data in accordance with the delay settings stored in the storage area 1418. This may provide the overall preprocessed data output on the line 1430 input to the run-time system model 1426.

In one embodiment, as shown in FIG. 14B, after preprocessing by the preprocessor 1412, the preprocessed data may optionally be input to a delay block 1416. As mentioned above, inherent delays in a system may affect the use of time-dependent data. For example, in an e-commerce system, an inventory monitor may provide inventory data at time t₀ at a given value. However, a given change in inventory resulting in a different inventory value may not affect the inventory output for a predetermined delay τ. In order to predict the inventory output, the value from the inventory monitor must be input to the non-linear model at a delay equal to τ. This may be accounted for in the training of the non-linear model through the use of the delay block 1416. Thus, the time scale of the data may be reconciled with the time scale of the system or process as follows.

The delay block 1416 may be operable to set the various delays for different sets of data. This operation may be performed on both the target output data and the input training data. The delay settings may be stored in a storage area 1418 (noted as delay settings 1418 in FIG. 14B). In this embodiment, the output of the delay block 1416 may be input to the training model 1420. Note that if the delay process is not used, then the blocks ‘set delay’ 1416, ‘delay settings’ 1418, and ‘runtime delay’ 1436 may be omitted, and therefore, the output from the preprocessor 1412 and the runtime process 1434 may be fed into the training model 1420 and the runtime system model 1426, respectively, as shown in FIG. 14A. In one embodiment, the delay process, as implemented by the blocks ‘set delay’ 1416, ‘delay settings’ 1418, and ‘runtime delay’ 1436 may be considered as part of the data preprocessor 1412. Similarly, the introduction of delays into portions of the data may be considered to be reconciling the input data to the time scale of the system or process being modeled, operated, or controlled.

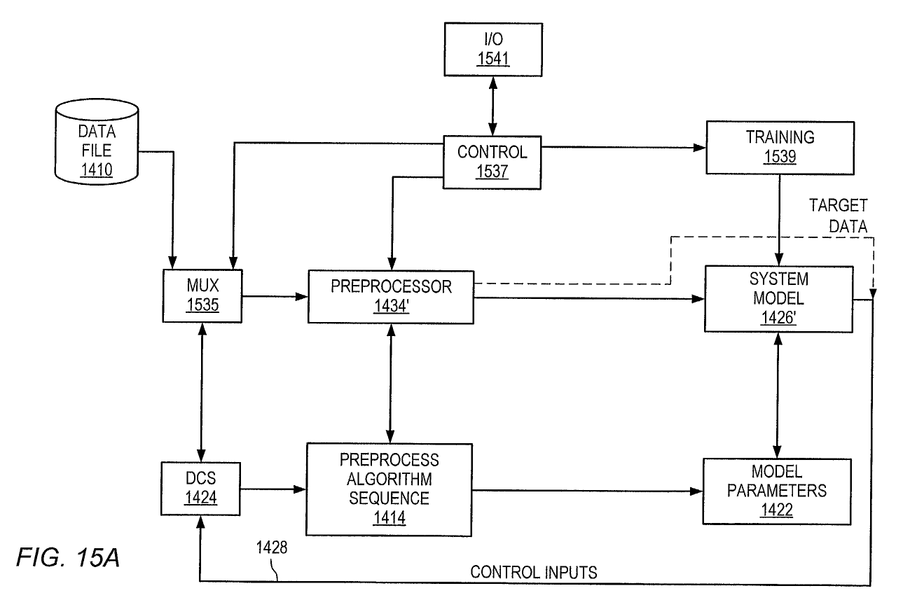

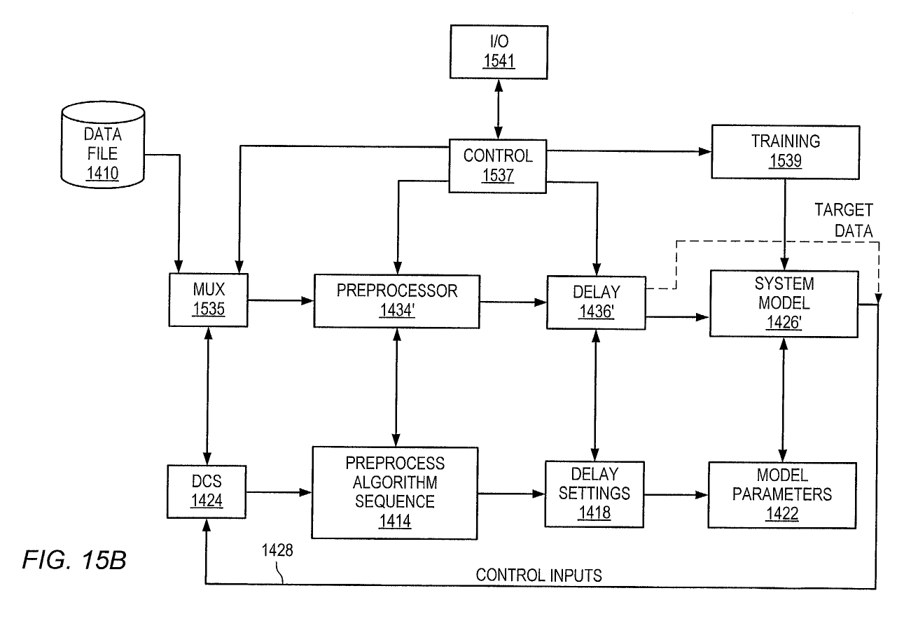

FIG. 15A is a simplified block diagram of the system of FIG. 14A, wherein a single preprocessor 1434′ is utilized, according to one embodiment. FIG. 15B is a simplified block diagram of the system of FIG. 14B, wherein the delay process, i.e., a single delay 1436′, is also included, according to one embodiment.

As FIG. 15A shows, the output of the preprocessor 1434′ may be input to a single system model 1426′. In operation, the preprocessor 1434′ and the system model 1426′ may operate in both a training mode and a run-time mode. A multiplexer 1535 may be provided that receives the output from the data file(s) 1410 and the output of the DCS 1424, and generates an output including operational variables, e.g., process variables, of the DCS 1424. The output of the multiplexer 1535 may then be input to the preprocessor 1434′. In one embodiment, a control device 1537 may be provided to control the multiplexer 1535 to select either a training mode or a run-time mode. In the training mode, the data file(s) 1410 may have the output thereof selected by the multiplexer 1535 and the preprocessor 1434′ may be operable to preprocess the data in accordance with a training mode, i.e., the preprocessor 1434′ may be utilized to determine the preprocessed algorithm sequence stored in the storage area 1414. An input/output (I/O) device 1541 may be provided for allowing an operator to interface with the control device 1537. The system model 1426′ may be operated in a training mode such that the target data and the input data to the system model 1426′ are generated, the training controlled by training block 1539. The training block 1539 may be operable to select one of multiple training algorithms for training the system model 1426′. The model parameters may be stored in the storage area 1422. Note that as used herein, the term “device” may refer to a software program, a hardware device, and/or a combination of the two.

In one embodiment, after training, the control device 1537 may place the system in a run-time mode such that the preprocessor 1434′ is operable to apply the algorithm sequence in the storage area 1414 to the data selected by the multiplexer 1535 from the DCS 1424. After the algorithm sequence is applied, the data may be output to the system model 1426′ which may then operate in a predictive mode to either predict an output or to predict/determine control inputs for the DCS 1424.

It is noted that in one embodiment, the optional delay process 1436′ and settings 1418 may be included, i.e., the data may be delayed, as shown in FIG. 15B. In this embodiment, after the algorithm sequence is applied, the data may be output to the delay block 1436′, which may introduce the various delays in the storage area 1418, and then these may be input to the system model 1426′ which may then operate in a predictive mode to either predict an output or to predict/determine control inputs for the DCS 1424. As FIG. 15B shows, the output of the delay 1436′ may be input to the single system model 1426′. In one embodiment, the delay 1436′ may be controlled by the control device 1537 to determine the delay settings for storage in the storage area 1418, as shown.

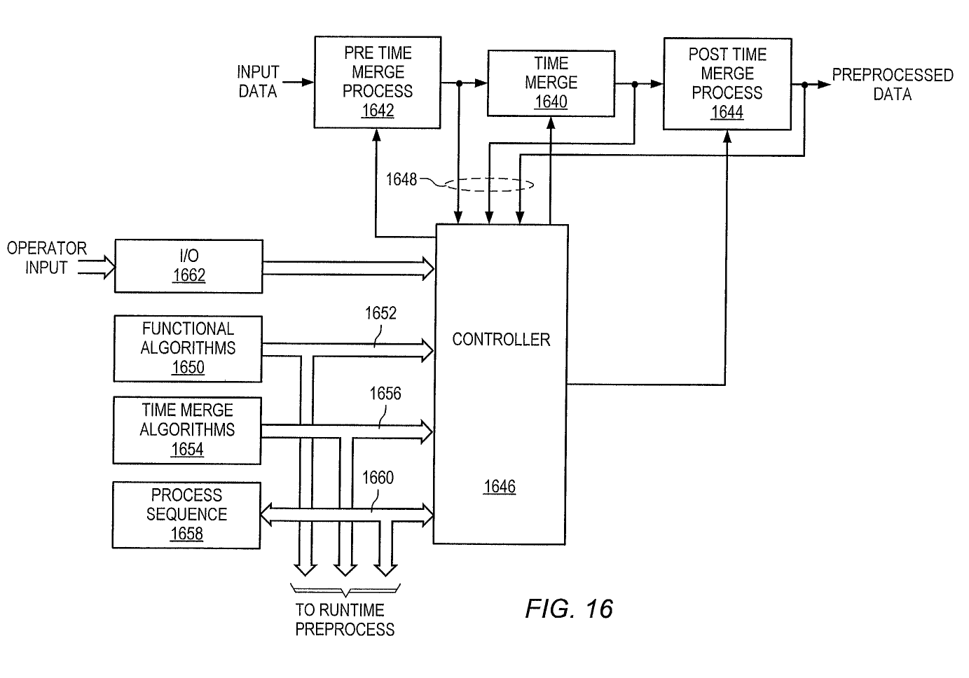

FIG. 16 is a more detailed block diagram of the preprocessor 1412 utilized during the training mode, according to one embodiment. In one embodiment, there may be three stages to the preprocessing operation. The central operation may be a time merge operation (or a merge operation based on some other independent variable), represented by block 1640. However, in one embodiment, prior to performing a time merge operation on the data, a pre-time merge process may be performed, as indicated by block 1642. In one embodiment, after the time merge operation, the data may be subjected to a post-time merge process, as indicated by block 1644.

In an embodiment in which the delay process is included, the output of the post-time merge process block 1644 may provide the preprocessed data for input to the delay block 1416, shown in FIGS. 14B and 15B, and described above.

In one embodiment, a controller 1646 may be included for controlling the process operation of the blocks 1640-1644, the outputs of which may be input to the controller 1646 on lines 1648. The controller 1646 may be interfaced with a functional algorithm storage area 1650 through a bus 1652 and a time merge algorithm storage area 1654 through a bus 1656. The functional algorithm storage area 1650 may be operable to store various functional algorithms that may be mathematical, logical, etc., as described below. The time merge algorithm storage area 1654 may be operable to contain various time merge formats that may be utilized, such as extrapolation, interpolation or a boxcar method, among others.

In one embodiment, a process sequence storage area 1658 may be included that may be operable to store the sequence of the various processes that are determined during the training mode. As shown, an interface to these stored sequences may be provided by a bi-directional bus 1660. During the training mode, the controller 1646 may determine which of the functional algorithms are to be applied to the data and which of the time merge algorithms are to be applied to the data in accordance with instructions received from an operator through an input/output device 1662. During the run-time mode, the process sequence in the storage area 1658 may be utilized to apply the various functional algorithms and time merge algorithms to input data, for use in operation or control of the real-time system or process.

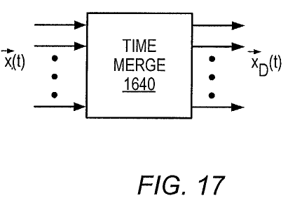

FIG. 17 is a simplified block diagram of a time merge operation, according to one embodiment. All of the input data x(t) may be input to the time merge block 1640 to provide time merge data x_{D}(t) on the output thereof. Although not shown, the output target data y(t) may also be processed through the time merge block 1640 to generate time merged output data y′(t). Thus, in one embodiment, input data x(t) and/or target data y(t), may be processed through the time merge block 1640 to homogenize the time-dependence of the data. As mentioned above, in other embodiments, input data x(v) and/or target data y(v), may be processed through the merge block 1640 to homogenize the dependence of the data with respect to some other independent variable v (i.e., instead of time t). In the descriptions that follow, dependence of the data on time t is assumed, however, the techniques are similarly applicable to data which depend on other variables.

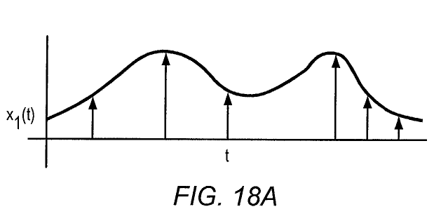

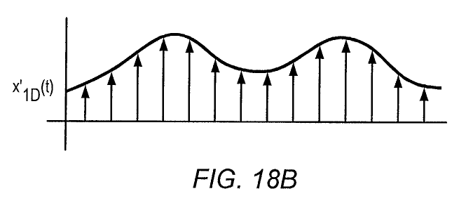

Referring now to FIGS. 18A and 18B, there are illustrated embodiments of data blocks of one input data set x₁(t), shown in FIG. 18A, and the resulting time merged output x′_{1D}(t), shown in FIG. 18B. It may be seen that the waveform associated with x₁(t) has only a certain number, n, of sample points associated therewith. In one embodiment, the time-merge operation may comprise a transform that takes one or more columns of data, xᵢ(tᵢ), such as that shown in FIG. 18A, with nᵢ time samples at times tᵢ′. That is, the time-merge operation may comprise a function, Ω, that produces a new set of data {x′} on a new time scale t′ from the given set of data x(t) sampled at t.

{\vec{x}′,\vec{t}′}=Ω{\vec{x},\vec{t}} (28)

This function may be performed via any of a variety of conventional extrapolation, interpolation, or box-car algorithms, among others. An example representation as a C-language callable function is shown below:

return 32 time_merge(\vec{x}₁, \vec{x}₂ . . . \vec{x}ₖ, \vec{t}_{1′} . . . \vec{x}_{k′}, \vec{t}_{1′}) (29)

where xᵢ, tᵢ are vectors of the old values and old times; xᵢ′ . . . xₖ′ are vectors of the new values; and t′ is the new time-scale vector.

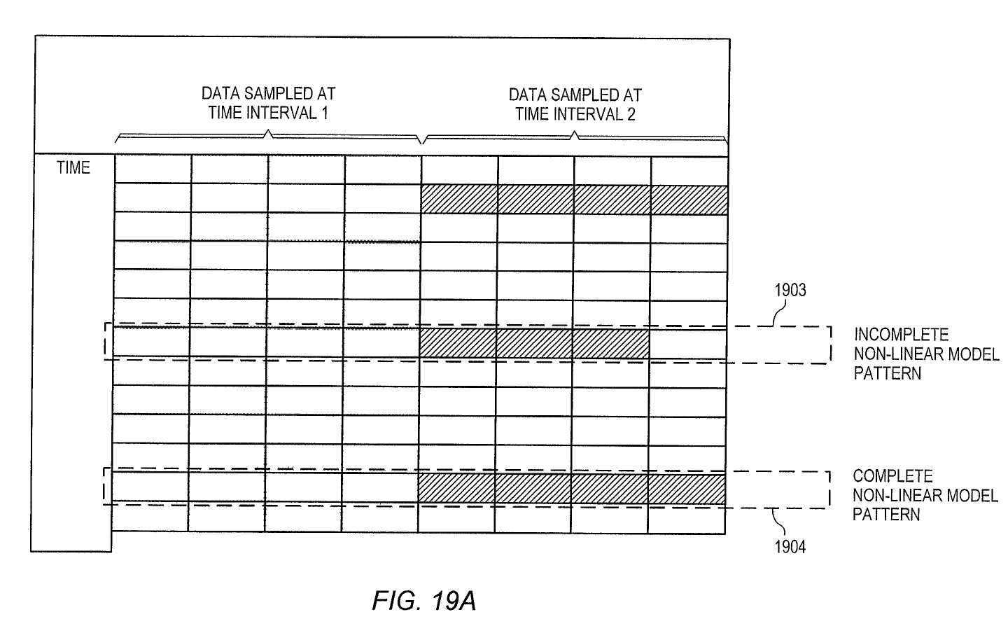

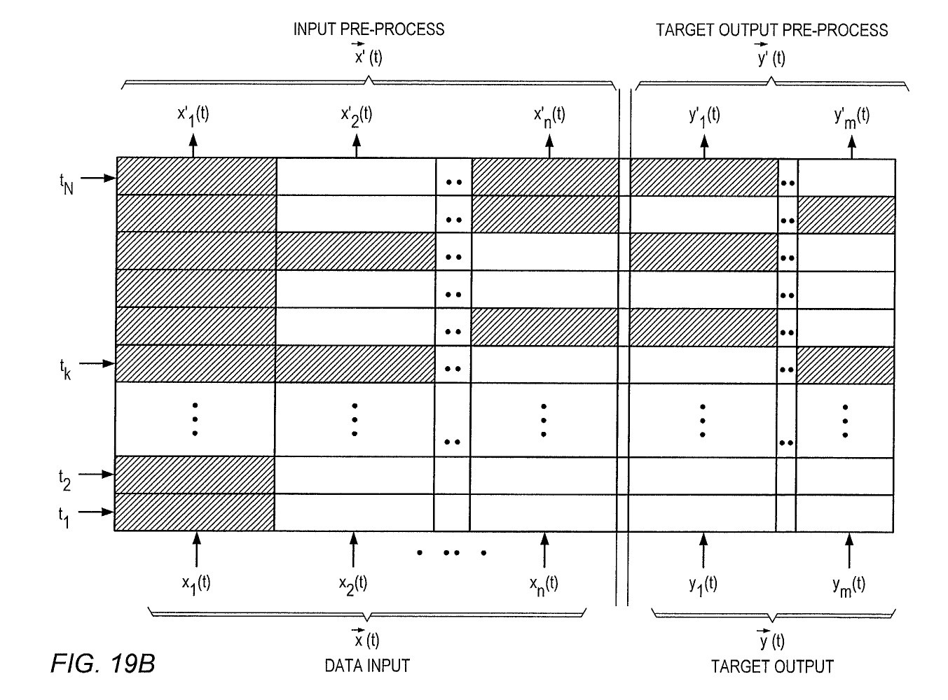

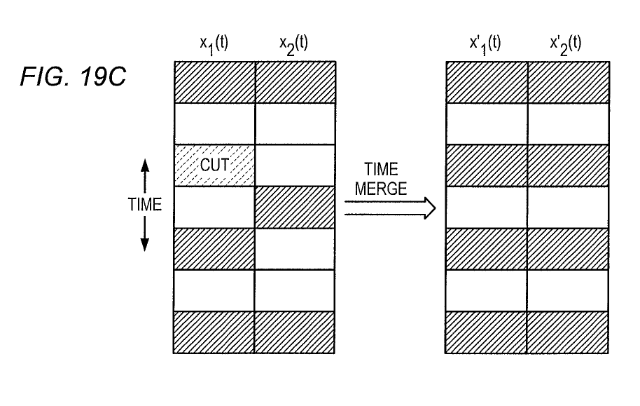

FIG. 19A shows a data table with bad, missing, or incomplete data. The data table may consist of data with time disposed along a vertical scale and the samples disposed along a horizontal scale. Each sample may include many different pieces of data, with two data intervals illustrated. It is noted that when the data are examined for both the data sampled at the time interval “1” and the data sampled at the time interval “2”, that some portions of the data result in incomplete patterns. This is illustrated by a dotted line 1903, where it may be seen that some data are missing in the data sampled at time interval “1” and some data are missing in time interval “2”. A complete non-linear model pattern is illustrated in box 1904, where all the data are complete. Of interest is the time difference between the data sampled at time interval “1” and the data sampled at time interval “2”. In time interval “1”, the data are essentially present for all steps in time, whereas data sampled at time interval “2” are only sampled periodically relative to data sampled at time interval “1”. As such, a data reconciliation procedure may be implemented that may fill in the missing data, for example, by interpolation, and may also reconcile between the time samples in time interval “2” such that the data are complete for all time samples for both time interval “1” and time interval “2”.

The non-linear models that are utilized for time-series prediction and control may require that the time-interval between successive training patterns be constant. Since the data generated from real-world systems may not always be on the same time scale, it may be desirable to time-merge the data before it is used for training or running the non-linear model. To achieve this time-merge operation, it may be necessary to extrapolate, interpolate, average, or compress the data in each column over each time-region so as to give input values x′(t) that are on the appropriate time-scale. All of these operations are referred to herein as “data reconciliation”. The reconciliation algorithm utilized may include linear estimates, spline-fit, boxcar algorithms, etc. If the data are sampled too frequently in the time-interval, it may be necessary to smooth or average the data to generate samples on the desired time scale. This may be done by window averaging techniques, sparse-sample techniques, or spline techniques, among others.

In general, x′(t) is a function of all or a portion of the raw values x(t) given at

$$\vec{{x}^{′}} ( t ) = f ( {x}_{1} ( {t}_{N} ) , {x}_{2} ( {t}_{N} ) , … {x}_{n} ( {t}_{N} ) ; \\ {x}_{1} ( {t}_{N1} ) , {x}_{1} ( {t}_{N2} ) … {x}_{1} ( {t}_{N1} ) ; {x}_{1} ( {t}_{1} ) , {x}_{2} ( {t}_{1} ) … {x}_{n} ( {t}_{1} ) ) \qquad ( 30 )$$

present and past times up to some maximum past time, Xₘₐₓ. That is, where some of the values of xᵢ(tᵢ) may be missing or bad.

In one embodiment, this method of finding x′(t) using past values may be based strictly on extrapolation. Since the system typically only has past values available during run-time mode, these past values may preferably be reconciled. A simple method of reconciling is to take the next extrapolated value x′ᵢ(t)=xᵢ(t_{N}); that is, take the last value that was reported. More elaborate extrapolation algorithms may use past values xᵢ(t−τᵢⱼ), jεt(0, . . . iₘₐₓ). For example, linear extrapolation may use:

$${x}_{i} ( t ) = {x}_{i} ( {t}_{N1} ) + [ \frac{{x}_{i} ( {t}_{N} ) {x}_{i} ( {t}_{N1} )}{{t}_{N} {t}_{N1}} ] t ; t > {t}_{N} \qquad ( 31 )$$

Polynomial, spline-fit, or extrapolation techniques may use Equation 30, according to one embodiment. In one embodiment, training of the non-linear model may actually use interpolated values, i.e., Equation 31, wherein the case of interpolation, t_{N}>t.

FIG. 19B illustrates one embodiment of an input data pattern and target output data pattern illustrating the preprocess operation for both preprocessing input data to provide time merged output data and also preprocessing the target output data to provide preprocessed target output data for training purposes. The data input x(t) may include a vector with many inputs, x₁(t), x₂(t), . . . xₙ(t), each of which may be on a different time scale. It is desirable that the output x′(t) be extrapolated or interpolated to insure that all data are present on a single time scale. For example, if the data at x₁(t) were on a time scale of one sample every second, represented by the time tₖ, and the output time scale were desired to be the same, this would require time merging the rest of the data to that time scale. It may be seen that in this example, the data x₂(t) occurs approximately once every three seconds, it also being noted that this may be asynchronous data, although it is illustrated as being synchronized. In other words, in some embodiments, the time intervals between data samples may not be constant. The data buffer in FIG. 19B is illustrated in actual time. The reconciliation may be as simple as holding the last value of the input x₂(t) until a new value is input thereto, and then discarding the old value. In this manner, an output may always exist. This technique may also be used in the case of missing data. However, a reconciliation routine as described above may also be utilized to insure that data are always on the output for each time slice of the vector x′(t). This technique may also be used with respect to the target output which is preprocessed to provide the preprocessed target output y′(t).

In the example of input data (for training and/or operation) with differing time scales, one set of data may be taken on an hourly basis and another set of data taken on a quarter hour (i.e., every fifteen minutes) basis, thus, for three out of every four data records on the quarter hour basis there will be no corresponding data from the hourly set. These areas of missing data must be filled in to assure that all data are presented at commonly synchronized times to the non-linear model. In other words, the time scales of the two data sets must be the same, and so must be reconciled.

As another example of reconciling different time scales for input data sets, in one data set the data sample periods may be non-periodic, producing asynchronous data, while another data set may be periodic or synchronous, e.g., hourly, thus, their time scales differ. In this case, the asynchronous data may be reconciled to the synchronous data.

In another example of data sets with differing time scales, one data set may have a “hole” in the data, as described above, compared to another set, i.e., some data may be missing in one of the data sets. The presence of the hole may be considered to be an asynchronous or anomalous time interval in the data set, which may then require reconciliation with a second data set to be useful with the second set.

In yet another example of different time scales for input data sets, two data sets may have two different respective time scales, e.g., an hourly basis and a 15 minute basis. The desired time scale for input data to the non-linear model may have a third basis, e.g., daily. Thus, the two data sets may need to be reconciled with the third timeline prior to being used as input to the non-linear model.

FIG. 19C illustrates one embodiment of the time merge operation. Illustrated are two formatted tables, one for the set of data x₁(t) and x₂(t), the second for the set of data x′₁(t) and x′₂(t). The data set for x₁(t) is illustrated as being on one time scale and the data set for x₂(t) is on a second, different time scale. Additionally, one value of the data set x₁(t) is illustrated as being bad, and is therefore “cut” from the data set, as described below. In this example, the preprocessing operation fills in, i.e., replaces, this bad data and then time merges the data, as shown. In this example, the time scale for x₁(t) is utilized as a time scale for the time merge data such that the time merge data x′₁(t) is on the same time scale with the “cut” value filled in as a result of the preprocessing operation and the data set x₂(t) is processed in accordance with one of the time merged algorithms to provide data for x′₂(t) and on the same time scale as the data x′₁(t). These algorithms will be described in more detail below.

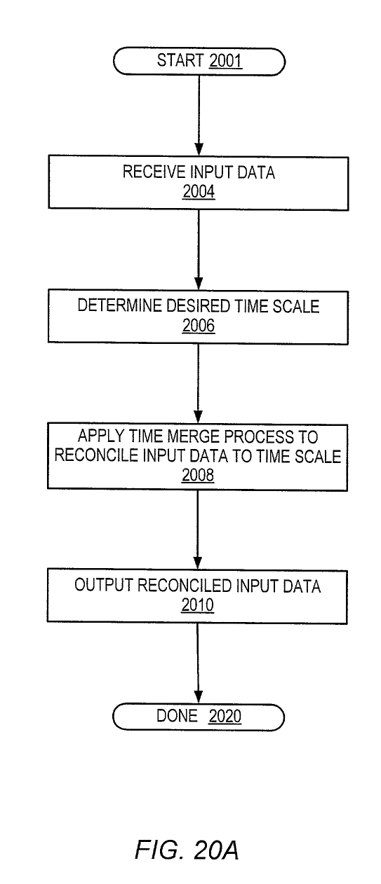

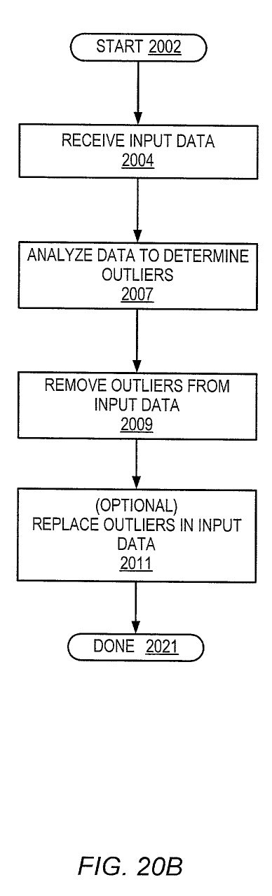

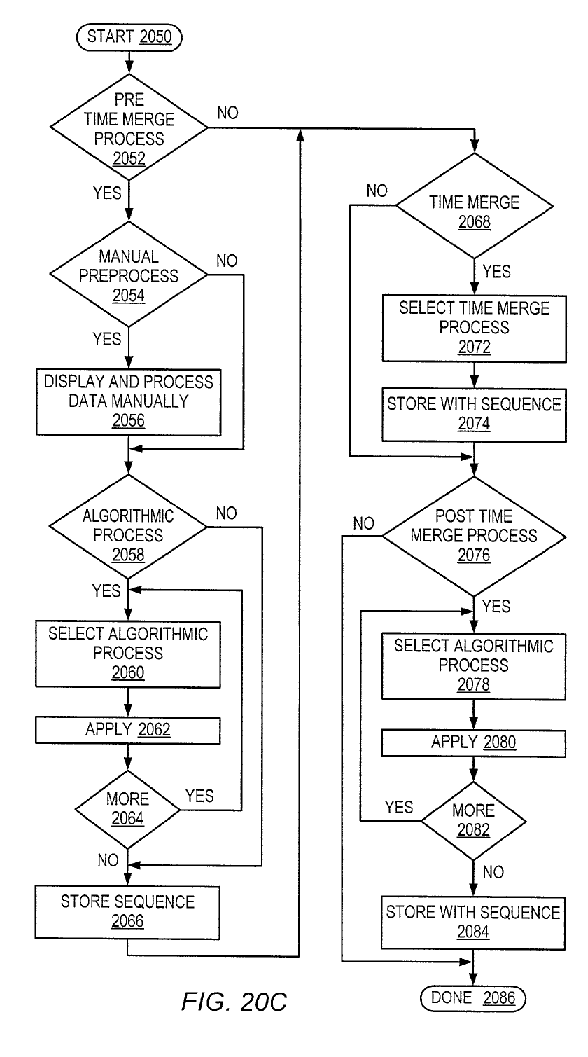

FIG. 20A is a high level flowchart depicting one embodiment of a preprocessing operation for preprocessing input data to a non-linear model. It should be noted that in other embodiments, various of the steps may be performed in a different order than shown, or may be omitted. Additional steps may also be performed.

The preprocess may be initiated at a start block 2001. Then, in 2004, input data for the non-linear model may be received, such as from a run-time system, or data storage. The received data may be stored in an input buffer.

As mentioned above, the non-linear model may comprise a set of model parameters defining a representation of a system. The model parameters may be capable of being trained, i.e., the non-linear model may be trained via the model parameters or coefficients. The input data may be associated with at least two inputs of a non-linear model, and may be on different time scales relative to each other. In the case of missing data associated with a single input, the data may be considered to be on different timescales relative to itself, in that the data gap caused by the missing data may be considered an asynchronous portion of the data.

It should be noted that in other embodiments, the scales of the input data may be based on a different independent variable than time. In one embodiment, one time scale may be asynchronous, and a second time scale may be synchronous with an associated time sequence based on a time interval. In one embodiment, both time scales may be asynchronous. In yet another embodiment, both time scales may be synchronous, but based on different time intervals. As also mentioned above, this un-preprocessed input data may be considered “raw” input data.

In 2006, a desired time scale (or other scale, depending on the independent variable) may be determined. For example, a synchronous time scale represented in the data (if one exists) may be selected as the desired time scale. In another embodiment, a predetermined time scale may be selected.

In 2008, the input data may be reconciled to the desired time scale. In one embodiment, the input data stored in the input buffer of 2004 may be reconciled by a time merge device, such as a software program, thereby generating reconciled data. Thus, after being reconciled by a time merge process, all of the input data for all of the inputs may be on the same time scale. In embodiments where the independent variable of the data is not time, the merge device may reconcile the input data such that all of the input data are on the same independent variable scale.

In one embodiment, where the input data associated with at least one of the inputs has missing data in an associated time sequence, the time merge device may be operable to reconcile the input data to fill in the missing data, thereby reconciling the gap in the data to the time scale of the data set.

In one embodiment, the input data associated with a first one or more of the inputs may have an associated time sequence based on a first time interval, and a second one or more of the inputs may have an associated time sequence based on a second time interval. In this case, the time merge device may be operable to reconcile the input data associated with the first one or more of the inputs to the input data associated with the second one or more other of the inputs, thereby generating reconciled input data associated with the first one or more of the inputs having an associated time sequence based on the second time interval.

In another embodiment, the input data associated with a first one or more of the inputs may have an associated time sequence based on a first time interval, and the input data associated with a second different one or more of the inputs may have an associated time sequence based on a second time interval. The time merge device may be operable to reconcile the input data associated with the first one or more of the inputs and the input data associated with the second one or more of the inputs to a time scale based on a third time interval, thereby generating reconciled input data associated with the first one or more of the inputs and the second one or more of the inputs having an associated time sequence based on the third time interval.

In one embodiment, the input data associated with a first one or more of the inputs may be asynchronous, and wherein the input data associated with a second one or more of the inputs may be synchronous with an associated time sequence based on a time interval. The time merge device may be operable to reconcile the asynchronous input data to the synchronous input data, thereby generating reconciled input data associated with the first one or more of the inputs, wherein the reconciled input data comprise synchronous input data having an associated time sequence based on the time interval.

In 2010, in response to the reconciliation of 2008, the reconciled input data may be output. In one embodiment, an output device may output the data reconciled by the time merge device as reconciled data, where the reconciled data comprise the input data to the non-linear model.

In one embodiment, the received input data of 2004 may comprise training data which includes target input data and target output data. The reconciled data may comprise reconciled training data which includes reconciled target input data and reconciled target output data which are both based on a common time scale (or other common scale).

In one embodiment, the non-linear model may be operable to be trained according to a predetermined training algorithm applied to the reconciled target input data and the reconciled target output data to develop model parameter values such that the non-linear model has stored therein a representation of the system that generated the target output data in response to the target input data. In other words, the model parameters of the non-linear model may be trained based on the reconciled target input data and the reconciled target output data, after which the non-linear model may represent the system.

In one embodiment, the input data of 2004 may comprise run-time data, such as from the system being modeled, and the reconciled data of 2008 may comprise reconciled run-time data. In this embodiment, the non-linear model may be operable to receive the run-time data and generate run-time output data. In one embodiment, the run-time output data may comprise control parameters for the system. The control parameters may be usable to determine control inputs to the system for run-time operation of the system. For example, in an e-commerce system, control inputs may include such parameters as advertisement or product placement on a website, pricing, and credit limits, among others.

In another embodiment, the run-time output data may comprise predictive output information for the system. For example, the predictive output information may be usable in making decisions about operation of the system. In an embodiment where the system may be a financial system, the predictive output information may indicate a recommended shift in investment strategies, for example. In an embodiment where the system may be a manufacturing plant, the predictive output information may indicate production costs related to increased energy expenses, for example.

FIG. 20B is a high level flowchart depicting another embodiment of a preprocessing operation for preprocessing input data to a non-linear model. As noted above, in other embodiments, various of the steps may be performed in a different order than shown, or may be omitted. Additional steps may also be performed. In this embodiment, the input data may include one or more outlier values which may be disruptive or counter-productive to the training and/or operation of the non-linear model.

The preprocess may be initiated at a start block 2002. Then, in 2004, input data for the non-linear model may be received, as described above with reference to FIG. 20A, and may be stored in an input buffer.

In 2007, the received data may be analyzed to determine any outliers in the data set. In other words, the data may be analyzed to determine which, if any, data values fall above or below an acceptable range.

After the determination of any outliers in the data, in 2009, the outliers, if any, may be removed from the data, thereby generating corrected input data. The removal of outliers may result in a data set with missing data, i.e., with gaps in the data.

In one embodiment, a graphical user interface (GUI) may be included whereby a user or operator may view the received data set. The GUI may thus provide a means for the operator to visually inspect the data for bad data points, i.e., outliers. The GUI may further provide various tools for modifying the data, including tools for “cutting” the bad data from the set.

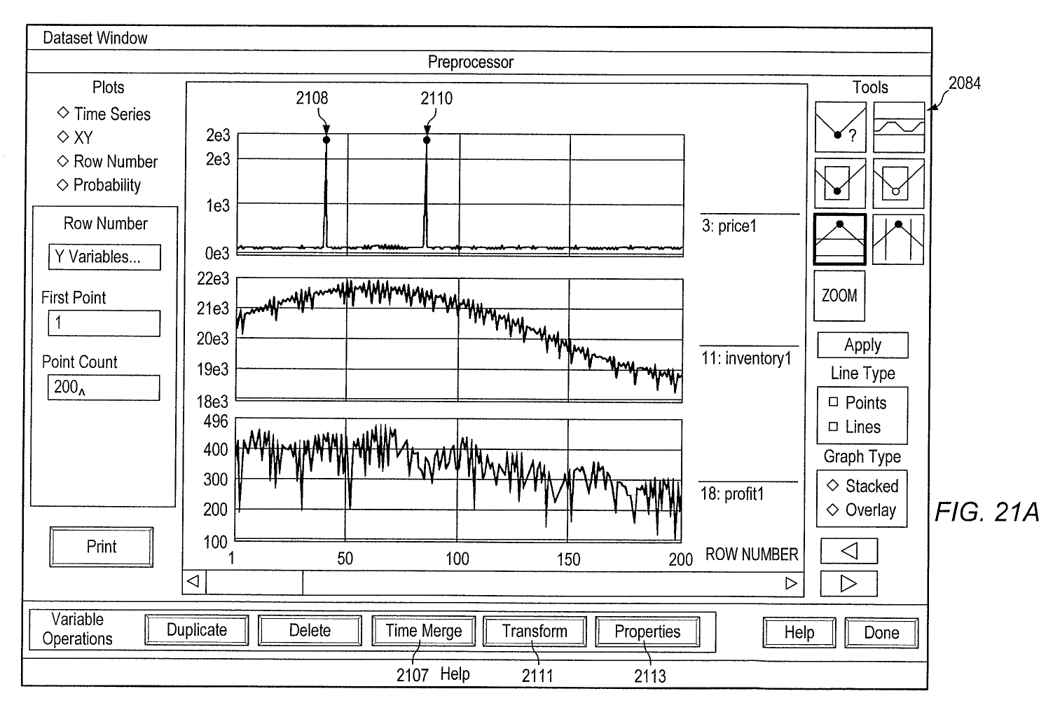

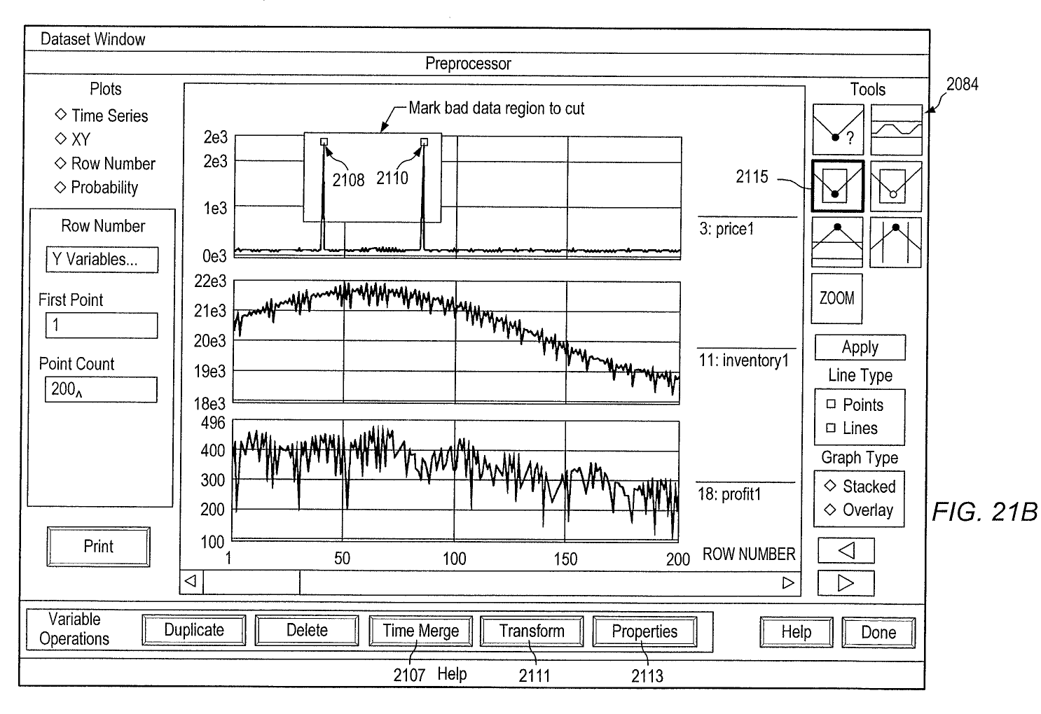

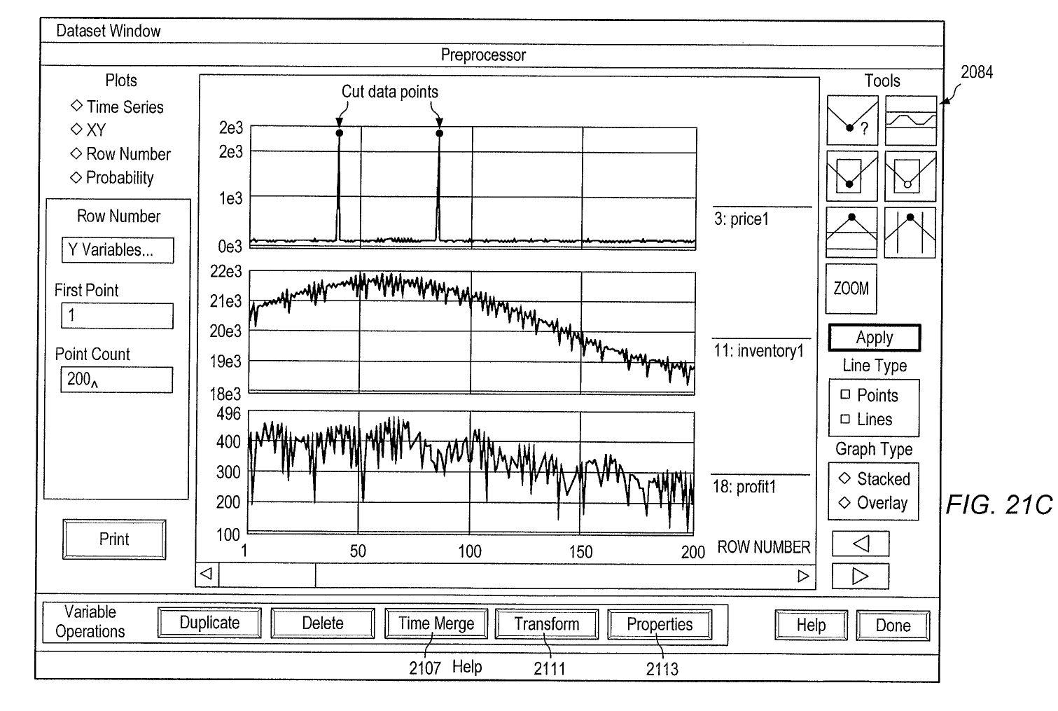

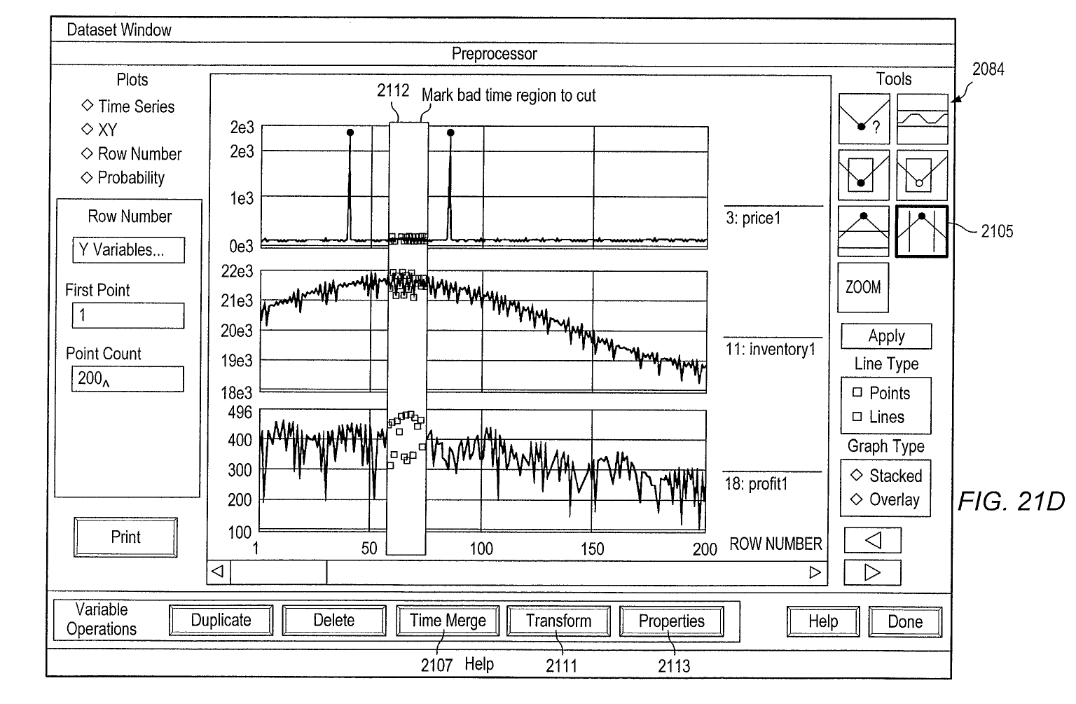

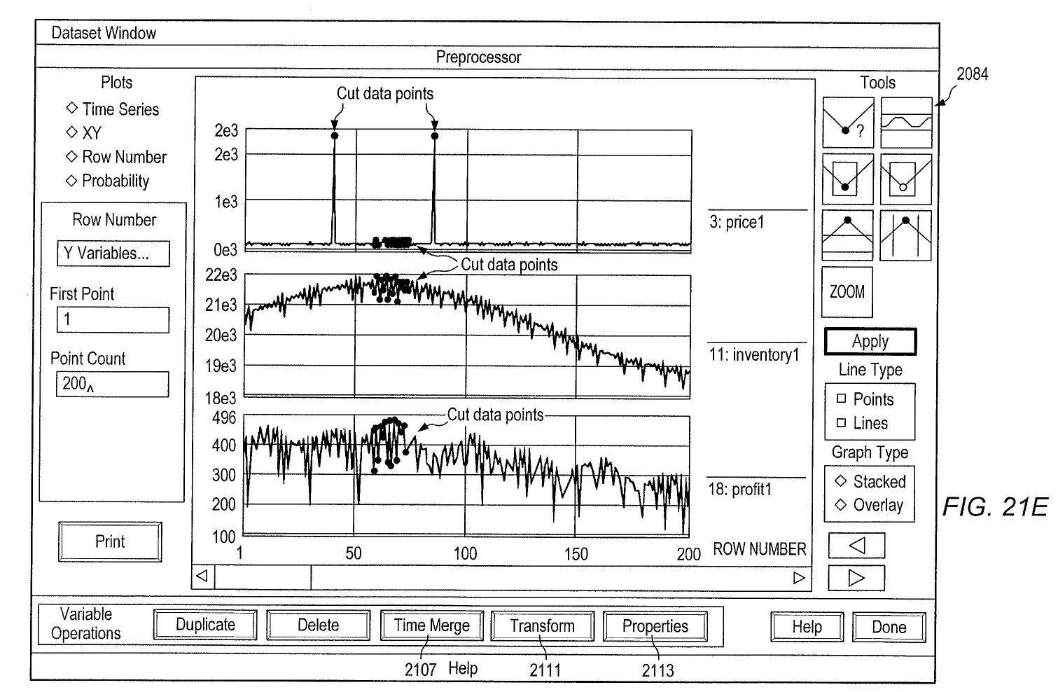

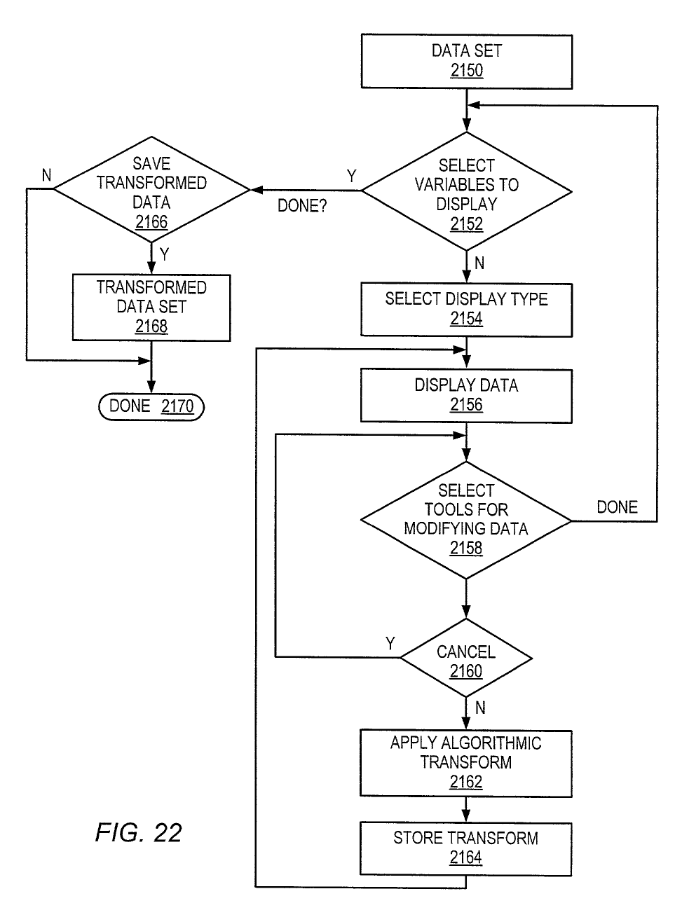

In one embodiment, the detection and removal of the outliers may be performed by the user via the GUI. In another embodiment, the user may use the GUI to specify one or more algorithms which may then be applied to the data programmatically, i.e., automatically. In other words, a GUI may be provided which is operable to receive user input specifying one or more data filtering operations to be performed on the input data, where the one or more data filtering operations operate to remove and/or replace the one or more outlier values. Additionally, the GUI may be further operable to display the input data prior to and after performing the filtering operations on the input data. Finally, the GUI may be operable to receive user input specifying a portion of said input data for the data filtering operations. Further details of the GUI are provided below with reference to FIGS. 21A-21E and FIG. 22.

After the outliers have been removed from the data in 2009, the removed data may optionally be replaced, as indicated in 2011. In other words, the preprocessing operation may “fill in” the gap resulting from the removal of outlying data. Various techniques may be brought to bear to generate the replacement data, including, but not limited to, clipping, interpolation, extrapolation, spline fits, sample/hold of a last prior value, etc., as are well known in the art.

In another embodiment, the removed outliers may be replaced in a later stage of preprocessing, such as the time merge process described above. In this embodiment, the time merge process will detect that data are missing, and operate to fill the gap.

Thus, in one embodiment, the preprocess may operate as a data filter, analyzing input data, detecting outliers, and removing the outliers from the data set. The filter parameters may simply be a predetermined value limit or range against which a data value may be tested. If the value falls outside the range, the value may be removed, or clipped to the limit value, as desired. In one embodiment, the limit(s) or range may be determined dynamically. For example, in one embodiment, the range may be determined based on the standard deviation of a moving window of data in the data set, e.g., any value outside a two sigma band for a moving window of 100 data points may be clipped or removed. As mentioned above, the data filter may also operate to replace the outlier values with more appropriate replacement values.

In one embodiment, the received input data of 2004 may comprise training data including target input data and target output data, and the corrected data may comprise corrected training data which includes corrected target input data and corrected target output data.

In one embodiment, the non-linear model may be operable to be trained according to a predetermined training algorithm applied to the corrected target input data and the corrected target output data to develop model parameter values such that the non-linear model has stored therein a representation of the system that generated the target output data in response to the target input data. In other words, the model parameters of the non-linear model may be trained based on the corrected target input data and the corrected target output data, after which the non-linear model may represent the system.

In one embodiment, the input data of 2004 may comprise run-time data, such as from the system being modeled, and the corrected data of 2011 may comprise reconciled run-time data. In this embodiment, the non-linear model may be operable to receive the corrected run-time data and generate run-time output data. In one embodiment, the run-time output data may comprise control parameters for the system. The control parameters may be usable to determine control inputs to the system for run-time operation of the system. For example, in an e-commerce system, control inputs may include such parameters as advertisement or product placement on a website, pricing, and credit limits, among others.

In another embodiment, the run-time output data may comprise predictive output information for the system. For example, the predictive output information may be usable in making decisions about operation of the system. In an embodiment where the system may be a financial system, the predictive output information may indicate a recommended shift in investment strategies, for example. In an embodiment where the system may be a manufacturing plant, the predictive output information may indicate production costs related to increased energy expenses, for example.

Thus, in one embodiment, the preprocessor may be operable to detect and remove and/or replace outlying data in an input data set for the non-linear model.

FIG. 20C is a detailed flowchart depicting one embodiment of the preprocessing operation. In this embodiment, the preprocessing operations described above with reference to FIGS. 20A and 20B are both included. It should be noted that in other embodiments, various of the steps may be performed in a different order than shown, or may be omitted. Additional steps may also be performed.

The flow chart may be initiated at start block 2050 and then may proceed to a decision block 2052 to determine if there are any pre-time merge process operations to be performed. If so, the program may proceed to a decision block 2054 to determine whether there are any manual preprocess operations to be performed. If so, the program may continue along the “Yes” path to a function block 2056 to manually preprocess the data. In the manual preprocessing of data 2056, the data may be viewed in a desired format by the operator and the operator may look at the data and eliminate, “cut”, or otherwise modify obviously bad data values.

For example, if the operator notices that one data value is significantly out of range with the normal behavior of the remaining data, this data value may be “cut” such that it is no longer present in the data set and thereafter appears as missing data. This manual operation is in contrast to an automatic operation where all values may be subjected to a predetermined algorithm to process the data.

In one embodiment, an algorithm may be generated or selected that either cuts out all data above/below a certain value or clips the values to a predetermined maximum/minimum. In other words, the algorithm may constrain values to a predetermined range, either removing the offending data altogether, or replacing the values, using the various techniques described above, including clipping, interpolation, extrapolation, splines, etc. The clipping to a predetermined maximum/minimum is an algorithmic operation that is described below.

After displaying and processing the data manually, the program may proceed to a decision block 2058. It is noted that if the manual preprocess operation is not utilized, the program may continue from the decision block 2054 along the “No” path to the input of decision block 2058. The decision block 2058 may be operable to determine whether an algorithmic process is to be applied to the data. If so, the program may continue along a “Yes” path to a function block 2060 to select a particular algorithmic process for a given set of data. After selecting the algorithmic process, the program may proceed to a function block 2062 to apply the algorithmic process to the data and then to a decision block 2064 to determine if more data are to be processed with the algorithmic process. If so, the program may flow back around to the input of the function block 2060 along a “Yes” path, as shown. Once all data have been subjected to the desired algorithmic processes, the program may flow along a “No” path from decision block 2064 to a function block 2066 to store the sequence of algorithmic processes such that each data set has the desired algorithmic processes applied thereto in the sequence. Additionally, if the algorithmic process is not selected by the decision block 2058, the program may flow along a “No” path to the input of the function block 2066.

After the sequence is stored in the function block 2066, the program may flow to a decision block 2068 to determine if a time merge operation is to be performed. The program also may proceed along a “No” path from the decision block 2052 to the input of decision block 2068 if the pre-time-merge process is not required. The program may continue from the decision block 2068 along the “Yes” path to a function block 2072 if the time merge process has been selected, and then the time merge operation may be performed. The time merge process may then be stored with the sequence as part thereof in block 2074. The program then may proceed to a decision block 2076 to determine whether the post time merge process is to be performed. If the time merge process is not performed, as determined by the decision block 2068, the program may flow along the “No” path therefrom to the decision block 2076.

If the post time merge process is to be performed, the program may continue along the “Yes” path from the decision block 2076 to a function block 2078 to select the algorithmic process and then to a function block 2080 to apply the algorithmic process to the desired set of data and then to a decision block 2082 to determine whether additional sets of data are to be processed in accordance with the algorithmic process. If so, the program may flow along the “Yes” path back to the input of function block 2078, and if not, the program may flow along the “No” path to a function block 2084 to store the new sequence of algorithmic processes with the sequence and then the program may proceed to a DONE block 2086. If the post time merge process is not to be performed, the program may flow from the decision block 2076 along the “No” path to the DONE block 2086.

Referring now to FIGS. 21A-21E, there are illustrated embodiments of three plots of data. FIGS. 21A-21E also illustrate one embodiment of a graphical user interface (GUI) for various data manipulation/reconciliation operations which may be included in one embodiment of the present invention. It is noted that these embodiments are meant to be exemplary illustrations only, and are not meant to limit the application of the invention to any particular application domain or operation. In this example, each figure includes one plot for an input “price1”, one plot for an input “inventoryl” and one plot for an output “profit1”, as may relate to an e-commerce system. In this example, the first input may relate to pricing, the second input may relate to inventory levels, and the output data may correspond to a profit calculation.

As shown in FIGS. 21A-21C, in the first data set, the price1 data, there are two points of data 2108 and 2110, which need to be “cut” from the data, as they are obviously bad data points. Such data points that lie outside the acceptable range of a data set are generally referred to as “outliers”. These two data points appear as cut data in the data-set, as shown in FIG. 21C, which then may be filled in or replaced by the appropriate time merge operation utilizing extrapolation, interpolation, or other techniques, as desired.

Thus, in one embodiment, the data preprocessor may include a data filter which may be operable to analyze input data, detect outliers, and remove the outliers from the data set. As mentioned above, in one embodiment, the applied filter may simply be a predetermined value limit or range against which a data value may be tested. If the value falls outside the range, the value may be removed, or clipped to the limit value, as desired. In one embodiment, the limit(s) or range may be determined dynamically. For example, in one embodiment, the range may be determined based on the standard deviation of a moving window of data in the data set, e.g., any value outside a two sigma band for a moving window of 100 data points may be clipped or removed. In one embodiment, the filter may replace any removed outliers using any of such techniques as extrapolation and interpolation, among others. In another embodiment, as mentioned above, the removed outliers may be replaced in a later stage of processing, such as the time merge process described herein. In this embodiment, the time merge process will detect that data are missing, and operate to fill the gaps.

FIG. 21A shows the raw data. FIG. 21B shows the use of a cut data region tool 2115. FIG. 21B shows the points 2108 and 2110 highlighted by dots showing them as cut data points. In one embodiment of the GUI presented on a color screen, these dots may appear in red. FIG. 21D shows a vertical cut of the data, cutting across several variables simultaneously. Applying this cut may cause all of the data points to be marked as cut, as shown in FIG. 21E. FIG. 22 flowcharts one embodiment of the steps involved in cutting or otherwise modifying the data. In one embodiment, a region of data may be selected by a set of boundaries 2112 (in FIG. 21D), which results may be utilized to block out data. For example, if it were determined that data during a certain time period were invalid due to various reasons, these data may be removed from the data sets, with the subsequent preprocessing operable to fill in the “blocked” or “cut” data.

In one embodiment, the data may be displayed as illustrated in FIGS. 21A-21E, and the operator may select various processing techniques to manipulate the data via various tools, such as cutting, clipping and viewing tools 2107, 2111, 2113, that may allow the user to select data items to cut, clip, transform or otherwise modify. In one mode, the mode for removing data, this may be referred to as a manual manipulation of the data. However, algorithms may be applied to the data to change the value of that data. Each time the data are changed, the data may be rearranged in the spreadsheet format of the data. In one embodiment, the operator may view the new data as the operation is being performed.

With the provisions of the various clipping and viewing tools 2107, 2111, and 2113, the user may be provided the ability to utilize a graphic image of data in a database, manipulate the data on a display in accordance with the selection of the various cutting tools, and modify the stored data in accordance with these manipulations. For example, a tool may be utilized to manipulate multiple variables over a given time range to delete all of that data from the input database and reflect it as “cut” data. The data set may then be considered to have missing data, which may require a data reconciliation scheme in order to replace this data in the input data stream. Additionally, the data may be “clipped”; that is, a graphical tool may be utilized to determine the level at which all data above (or below) that level is modified. All data in the data set, even data not displayed, may be modified to this level. This in effect may constitute applying an algorithm to that data set.

In FIG. 22, the flowchart depicts one embodiment of an operation of utilizing the graphical tools for cutting data. An initiation block, data set 2150, may indicate the acquisition of the data set. The program then may proceed to a decision block 2152 to determine if the variables have been selected and manipulated for display. If not, the program may proceed along a “No” path to a function block 2154 to select the display type and then to a function block 2156 to display the data in the desired format. The program then may continue to a decision block 2158 wherein tools for modifying the data are selected. When this is done, the program may continue along a “DONE” line back to decision block 2152 to determine if all of the variables have been selected. However, if the data are still in the modification stage, the program may proceed to a decision block 2160 to determine if an operation is cancelled and, if so, may proceed back around to the decision block 2158. If the operation is not cancelled, the program may continue along a “No” path to function block 2162 to apply the algorithmic transformation to the data and then to function block 2164 to store the transform as part of a sequence. The program then may continue back to function block 2156. This may continue until the program continues along the “DONE” path from decision block 2158 back to decision block 2152.

Once all the variables have been selected and displayed, the program may proceed from decision block 2152 along a “Yes” path to decision block 2166 to determine if the transformed data are to be saved. If not, the program may proceed along a “No” path to “DONE” block 2170. If the transformed data are to be saved, the program may continue from the decision block 2166 along the “Yes” path to a function block 2168 to transform the data set and then to the “DONE” block 2170.

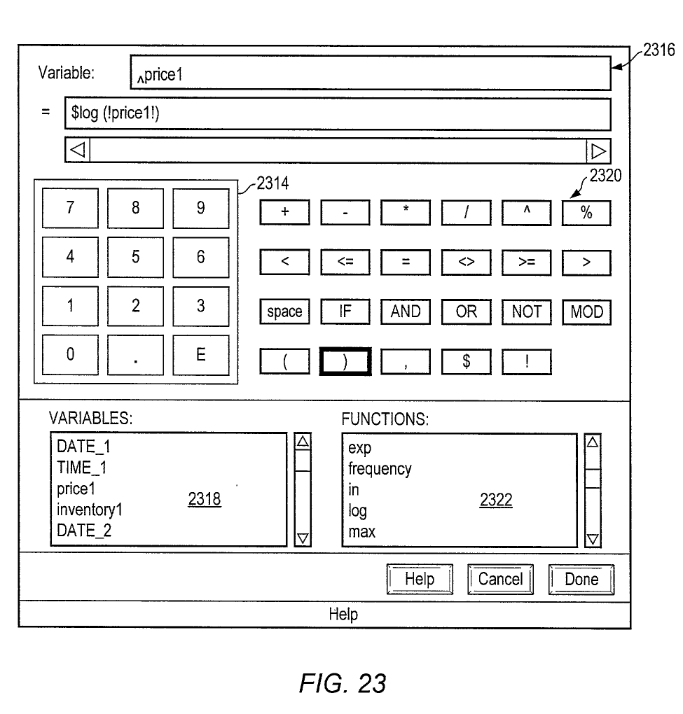

FIG. 23 is a diagrammatic view of a display (i.e., a GUI) for performing algorithmic functions on the data, according to one embodiment. In one embodiment, the display may include a first numerical template 2314 which may provide a numerical keypad function. A window 2316 may be provided that may display the variable(s) that is/are being operated on (e.g., price1, as shown). The variables that are available for manipulation may be displayed in a window 2318. In this embodiment, the various variables are arranged in groups, one group associated with a first date and time, e.g., variables price1 and inventory1, and a second group associated with a second date and time, e.g., variables price2 and inventory2, for example, prior to time merging. A mathematical operator window 2320 may be included that may provide various mathematical operators (e.g., “+”, “−”, etc.) which may be applied to the variables. Various logical operators may also be available in the window 2320 (e.g., “AND”, “OR”, etc.). Additionally, in one embodiment, a functions window 2322 may be included that may allow selection of various mathematical functions, logical functions, etc. (e.g., exp, frequency, in, log, max, etc.) for application to any of the variables, as desired.

In the example illustrated in FIG. 23, the variable price1 may be selected to be processed and the logarithmic function selected for application thereto. For example, the variable price1 may first be selected from window 2318 and then the logarithmic function “log” selected from the window 2322. In one embodiment, the left parenthesis may then be selected from window 2320, followed by the selection of the variable price1 from window 2318, then followed by the selection of the right parenthesis from window 2320. This may result in the selection of an algorithmic process which includes a logarithm of the variable price1. This may then be stored as a sequence, such that upon running the data through the run-time sequence, data associated with the variable price1 has the logarithmic function applied thereto prior to inputting to the run-time system model 1426. This process may be continued or repeated for each desired operation.

After the data have been manually preprocessed as described above with reference to FIGS. 21A-21E and FIG. 22, the resultant data may be shown to have a time scale difference. For example, one group associated with the time TIME_1 and one group associated with the time TIME_2. Continuing the example, the first time scale may be based on an hourly interval and the second time scale may be based on a two hour interval. Of course, any time scales may be used or chosen. Any “cut” data may appear as missing data.

After the data have been manually preprocessed, the algorithmic processes may be applied thereto. In the example described above with reference to FIG. 23, the variable price1 is processed by taking a logarithm thereof. This may result in a variation of the set of data associated with the variable price1. This variation may be stored for future use.

The sequence of operations associated therewith may determine the data that were cut out of the original data set for data price1 and also the algorithmic processes associated therewith, these being in a sequence which is stored in the sequence block 1414 and which may be examined via a data-column properties module 2113, shown in FIGS. 21A-21E.

To perform the time merge, the operator may select the time merge function 2115, illustrated in FIG. 21B, and may specify the time scale and type of time merge algorithm. For example, in FIG. 21B, a one-hour time-scale is selected and the box-car algorithm of merging is used.

After the time merge, the time scale may be disposed on an hourly interval with the time merge process, wherein all of the data are on a common time scale and the cut data has been extrapolated to insert new data.

The sequence after time merge may include the data that are cut from the original data sets, the algorithmic processes utilized during the pre-time merge processing, and the time merge data.

After the time merge operation, additional processing may be utilized. For example, the display of FIG. 23 may again be pulled up, and another algorithmic process selected. One example may be to take the variable price1 after time merge and increase the value of this variable by a user-specified percentage (e.g., 10%). This may result in each date-time identified value of the variable price1 being increased by the user-specified amount, (e.g., if the prior price1 value was 100, the modified value may be 110). The sequence may then be updated.

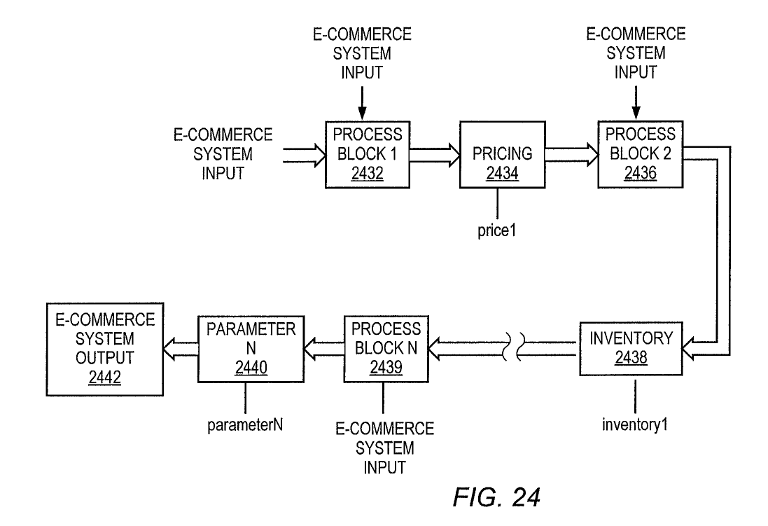

FIG. 24 is a block diagram of one embodiment of a process flow, such as, for example, a process flow for an e-commerce system. It is noted that although process flow for an e-commerce system is an exemplary application of one embodiment of the present invention, any other process may also be suitable for application of the systems and methods described herein, including scientific, medical, financial, stock and/or bond management, and manufacturing, among others.

As shown, an e-commerce system input may be sent to a process block 2432, wherein various e-commerce system processes may be carried out. Various e-commerce system inputs may be provided to this process block 2432. The flow may then continue to a pricing block 2434, which may output a variable price1. The flow may proceed to a process block 2436 to perform other e-commerce system processes, these also receiving e-commerce system inputs. The flow may then continue to an inventory block 2438, which may output a variable inventory1. The flow may continue through various other process blocks 2439 and other parameter measurement blocks 2440, resulting in an overall e-commerce system output 2442 which may be the desired e-commerce system output. It may be seen that numerous processes may occur prior to the e-commerce system output 2442 being generated. Additionally, other e-commerce system outputs such as price1 and inventory1 may occur at different stages in the process. This may result in delays between a measured parameter and an effect on the e-commerce system output. The delays associated with one or more parameters in a data set may be considered a variance in the time scale for the data set. In one embodiment, adjustments for these delays may be made by reconciling the data to homogenize the time scale of the data set, as described below.

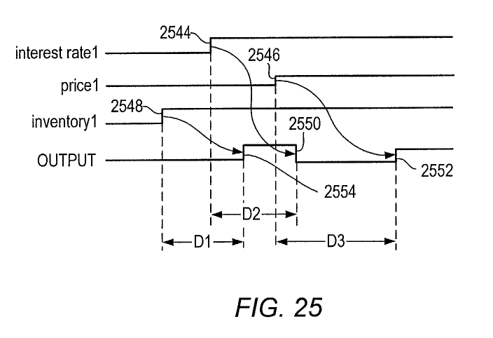

FIG. 25 is a timing diagram illustrating the various effects of variables from the e-commerce system and the e-commerce system output, according to one embodiment. The variable interest rate1 (not shown in FIG. 24) may experience a change at a point 2544. Similarly, the variable price1 may experience a change at a point 2546, and the variable inventory1 may experience a change at a point 2548. However, the corresponding change in the output may not be time synchronous with the changes in the variables. Referring to the line labeled OUTPUT, changes in the e-commerce system output may occur at points 2550, 2552 and 2554, for the respective changes in the variables at points 2544-2548, respectively. The change between points 2544 and 2550 and the variable interest rate1 and the output, respectively, may experience a delay D2. The change in the output of point 2552 associated with the change in the variable price1 may occur after delay D3. Similarly, the change in the output of point 2554 associated with the change in the variable inventory1 may occur after delay D1. In accordance with one embodiment of the present invention, these delays may be accounted for during training, and/or during the run-time operation.

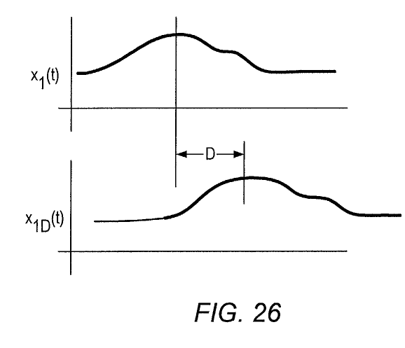

FIG. 26 is a diagrammatic view of the delay for a given input variable x₁(t), according to one embodiment. It may be seen that a delay D is introduced to the system to provide an output x_{1D}(t) such that x_{1D}(t)=x₁(t−D), this output may then be input to the non-linear model. As such, the measured variables may now coincide in time with the actual effect that is realized in the measured output such that, during training, a system model may be trained with a more accurate representation of the system.

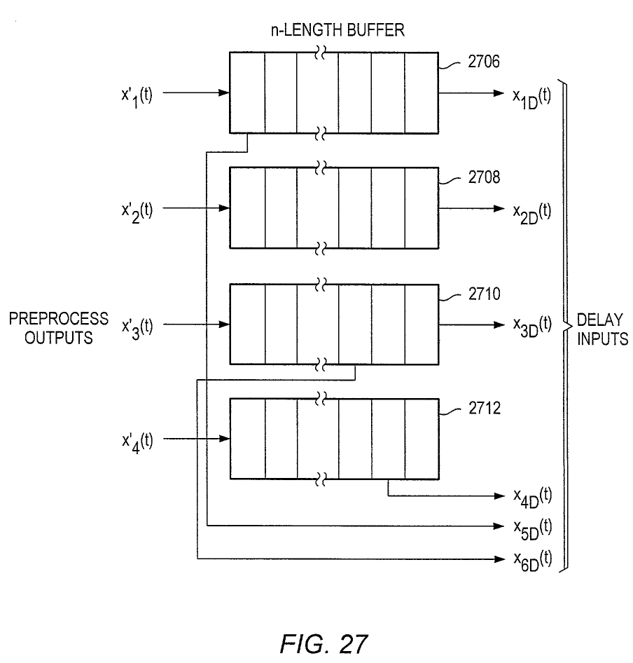

FIG. 27 is a diagrammatic view of the method for implementing the delay, according to one embodiment. Rather than providing an additional set of data for each delay that is desired, x(t+τ), variable length buffers may be provided in each data set after preprocessing, the length of which may correspond to the longest delay. Multiple taps may be provided in each of the buffers to allow various delays to be selected. In FIG. 27, there are illustrated four buffers 2706, 2708, 2710 and 2712, associated with the preprocessed inputs x′₁(t), x′₂(t), x′₃(t), and x′₄(t). Each of the buffers has a length of N, such that the first buffer 2706 outputs the delay input x_{1D}(t), the second buffer 2708 outputs the delay input x_{2D}(t), and the third buffer 2710 outputs the delay input x_{3D}(t). The buffer 2712, on the other hand, has a delay tap that may provide for a delay of “n−1” to provide an output x_{4D}(t). An output x_{5D}(t) may be provided by selecting the first tap in the buffer 2706 such that the relationship x_{5D}(t)=x′₁(t+1). Additionally, the delayed input x_{6D}(t) may be selected as a tap output of the buffer 2710 with a value of τ=2. This may result in the overall delay inputs to the training model 1420. Additionally, these delays may be stored as delay settings for use during the run-time.

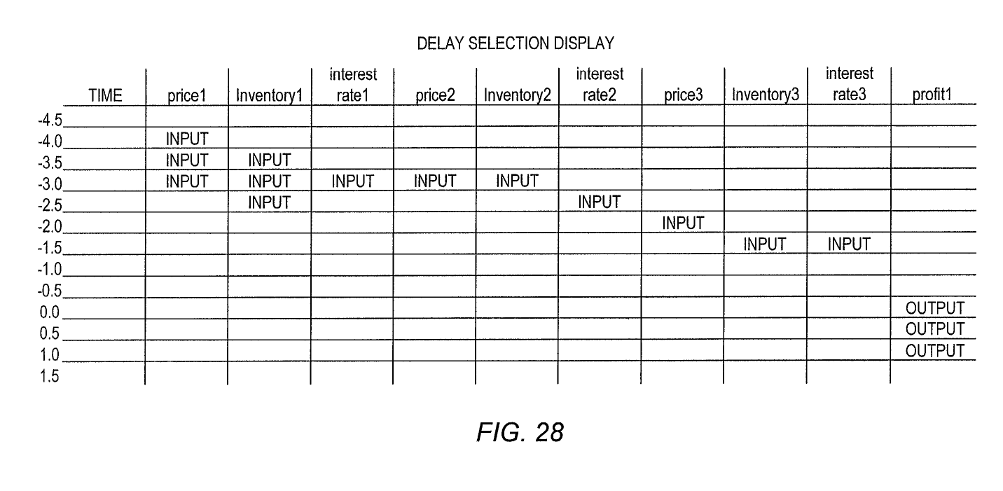

FIG. 28 illustrates one embodiment of a display that may be provided to the operator for selecting the various delays to be applied to the input variables and the output variables utilized in training. In this example, it may be seen that by selecting a delay for the variable price1 of −4.0, −3.5, and −3.0, three separate input variables have been selected for input to the training model 1420. Additionally, three separate outputs are shown as selected, one for delay 0.0, one for a delay 0.5, and one for a delay of 1.0, to predict present and future values of the variable. Each of these may be processed to vary the absolute value of the delays associated with the input variables. It may therefore be seen that a maximum buffer of −4.0 for an output of 0.0 may be needed in order to provide for the multiple taps. Further, it may be seen that it is not necessary to completely replicate the data in any of the delayed variable columns as a separate column, thus increasing the amount of memory utilized.

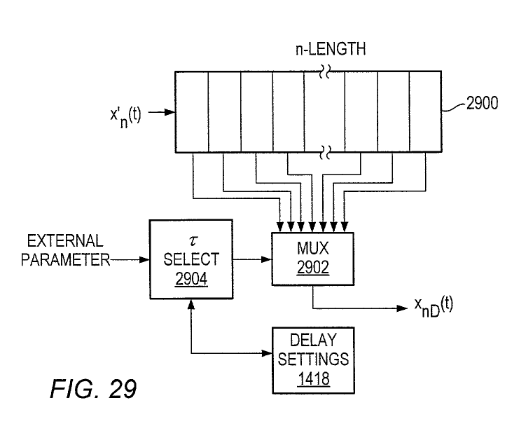

FIG. 29 is a block diagram of one embodiment of a system for generating process dependent delays. A buffer 2900 is illustrated having a length of N, which may receive an input variable x′ₙ(t) from the preprocessor 1412 to provide on the output thereof an output x_{nD}(t) as a delayed input to the training model 1420. A multiplexer 2902 may be provided which has multiple inputs, one from each of the n buffer registers with a τ-select circuit 2904 provided for selecting which of the taps to output. The value of τ may be a function of other variables parameters such as price, inventory, interest rates, etc. For example, it may be noted empirically that the delays are a function of price. As such, the price relationship may be placed in the block 2904 and then the external parameters input and the value of τ utilized to select the various taps input to the multiplexer 2902 for output therefrom as a delay input. The system of FIG. 29 may also be utilized in the run-time operation wherein the various delay settings and functional relationships of the delay with respect to the external parameters are stored in the storage area 1418. The external parameters may then be measured and the value of τ selected as a function of this price and the functional relationship provided by the information stored in the storage area 1418. This is to be compared with the training operation wherein this information is externally input to the system. For example, with reference to FIG. 28, it may be noticed that all of the delays for the variable price1 may be shifted up by a value of 0.5 when the price reached a certain point. With the use of the multiple taps, as described with respect to FIGS. 27 and 29, it may only be necessary to vary the value of the control input to the multiplexers 2902 associated with each of the variables, it being understood that in the example of FIG. 28, three multiplexers 2902 would be required for the variable price1, since there are three separate input variables.

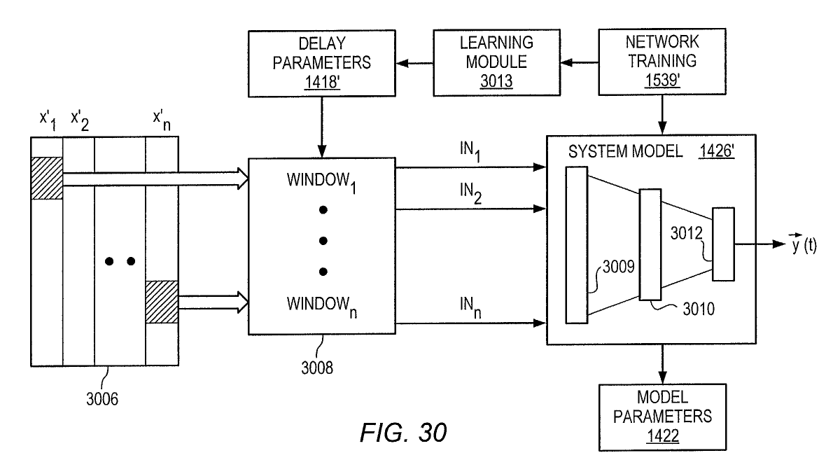

FIG. 30 is a block diagram of one embodiment of a preprocessing system for setting delay parameters, where the delay parameters may be learned. For simplicity, the preprocessing system is not illustrated; rather, a table 3006 of the preprocess data is shown. Further, the methods for achieving the delay may differ somewhat, as described below. The delay may be achieved by a time delay adjustor 3008, which may utilize the stored parameters in a delayed parameter block 1418′. The delay parameter block 1418′ is similar to the delay setting block 1418, with the exception that absolute delays are not contained therein. Rather, information relating to a window of data may be stored in the delay parameter block 1418′. The time delay adjustor 3008 may be operable to select a window of data within each set of data in the table 3006, the data labeled x′₁ through x′ₙ. The time delay adjustor 3008 may be operable to receive data within a defined window associated with each of the sets of data x′₁-x′ₙ and convert this information into a single value for output therefrom as an input value IN₁-INₙ. These may be directly input to a system model 1426′, which system model 1426′ is similar to the run-time system model 1426 and the training model 1420 in that it is realized with a non-linear model (e.g., a neural network or a support vector machine). The non-linear model is illustrated as having an input layer 3009, a middle layer 3010 and an output layer 3012. The middle layer 3010 may be operable to map the input layer 3009 to the output layer 3012, as described below. However, note that this is a non-linear mapping function. By comparison, the time delay adjustor 3008 may be operable to linearly map each of sets of data x′₁-x′ₙ in the table 3006 to the input layer 3009. This mapping function may be dependent upon the delay parameters in the delay parameter block 1418′. As described below, these parameters may be learned under the control of a learning module 3013, which learning module 3013 may be controlled during the non-linear model training in the training mode.

During learning, the learning module 3013 may be operable to control both the time delay adjustor block 3008 and the delay parameter block 1418′ to change the values thereof in training of the system model 1426′. During training, target outputs may be input to the output layer 3012 and a set of training data input thereto in the form of the chart 3006, it being noted that this is already preprocessed in accordance with the operation as described above. The model parameters of the system model 1426′ stored in the storage area 1422 may then be adjusted in accordance with a predetermined training algorithm to minimize the error. However, the error may only be minimized to a certain extent for a given set of delays. Only by setting the delays to their optimum values may the error be minimized to the maximum extent. Therefore, the learning module 3013 may be operable to vary the parameters in the delay parameter block 1418′ that are associated with the timing delay adjustor 3008 in order to further minimize the error.

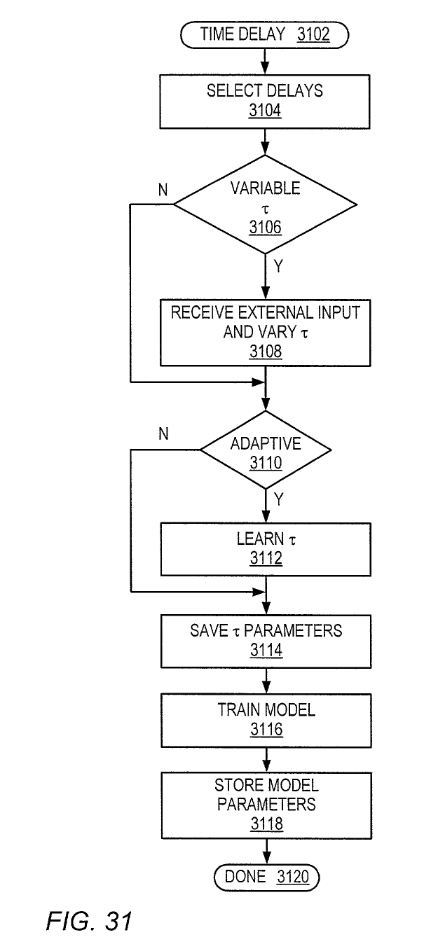

FIG. 31 is a flowchart illustrating the determination of time delays for the training operation, according to one embodiment. This flowchart may be initiated at a time delay block 3102 and may then continue to a function block 3104 to select the delays. In one embodiment, this may be performed by the operator as described above with respect to FIG. 28. The program may then continue to a decision block 3106 to determine whether variable τ are selected. The program may continue along a “Yes” path to a function block 3108 to receive an external input and vary the value of τ in accordance with the relationship selected by the operator, this being a manual operation in the training mode. The program may then continue to a decision block 3110 to determine whether the value of τ is to be learned by an adaptive algorithm. If variable τ are not selected in the decision block 3106, the program may then continue around the function block 3108 along the “No” path.

If the value of τ is to be learned adaptively, the program may continue from the decision block 3110 to a function block 3112 to learn the value of τ adaptively. The program may then proceed to a function block 3114 to save the value of τ. If no adaptive learning is required, the program may continue from the decision block 3110 along the “No” path to function block 3114. After the τ parameters have been determined, the model 1420 may be trained, as indicated by a function block 3116 and then the parameters may be stored, as indicated by a function block 3118. Following storage of the parameters, the program may flow to a DONE block 3120.

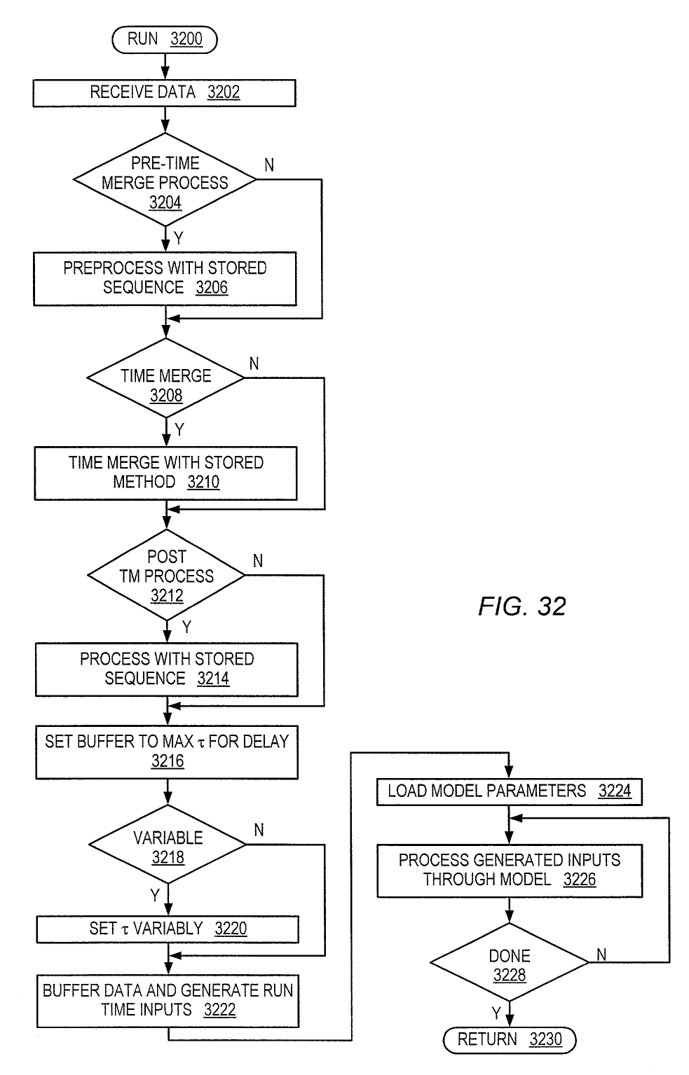

FIG. 32 is a flowchart depicting operation of the system in run-time mode, according to one embodiment. The operation may be initiated at a run block 3200 and may then proceed to a function block 3202 to receive the data and then to a decision block 3204 to determine whether the pre-time merge process is to be entered. If so, the program may proceed along a “Yes” path to a function block 3206 to preprocess the data with the stored sequence and then to a decision block 3208. If not, the program may continue along the “No” path to the input of decision block 3208. Decision block 3208 may determine whether the time merge operation is to be performed. If so, the program may proceed along the “Yes” path to function block 3210 to time merge with the stored method and then to the input of a decision block 3212 and, if not, the program may continue along the “No” path to the decision block 3212. The decision block 3212 may determine whether the post-time merge process is to be performed. If so, the program may proceed along the “Yes” path to a function block 3214 to process the data with the stored sequence and then to a function block 3216 to set the buffer equal to the maximum τ for the delay. If not, (i.e., if the post-time merge process is not selected), the program may proceed from the decision block 3212 along the “No” path to the input of function block 3216.

After completion of function block 3216, the program may continue to a decision block 3218 to determine whether the value of τ is to be varied. If so, the program may proceed to a function block 3220 to set the value of τ variably, then to the input of a function block 3222 and, if not, the program may continue along the “No” path to function block 3222. Function block 3222 may be operable to buffer data and generate run-time inputs. The program may then continue to a function block 3224 to load the model parameters. The program may then proceed to a function block 3226 to process the generated inputs through the model and then to a decision block 3228 to determine whether all of the data has been processed. If all of the data has not been processed, the program may continue along the “No” path back to the input of function block 3226 until all data are processed and then along the “Yes” path to return block 3230.

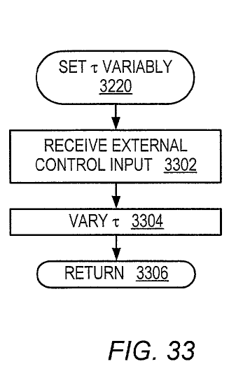

FIG. 33 is a flowchart for the operation of setting the value of τ variably (i.e., expansion of the function block 3220, as illustrated in FIG. 32), according to one embodiment. The operation may be initiated at a block 3220, set τ variably, and then may proceed to a function block 3302 to receive the external control input. The value of τ may be varied in accordance with the relationship stored in the storage area 1414, as indicated by a function block 3304. Finally, the operation may proceed to a return function block 3306.

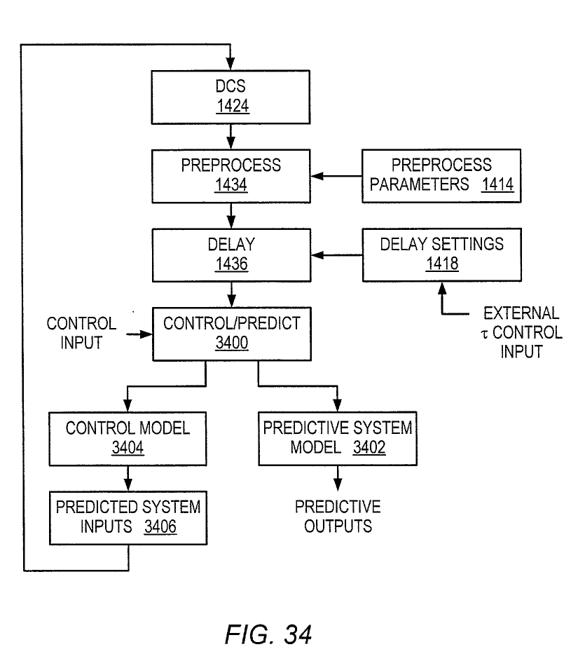

FIG. 34 is a simplified block diagram for the overall run-time operation, according to one embodiment. Data may be initially output by the DCS 1424 during run-time. The data may then be preprocessed in the preprocess block 1434 in accordance with the preprocess parameters stored in the storage area 1414. The data may then be delayed in the delay block 1436 in accordance with the delay settings set in the delay block 1418, this delay block 1418 may also receive the external block control input, which may include parameters on which the value of τ depends to provide the variable setting operation that was utilized during the training mode. The output of the delay block 1436 may then be input to a selection block 3400, which may receive a control input. This selection block 3400 may select either a control non-linear model or a prediction non-linear model. A predictive system model 3402 may be provided and a control model 3404 may be provided, as shown. Both models 3402 and 3404 may be identical to the training model 1420 and may utilize the same parameters; that is, models 3402 and 3404 may have stored therein a representation of the system that was trained in the training model 1420. The predictive system model 3402 may provide on the output thereof predictive outputs, and the control model 3404 may provide on the output thereof predicted system inputs for the DCS 1424. These predicted system inputs may be stored in a block 3406 and then may be translated to control inputs to the DCS 1424.

In one embodiment of the present invention, a predictive non-linear model may operate in a run-time mode or in a training mode with a data preprocessor for preprocessing the data prior to input to a system model. The predictive non-linear model may include an input layer, an output layer and a middle layer for mapping the input layer to the output layer through a representation of a run-time system. Training data derived from the training system may be stored in a data file, which training data may be preprocessed by a data preprocessor to generate preprocessed training data, which may then be input to the non-linear model and trained in accordance with a predetermined training algorithm. The model parameters of the non-linear model may then be stored in a storage device for use by the data preprocessor in the run-time mode. In the run-time mode, run-time data may be preprocessed by the data preprocessor in accordance with the stored data preprocessing parameters input during the training mode and then this preprocessed data may be input to the non-linear model, which non-linear model may operate in a prediction mode. In the prediction mode, the non-linear model may output a prediction value.

In another embodiment of the present invention, a system for preprocessing data prior to training the model is presented. The preprocessing operation may be operable to provide a time merging of the data such that each set of input data is input to a training system model on a uniform time base. Furthermore, the preprocessing operation may be operable to fill in missing or bad data. Additionally, after preprocessing, predetermined delays may be associated with each of the variables to generate delayed inputs. These delayed inputs may then be input to a training model and the training model may be trained in accordance with a predetermined training algorithm to provide a representation of the system. This representation may be stored as model parameters. Additionally, the preprocessing steps utilized to preprocess the data may be stored as a sequence of preprocessing algorithms and the delay values that may be determined during training may also be stored. A distributed control system may be controlled to process the output parameters therefrom in accordance with the process algorithms and set delays in accordance with the predetermined delay settings. A predictive system model, or a control model, may then be built on the stored model parameters and the delayed inputs input thereto to provide a predicted output. This predicted output may provide for either a predicted output or a predicted control input for the run-time system. It is noted that this technique may be applied to any of a variety of application domains, and is not limited to plant operations and control. It is further noted that the delay described above may be associated with other variables than time. In other words, the delay may refer to offsets in the ordered correlation between process variables according to an independent variable other than time t.

Thus, various embodiments of the systems and methods described above may perform preprocessing of input data for training and/or operation of a non-linear model.

Although the system and method of the present invention have been described in connection with several embodiments, the invention is not intended to be limited to the specific forms set forth herein, but on the contrary, it is intended to cover such alternatives, modifications, and equivalents as may be reasonably included within the spirit and scope of the invention as defined by the appended claims.

What is claimed is:

1. A data preprocessor for preprocessing input electronic commerce data for a non-linear model used to control an electronic commerce system, wherein the input electronic commerce data include one or more outlier values, comprising:
an input buffer which is operable to receive and store the input electronic commerce data;
a data filter which is operable to detect and remove said one or more outlier values, thereby generating corrected input electronic commerce data; and
an output device for outputting the corrected input electronic commerce data, said corrected input electronic commerce data comprising the input electronic commerce data to the non-linear model.

2. The data preprocessor of claim 1, wherein the non-linear model includes a set of model parameters defining a representation of the electronic commerce system, said model parameters capable of being trained;
wherein the input electronic commerce data comprise training electronic commerce data, wherein said corrected input electronic commerce data comprise corrected training electronic commerce data including corrected target input electronic commerce data and corrected target output electronic commerce data; and
wherein the non-linear model is operable to be trained according to a predetermined training algorithm applied to said corrected target input electronic commerce data and said corrected target output electronic commerce data to develop model parameter values such that said non-linear model has stored therein a representation of the electronic commerce system that generated the target output electronic commerce data in response to the corrected target input electronic commerce data.

3. The data preprocessor of claim 1, wherein the non-linear model includes a set of model parameters defining a representation of the electronic commerce system, wherein said model parameters of said non-linear model have been trained to represent said system;
wherein the input electronic commerce data comprise run-time electronic commerce data, and wherein said corrected input electronic commerce data comprise corrected run-time electronic commerce data; and
wherein the non-linear model is operable to receive said corrected run-time electronic commerce data and generate run-time output electronic commerce data, wherein said run-time output electronic commerce data comprise one or both of control parameters for said electronic commerce system and predictive output information for said electronic commerce system.

4. The data preprocessor of claim 3, wherein said control parameters are usable to determine control inputs to said system for run-time operation of said system.

5. The data preprocessor of claim 1, wherein the data filter is further operable to replace said one or more outlier values with replacement values, wherein said corrected input includes said replacement values.

6. The data preprocessor of claim 5, wherein the data filter is operable to replace said one or more outlier values using one or more of clipping, interpolation, extrapolation, spline fit, and sample/hold of a last prior value.

7. The data preprocessor of claim 1, further comprising:
a graphical user interface (GUI) which is operable to receive user input specifying one or more data filtering operations to be performed on said input electronic commerce data, wherein said one or more data filtering operations operate to remove and/or replace said one or more outlier values.

8. The data preprocessor of claim 7, wherein said GUI is further operable to display said input electronic commerce data prior to and after performing said filtering operations on said input electronic commerce data.

9. The data preprocessor of claim 7, wherein said GUI is further operable to receive user input specifying a portion of said input electronic commerce data for said data filtering operations.

10. The data preprocessor of claim 1, wherein the input electronic commerce data comprise a plurality of variables, each of the variables comprising an input variable with an associated set of electronic commerce data wherein each of said variables comprises an input to said input buffer; and
wherein each of at least a subset of said variables comprises a corresponding one of the inputs to the non-linear model.

11. A method for preprocessing input electronic commerce data prior to input to a non-linear model used to control an electronic commerce system, wherein said non-linear model comprises multiple inputs, each of the inputs associated with a portion of the input electronic commerce data, wherein the input electronic commerce data include one or more outlier values, the method comprising:
receiving and storing the input electronic commerce data;
analyzing said input electronic commerce data to determine said one or more outlier values;
removing said one or more outlier values, thereby generating corrected input electronic commerce data; and
outputting the corrected electronic commerce data, said corrected electronic commerce data comprising the input electronic commerce data to the non-linear model.

12. The method of claim 11, wherein the non-linear model includes a set of model parameters defining a representation of the electronic commerce system, said model parameters capable of being trained; and
wherein the input electronic commerce data comprise training electronic commerce data including target input electronic commerce data and target output electronic commerce data, wherein said corrected electronic commerce data comprise corrected training electronic commerce data including corrected target input electronic commerce data and corrected target output electronic commerce data;
the method further comprising:
training the non-linear model according to a predetermined training algorithm applied to said corrected target input electronic commerce data and said corrected target output electronic commerce data to develop model parameter values such that said non-linear model has stored therein a representation of the electronic commerce system that generated the target output electronic commerce data in response to the target input electronic commerce data.

13. The method of claim 11, wherein the non-linear model includes a set of model parameters defining a representation of the electronic commerce system, wherein said model parameters of said non-linear model have been trained to represent said system; and
wherein the input electronic commerce data comprise run-time electronic commerce data, and wherein said corrected electronic commerce data comprise corrected run-time electronic commerce data;
the method further comprising:
inputting said run-time electronic commerce data into the non-linear model to generate run-time output electronic commerce data, wherein said run-time output electronic commerce data comprise one or both of control parameters for said system and predictive output information for said system.

14. The method of claim 13, wherein said control parameters are usable to determine control inputs to said system for run-time operation of said system.

15. The method of claim 11, further comprising:
replacing said one or more outlier values with replacement values, wherein said corrected input includes said replacement values.

16. The method of claim 15, wherein said replacing said one or more outlier values is performed using one or more of clipping, interpolation, extrapolation, spline fit, and sample/hold of a last prior value.

17. The method of claim 11, further comprising:
receiving user input specifying one or more data filtering operations to be performed on said input electronic commerce data, wherein said analyzing and said removing said one or more outlier values comprises performing said one or more data filtering operations on the input electronic commerce data.

18. The method of claim 11, further comprising:
displaying said input electronic commerce data prior to and after performing said filtering operations on said input electronic commerce data.

19. The method of claim 11, further comprising:
receiving user input specifying a portion of said input electronic commerce data for said data filtering operations.

20. The method of claim 11, wherein the input electronic commerce data comprise a plurality of variables, each of the variables comprising an input variable with an associated set of electronic commerce data wherein each of said variables comprises an input to said input buffer; and
wherein each of at least a subset of said variables comprises a corresponding one of the inputs to the non-linear model.

21. A system for preprocessing input electronic commerce data for a non-linear model used to control an electronic commerce system, wherein said non-linear model comprises multiple inputs, each of the inputs associated with a portion of the input electronic commerce data, wherein the input electronic commerce data include one or more outlier values, comprising:
means for receiving and storing the input electronic commerce data;
means for analyzing said input electronic commerce data to determine said one or more outlier values;
means for removing said one or more outlier values, thereby generating corrected input electronic commerce data; and
means for outputting the corrected electronic commerce data, said corrected electronic commerce data comprising the input electronic commerce data to the non-linear model.

22. The system of claim 21, wherein the non-linear model includes a set of model parameters defining a representation of the electronic commerce system, said model parameters capable of being trained; and
wherein the input electronic commerce data comprise training electronic commerce data including target input electronic commerce data and target output electronic commerce data, wherein said corrected electronic commerce data comprise corrected training electronic commerce data including corrected target input electronic commerce data and corrected target output electronic commerce data;
the system further comprising:
means for training the non-linear model according to a predetermined training algorithm applied to said corrected target input electronic commerce data and said corrected target output electronic commerce data to develop model parameter values such that said non-linear model has stored therein a representation of the electronic commerce system that generated the target output electronic commerce data in response to the target input electronic commerce data.

23. The system of claim 21, wherein the non-linear model includes a set of model parameters defining a representation of the electronic commerce system, wherein said model parameters of said non-linear model have been trained to represent said electronic commerce system; and
wherein the input electronic commerce data comprise run-time electronic commerce data, and wherein said corrected electronic commerce data comprise corrected run-time electronic commerce data;
the system further comprising:
means for inputting said run-time electronic commerce data into the non-linear model to generate run-time output electronic commerce data, wherein said run-time output electronic commerce data comprise one or both of control parameters for said electronic commerce system and predictive output information for said electronic commerce system.

24. The system of claim 23, wherein said control parameters are usable to determine control inputs to said electronic commerce system for run-time operation of said electronic commerce system.

25. The system of claim 21, further comprising:
means for replacing said one or more outlier values with replacement values, wherein said corrected input includes said replacement values.

26. The system of claim 25, wherein said replacing said one or more outlier values is performed using one or more of clipping, interpolation, extrapolation, spline fit, and sample/hold of a last prior value.

27. The system of claim 21, further comprising:
means for receiving user input specifying one or more data filtering operations to be performed on said input electronic commerce data, wherein said analyzing and said removing said one or more outlier values comprises performing said one or more data filtering operations on the input electronic commerce data.

28. The system of claim 21, further comprising:
means for displaying said input electronic commerce data prior to and after performing said filtering operations on said input electronic commerce data.

29. The system of claim 21, further comprising:
means for receiving user input specifying a portion of said input electronic commerce data for said data filtering operations.

30. The system of claim 21, wherein the input electronic commerce data comprise a plurality of variables, each of the variables comprising an input variable with an associated set of electronic commerce data wherein each of said variables comprises an input to said input buffer; and
wherein each of at least a subset of said variables comprises a corresponding one of the inputs to the non-linear model.

31. A carrier medium which stores program instructions for preprocessing input electronic commerce data prior to input to a non-linear model used to control an electronic commerce system, wherein said non-linear model comprises multiple inputs, each of the inputs associated with a portion of the input electronic commerce data, wherein the input electronic commerce data comprise one or more outlier values, wherein said program instructions are executable to:
receive and store the input electronic commerce data;
analyze said input electronic commerce data to determine said one or more outlier values;
remove said one or more outlier values, thereby generating corrected input electronic commerce data; and
output the corrected electronic commerce data, said corrected electronic commerce data comprising the input electronic commerce data to the non-linear model.

32. The carrier medium of claim 31, wherein the non-linear model includes a set of model parameters defining a representation of the electronic commerce system, said model parameters capable of being trained; and
wherein the input electronic commerce data comprise training electronic commerce data including target input electronic commerce data and target output electronic commerce data, wherein said corrected electronic commerce data comprise corrected training electronic commerce data including corrected target input electronic commerce data and corrected target output electronic commerce data;
wherein said program instructions are further executable to:
train the non-linear model according to a predetermined training algorithm applied to said corrected target input electronic commerce data and said corrected target output electronic commerce data to develop model parameter values such that said non-linear model has stored therein a representation of the electronic commerce system that generated the target output electronic commerce data in response to the target input electronic commerce data.

33. The carrier medium of claim 31, wherein the non-linear model includes a set of model parameters defining a representation of the electronic commerce system, wherein said model parameters of said non-linear model have been trained to represent said electronic commerce system; and
wherein the input electronic commerce data comprise run-time electronic commerce data, and wherein said corrected electronic commerce data comprise corrected run-time electronic commerce data;
wherein said program instructions are further executable to:
input said run-time electronic commerce data into the non-linear model to generate run-time output electronic commerce data, wherein said run-time output electronic commerce data comprise one or both of control parameters for said system and predictive output information for said system.

34. The carrier medium of claim 33, wherein said control parameters are usable to determine control inputs to said system for run-time operation of said system.

35. The carrier medium of claim 31, wherein said program instructions are further executable to:
replace said one or more outlier values with replacement values, wherein said corrected input includes said replacement values.

36. The carrier medium of claim 31, wherein said replacing said one or more outlier values is performed using one or more of clipping, interpolation, extrapolation, spline fit, and sample/hold of a last prior value.

37. The carrier medium of claim 31, wherein said program instructions are further executable to:
receive user input specifying one or more data filtering operations to be performed on said input electronic commerce data, wherein said analyzing and said removing said one or more outlier values comprises performing said one or more data filtering operations on the input electronic commerce data.

38. The carrier medium of claim 31, wherein said program instructions are further executable to:
display said input electronic commerce data prior to and after performing said filtering operations on said input electronic commerce data.

39. The carrier medium of claim 31, wherein said program instructions are further executable to:
receive user input specifying a portion of said input electronic commerce data for said data filtering operations.

40. The carrier medium of claim 39, wherein the input electronic commerce data comprise a plurality of variables, each of the variables comprising an input variable with an associated set of electronic commerce data wherein each of said variables comprises an input to said input buffer; and
wherein each of at least a subset of said variables comprises a corresponding one of the inputs to the non-linear model.
